(19) United States
(12) Patent Application Publication
(10) Pub. No.: US 2006/0152085 A1
(43) Pub. Date: Jul. 13, 2006

(54) Power system method and apparatus

(76) Inventors: Fred Flett, Bloomfield, MI (US); Lizhi Zhu, Canton, MI (US); Sayeed Ahmed, Canton, MI (US); Ajay V. Patwardhan, Canton, MI (US); Roy I. Davis, Saline, MI (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/255,162

(22) Filed: Oct. 20, 2005

Related U.S. Application Data
(60) Provisional application No. 60/621,012, filed on Oct. 20, 2004.
(60) Provisional application No. 60/662,707, filed on Mar. 17, 2005.
(60) Provisional application No. 60/688,310, filed on Jun. 7, 2005.

(51) Int. Cl. H02J 3/00

(52) U.S. Cl. 307/75

(57) ABSTRACT

Power converter system topologies comprise a first DC/DC converter to pull a positive rail of a high voltage bus up, while a second DC/DC converter pushes a negative rail of the high voltage bus down. One or both the DC/DC converters may be bi-directional. Such topologies are suitable for use with separate primary power sources, and/or auxiliary power sources. Such topologies may include a DC/AC converter, which may be bi-directional. Such topologies may include one or more auxiliary DC/DC converters, which may be bi-directional. Multiple substrates, including at least one stacked above another may enhance packaging.

### CROSS-REFERENCES TO RELATED APPLICATIONS

This application claims the benefit under 35 U.S.C. § 119(e) of U.S. Provisional Patent Application No. 60/621,012 filed Oct. 20, 2004; U.S. Provisional Patent Application No. 60/662,707 filed Mar. 17, 2005; and U.S. Provisional Patent Application No. 60/688,310 filed Jun. 7, 2005, where these three provisional applications are incorporated herein by reference in their entireties.

### BACKGROUND OF THE INVENTION

1. Field of the Invention

This disclosure generally relates to electrical power systems, and more particularly to power system architectures suitable for rectifying, inverting, and/or converting electrical power between power sources and loads.

2. Description of the Related Art

Power conversion systems transform and/or condition power from one or more power sources for supplying power to one or more loads. A power conversion system component commonly referred to as an “inverter” transforms direct current (DC) to alternating current (AC) for use in supplying power to an AC load. A power conversion system component commonly referred to as a “rectifier” transforms AC to DC. A power conversion system component commonly referred to as a “DC/DC converter” steps-up or steps-down DC voltage. In some embodiments, these components may be bi-directionally operable to perform two or more functions. These functions may, in some cases be inverse functions. For example, a switch mode inverter may be operable to invert DC to AC in one direction, while also operable to rectify AC to DC in another direction. An appropriately configured and operated power conversion system may include any one or more of these components to perform any one or more of these functions.

In common usage, the term “converter” applies generically to all power conversion components whether inverters, rectifiers and/or DC/DC converters and is used herein and in the claims in that generic sense. One or more power conversion system components may be provided as a self-contained unit, commonly referred to as a power module, which comprises an electrically insulative housing that houses at least a portion of the power conversion system component, and appropriate connectors such as terminals or bus bars.

Many applications employ the delivery of high power, high current and/or high voltage from a power source to a load. For example, it may be desirable in transportation applications to provide a relatively high DC voltage to an inverter to supply AC power for driving a load such as a traction motor for propelling an electric or hybrid electric vehicle. It may also be desirable at the same time to provide a relatively low voltage for driving accessory or peripheral loads.

Such applications may employ one or more of a variety of power sources. Applications may, for example, employ energy producing power sources such as internal combustion engines or arrays of fuel cells and/or photovoltaic cells. Applications may additionally, or alternatively, employ power sources such as energy storage devices, for example, arrays of battery cells, super- or ultra-capacitors, and/or flywheels.

The desire to match the capacity of the power source(s) with the requirements of the load(s) requires the careful weighing of the various costs and benefits that may dictate many design decisions such as the type of power source, and the size of power converter. It must be recognized as part of the design process that power converters typically employ power semiconductor devices, such as insulated gate bipolar transistors (IGBTs), metal oxide semiconductor field effect transistors (MOSFETs), and/or semiconductor diodes, all of which dissipate large amounts of heat during high power operation. This may require the use of higher rated semiconductor devices, which are expensive. This may also create thermal management problems which may limit the operating range, increase cost, increase size and/or weight, adversely effect efficiency and/or reduce reliability of a power converter.

Methods in, or architectures for power conversion systems capable of high power operation that alleviate these problems are highly desirable.

### BRIEF SUMMARY OF THE INVENTION

In one embodiment, a power system comprises a high side DC power bus comprising a first voltage rail and a second voltage rail; a first low side DC power bus; a second low side DC power bus; first means for boosting a potential on the first voltage rail of the high side DC power bus above a high potential of the first low side DC power bus; and second means for boosting a potential on the second voltage rail of the high side DC power bus below a low potential of the second low side DC power bus.

In another embodiment, a power system comprises a high side DC power bus; a first low side DC power bus; a second low side DC power bus; a first DC/DC power converter electrically coupled to the first low side DC power bus and operable to transform power between the first low side DC power bus and the high side DC power bus; and a second DC/DC power converter electrically coupled to the second low side DC power bus and operable to transform power between the first low side DC power bus and the high side DC power bus, wherein the first and the second DC/DC power converters are electrically coupled in series with one another across the high side DC power bus during at least one time.

In yet another embodiment, a method of operating a power system comprises pulling up a potential on a first voltage rail of a high side DC power bus; and pulling down a potential on a second voltage rail of the high side DC power bus.

In still another embodiment, a method of operating a power system comprises in a first mode, operating a first DC/DC converter circuit to boost a potential on a first voltage rail of a high side DC power bus above a high potential of a first low side DC power bus; and in the first mode, operating a second DC/DC converter circuit to boost a potential on a second voltage rail of the high side DC power bus below a low potential of a second low side DC power bus, the first and the second DC/DC converter circuits electrically coupled in series with each other across the high side DC power bus.

In another aspect, various embodiments are employed in a number of power system topologies suitable for use with fuel cell stacks. Some topologies employ bi-directional first and second DC/DC converters electrically coupled in series between a high side voltage rail and a low side voltage rail, while other embodiments employ first and second DC/DC buck converters electrically coupled in series. Some topologies include a high voltage power storage device, for example a high voltage array of batteries. Some topologies include bi-directional high power first and second DC/DC converters electrically coupled in series to step-up and/or step-down voltage transferred to, and from, the high voltage power storage device. Some topologies include high power first and second DC/DC power converters electrically coupled in series to step-up power transferred from the fuel cell stack.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an electrical schematic of a power conversion system coupling a pair of series coupled primary power sources to a load, the power conversion system comprising first and second primary DC/DC converters and a DC/AC inverter, according to one illustrated embodiment.

FIG. 2 is an electrical schematic of a power conversion system similar to that of FIG. 1, where the power conversion system further comprises an auxiliary DC/DC converter coupled to transfer power to and from an auxiliary power source according to one illustrated embodiment.

FIG. 3 is an electrical schematic of a power conversion system similar to that of FIG. 1, where the power conversion system further comprises an auxiliary DC/DC power converter coupled to transfer power to an auxiliary power source according to another illustrated embodiment.

FIG. 4 is an electrical schematic of a power conversion system coupling a pair of parallel coupled primary power sources to a load, the power conversion system comprising first and second primary DC/DC converters and a DC/AC inverter, according to one illustrated embodiment.

FIG. 5 is an electrical schematic of the power conversion system similar to that of FIG. 4 where the power conversion system further comprises an auxiliary DC/DC converter coupled to transfer power to and from an auxiliary power source according to one illustrated embodiment.

FIG. 6 is an electrical schematic of the power conversion system similar to that of FIG. 4 where the power conversion system further comprises an auxiliary DC/DC converter coupled to transfer power to and from one of the primary power sources according to one illustrated embodiment.

FIG. 7 is a timing diagram showing gating control signals to control operation of the first and second primary three-phase interleaved switch mode DC/DC converters of FIG. 2 to provide power to the electric machine in one mode, and to provide power from the electric machine in another mode.

FIG. 8 is a timing diagram showing gating control signals to control operation of the auxiliary DC/DC power converter of FIG. 2 to provide power to the electric machine in at least one mode.

FIG. 9 is a timing diagram showing gating control signals to control operation of the auxiliary DC/DC power converter of FIG. 2 to provide power to the auxiliary storage device in at least another mode.

FIG. 10 is a timing diagram showing gating control signals to control operation of the first primary three-phase interleaved switch mode DC/DC converter of FIG. 6 to provide power to the electric machine in one mode.

FIG. 11 is a timing diagram showing gating control signals to control operation of the second primary three-phase interleaved switch mode buck-boost DC/DC converter of FIG. 6 to provide power to the electric machine in at least one mode.

FIG. 12 is a timing diagram showing gating control signals to control operation of the second primary three-phase interleaved switch mode buck-boost DC/DC converter of FIG. 6 to provide power to the auxiliary power source V_{A} in at least another mode, where the auxiliary power source takes the form of a power storage device.

FIG. 13 is a schematic diagram of a pair of primary power sources in the form of two fuel cell systems, according to one illustrated embodiment.

FIG. 14 is a schematic diagram of a pair of primary power sources in the form of a fuel cell system comprising two fuel cell stacks which share some operational components, according to another illustrated embodiment.

FIG. 15 is a schematic diagram of a pair of primary power sources in the form of a fuel cell system with a single fuel cell stack and one set of operational components, according to a further illustrated embodiment.

FIG. 16 is a schematic diagram of a primary power source topology comprising two pairs of parallel fuel cell stacks coupled in series, according to a further illustrated embodiment.

FIG. 17 is a schematic diagram of a power conversion system similar to that of FIG. 1 in an electric or hybrid vehicle embodiment.

FIG. 18 is an isometric view of a power module according to at least one illustrated embodiment.

FIG. 19 is a partially exploded isometric view of a power module of FIG. 18 according to at least one illustrated embodiment.

FIG. 20 is an isometric partial view of a power module according to at least one illustrated embodiment showing various terminals for making connections.

FIG. 21A is a top plan view of a portion of a power module according to at least one illustrated embodiment illustrating a single phase of the power module where the DC/DC converter components are physically positioned between the DC/AC converter components.

FIG. 21B is a top plan view of a pair of substrates that comprise a portion of the power module of FIG. 21A, with a third substrate and various components of the DC/DC converter and DC/AC converter removed to better illustrate conductive regions formed in an upper electrically conductive layer of the pair of substrates.

FIG. 21C is a top plan view of the third substrate that comprises a portion of the power module of FIG. 21A, with various components of the DC/DC converter and DC/AC converter removed to better illustrate conductive regions formed in an upper electrically conductive layer of the third substrate.

FIG. 21D is a partial cross-sectional view of a portion of the power module of FIG. 21A illustrating the arrangement of, and connections between the multi-layer substrates.

FIG. 21E is a bottom plan view of the third substrate that comprises a portion of the power module of FIG. 21A, illustrating conductive regions formed in an lower electrically conductive layer of the third substrate.

FIG. 22 is an isometric view of a power module according to another illustrated embodiment.

FIG. 23A is a top plan view of a portion of a power module according to at least one illustrated embodiment illustrating a single phase of the power module where the DC/AC converter components are physically positioned between the DC/DC converter components.

FIG. 23B is a top plan view of four substrates that comprise a portion of the power module of FIG. 23A, with a fifth substrate and various components of the DC/DC converter and DC/AC converter removed to better illustrate conductive regions formed in an upper electrically conductive layer of the four substrates.

FIG. 24 is a chart illustrating, for an exemplary MOSFET switch, RMS current and diode average current versus the output voltage at 100 kW input power and 200V total stack input voltage employed in an exemplary embodiment.

FIG. 25 is a chart illustrating, for a 200V input, an exemplary MOSFET and diode conduction losses, as well as the diode reverse recovery loss for all output voltages, for each of the six switch/diode pairs.

FIG. 26 is a chart illustrating efficiency mapping for the above-described exemplary embodiment, assuming a 100 kW input power, 200V input voltage, and output voltage range of 250V to 430V.

FIG. 27 is a chart illustrating that the reverse recovery losses for the SiC diode are significantly better than the ultrafast Si diode, but the conduction losses favor the Si diode.

FIG. 28 is a chart illustrating a comparison of system efficiency with SiC diodes compared to ultrafast Si diodes.

FIGS. 29 and 30 are charts illustrating current waveforms of an exemplary embodiment for the boost inductors and high voltage bus capacitor, for the full load operation with input voltage of 200V, and output voltages of 250V and 430V, respectively.

FIG. 31 is a schematic diagram of a system, with first and second DC/DC converters electrically coupled in series, suitable for a vehicle.

FIG. 32 is a schematic diagram of a “lean” power system topology suitable for a vehicle according to the various embodiments.

FIG. 33 is a schematic diagram of a “fuel cell following hybrid” power system topology suitable for a vehicle according to the various embodiments.

FIG. 34 is a schematic diagram of a “battery following hybrid” power system topology suitable for a vehicle according to the various embodiments.

FIG. 35 is a schematic diagram of a “regulated inverter bus hybrid” power system topology suitable for a vehicle according to the various embodiments.

FIG. 36 is a graph of polarization curve illustrating a relationship between cell voltage and current density for a PEM fuel cell structure, according to the various embodiments.

FIG. 37 is a graph of the polarization curve further illustrating a direct relationship between an increase in current and waste heat of an exemplary embodiment.

FIG. 38 is a graph showing various constraints to reducing costs associated with various embodiments.

FIG. 39 is a graph showing a polarization curve for cold startups along with the polarization curve for normal operation of an exemplary embodiment.

FIG. 40 is a graph showing a polarization curve for cold startups employing power electronics to provide functionality of an exemplary embodiment.

FIG. 41 is a schematic diagram of a system, with first and second primary DC/DC power converters electrically coupled in series, wherein the first and second primary DC/DC power converters each comprise a single inductor, switch and diode leg.

FIG. 42 is a schematic diagram of a system, with first and second primary DC/DC power converters electrically coupled in series, wherein the first and second primary DC/DC power converters each comprise a plurality of single inductor, switch and diode legs.

FIG. 43 is a schematic diagram of a system, with a plurality of parallel sets of first primary DC/DC power converters and second primary DC/DC power converters.

FIG. 44 is a schematic diagram of a bi-directional system, with a first primary DC/DC power converter and a second primary DC/DC power converter.

FIG. 45 is a schematic diagram of a bi-directional system wherein the capacity in the direction from the primary energy source to the voltage rail is different from the capacity in the voltage rail to the primary energy source.

FIG. 46 is a schematic diagram of a bi-directional system wherein an additional switch is employed in each leg to protect the load from the primary power sources.

FIGS. 47-51 are flow charts illustrating various processes of operating power systems using the various embodiments described herein.

### DETAILED DESCRIPTION OF THE INVENTION

In the following description, certain specific details are set forth in order to provide a thorough understanding of various embodiments of the present systems and methods. However, one skilled in the relevant art will recognize that the present systems and methods may be practiced without one or more of these specific details, or with other methods, components, materials, etc. In other instances, well-known structures associated with converter systems and power sources, and associated methods and apparatus have not been shown or described in detail to avoid unnecessarily obscuring descriptions of the embodiments of the present systems and methods.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present systems and methods. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

It may be advantageous to employ a higher DC voltage in many applications than would normally be available from a power source. For example, supplying a high DC voltage to a DC/AC inverter that in turn supplies power to an AC electric motor may increase the efficiency of the electric motor, and may permit a substantial reduction in the size and weight of the electric motor. However, the use of a high voltage power source to supply the high DC voltage may be disadvantageous. For example, where the primary power source is a stack of fuel cells, increasing the number of fuel cells forming the stack may cause challenges related to sealing and mechanical tolerance, as well as significantly increasing size, weight and cost, and potentially contributing to reliability problems.

Conversely, it may be advantageous to employ a power source that provides a lower voltage than that desired by the load. For example, where the primary power source is a fuel cell stack, a lower voltage stack avoids many of the problems denominated above. Further, operating fuel cell stacks close to their maximum voltage rating is more efficient (i.e., polarization curve) than operating at lower voltages. Thus, it may be beneficial to use a smaller fuel cell stack where the typically desired output voltage is relatively small. It may be advantageous to operate a fuel cell stack over a greater voltage range than would be ideal for components being powered by the fuel cell stack. It may also be advantageous to supply those components with power at a set voltage or a voltage that increases with power (as opposed to decreases with an unmodified fuel cell stack).

To some extent the desired increase in voltage can be accomplished using a primary DC/DC boost converter to boost the voltage from the primary power source to supply the DC/AC inverter.

This approach however has a number of practical limits or drawbacks. For example, as the boost ratio required of the primary DC/DC converter increases, efficiency decreases, while cost, thermal management problems, packaging problems and reliability problems all increase. For example, output current of a 120 kW fuel cell stack operating at a full load voltage of 80V, may approach 1500A. Such requires exceptionally highly rated, and consequently, very costly semiconductor devices. Such also produces extreme penalty in component size and efficiency, and requires exceptional thermal management solutions.

The multiple-feed approach discussed herein, may address some of the limitations and drawbacks noted above by providing a multiple (i.e., two or more) primary DC/DC power converter topology in which the primary DC/DC power converters are electrically coupled in series to provide an higher output voltage than would be provided by the primary DC/DC power converters operating separately. This may, for example, allow the use of two or more primary DC/DC power converters with relatively small boost ratios, and consequently lowering the RMS voltage and/or current ratings of the semiconductor devices, and alleviating attendant packing, thermal management and reliability problems. For example, the on-resistance (RDS) for a field effect transistor (FET) is approximated as the breakdown voltage raised to the power of 2.7. By employing two DC/DC power converters each operating with FETs having a breakdown voltage of 300V, the on-resistance of the FETs is 6.5 time less than would otherwise be the case for a single feed converter employing FETs with a breakdown voltage rating of 600V.

Further, the multiple-feed approach may employ multiple (i.e., two or more) primary power sources, to feed the respective primary DC/DC power converters. This may, for example, allow two or more relatively low voltage fuel cell stacks (e.g., 40-80V each, operating at a high current) to replace a single relatively high voltage fuel cell stack (e.g., 200V-450V operating at a lower current) while still delivering high voltage DC power to a DC/AC inverter for use in driving a traction motor of an electric or hybrid vehicle, allowing the efficient design of the DC/AC inverter and electric motor for size, weight and/or reliability. This may also allow the primary power sources to be operated at different demand levels (e.g., different voltages, currents, and/or powers), for example, operating a first fuel cell stack at a maximum voltage level while not operating or running a second fuel cell stack in a “sleep” mode. This may further permit limited or reduced operation via one or more primary power sources when another primary power source is inoperable, defective or malfunctioning. Such operation may, for example, provide “limp home” capability, allowing a driver to reach a safe destination at a low speed or lower performance. Such operation may, for example, provide the ability to elegantly shut down a system where there would otherwise not have been sufficient power to perform an orderly shut down routine.

The embodiments described herein may comprise first and second DC/DC converters electrically coupled in series in a single power module. Each of the series coupled DC/DC converter sections modulate both the positive and negative DC bus voltage of the AC inverter for traction motor applications in fuel cell and hybrid electric vehicles, and in other applications. Two boost converters, in selected embodiments, are arranged in series and on either side of the DC bus to reduce voltage rating for the semiconductor switches in the boost converter. The topology on some embodiments utilize six inductors, three for each boost converter, to share the input current and make it more feasible for packaging and thermal management. The higher DC bus voltage enables the efficient design of the traction inverter and motor for size, weight, reliability and cost.

The various embodiments enable significant cost and volume reductions of fuel cell systems. Further performance and operational benefits also accrue to the system once the series coupled DC/DC converters are in place, including novel freeze start performance and mitigation of the aging effects of fuel cells. It is appreciated that waste heat increases during high current density, low voltage operation. At extremely high current density, the voltage begins to collapse and the cells are operated beyond their peak power delivery point. Normally, this operational domain is avoided because the voltage output is so low that it is unusable by the high voltage loads. With series coupled DC/DC converters, during very cold operation however, an area of the polarization curve is made accessible by delivering high voltage from the series coupled DC/DC converters and maximizing the waste heat that is generated within the stack, thereby reducing warm up time significantly.

As a fuel cell ages, the entire polarization curve shifts downwards due to internal degradation mechanisms, eventually being unable to deliver power above the minimally acceptable voltage (usually about 230 Vdc for the stack). With embodiments of the series coupled DC/DC converters, it is obvious that this is no longer a limitation, and the life of the fuel cell system is extended, although output power may be reduced.

In some embodiments, the series coupled DC/DC converter topology arranges the various power devices (switches, inductors, diodes, etc.) in a parallel/series structure. The parallel approach reduces the current stress. The series arrangement reduces the voltage stress on the passive components and power devices.

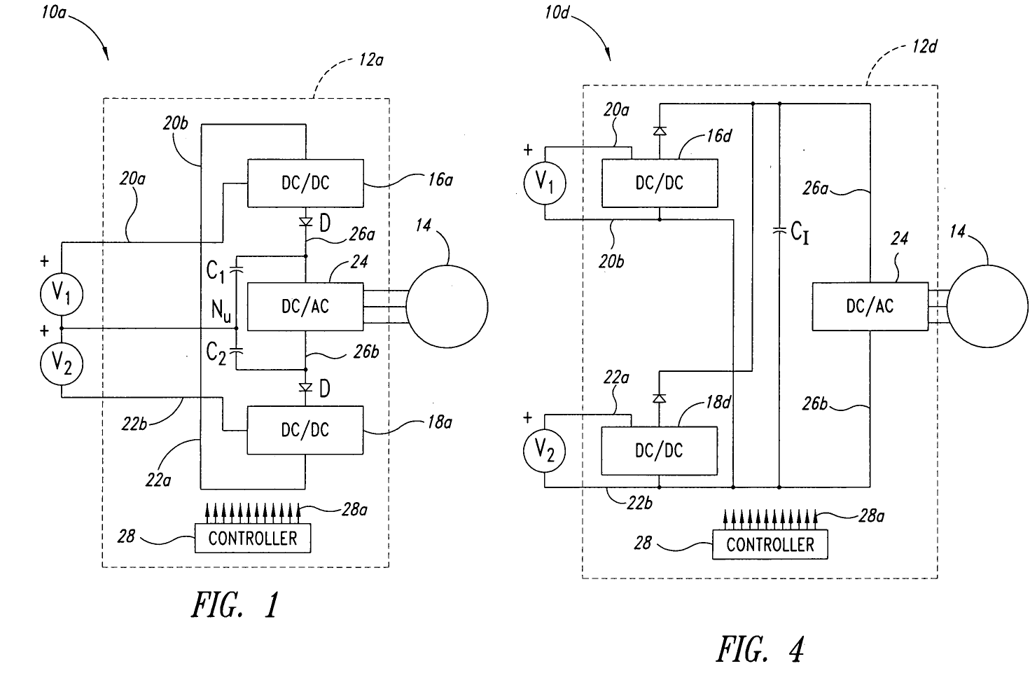

FIG. 1 shows a power system 10a comprising a power conversion system 12a coupled to supply power from a first primary power source V₁ and a second primary power source V₂ to a load in the form of an electric machine 14, according to one illustrated embodiment. The first and the second primary power sources V₁, V₂ are electrically coupled in series with one another, and may take a variety of forms as discussed in detail below.

The power conversion system 12a comprises a first primary DC/DC power converter 16a and a second primary DC/DC power converter 18a electrically coupled to form a dual-fed power converter. The first and second primary DC/DC converters 16a, 18a are operable to step-up and/or step-down a voltage. For example, the first primary DC/DC power converter 16a may step-up a voltage received from the first primary power source V₁ via an upper voltage rail 20a and lower voltage rail 20b of a first low side DC power bus collectively referenced as 20. Likewise the second primary DC/DC power converter 18a may step-up a voltage received from the second primary power source V₂ via an upper voltage rail 22a and a lower voltage rail 22b of a second low side DC power bus collectively referenced as 22. The lower voltage rail 20b of the first low side DC power bus 20 and the upper voltage rail 22a of the second low side DC power bus 22 are commonly coupled at a neutral node Nu.

The boosted output voltages provided by the first and second primary DC/DC power converters 16a, 18a are applied in series with one another to first and second voltage rails 26a, 26b of a high voltage DC bus, collectively referenced as 26. This permits the first and second primary DC/DC power converters 16a, 18a to have lower boost ratios (e.g., half than would otherwise be required to achieve the desired voltage across the high voltage DC bus 26. The sharing of current by the first and second primary DC/DC power converters 16a, 18a also allows the use of lower rated (i.e., lower operating thresholds) devices (e.g., power semiconductor switches and diodes) in the first and second primary DC/DC power converters 16a, 18a than would otherwise be possible. As discussed below, one or both of the primary DC/DC power converters of the various illustrated embodiments, collectively 16, 18, may be bi-directional, for example, stepping up a voltage in one direction, and stepping the voltage down in the other direction.

The primary DC/DC power converters 16a, 18a may also comprise diodes D electrically coupled between the first and the second DC/DC converters 16a, 18a and the high voltage bus 26. The diodes D may advantageously take the form of silicon carbide diodes, although other diodes may be suitable. Silicon carbide diodes have lower switching losses than other types of diodes, thus permit higher switching frequency operation with attendant advantages discussed below. Furthermore, higher switching frequency operation may allow a reduced inductor size in some embodiments.

The power conversion system 12a may optionally comprise a DC/AC power converter 24. The DC/AC power converter 24 may be coupled to supply AC power to the electric machiner 14. The electric machine 14 may, for example, take the form of a traction motor of an electric or hybrid vehicle, or other electric motor. The first and second voltage rails 26a, 26b of the high voltage DC bus 26, may electrically couple the DC/AC power converter 24 to the first and the second primary DC/DC converters 16a, 18a, respectively. The DC/AC power converter 24 is operable as an inverter to transform DC power supplied via the primary DC/DC power converters 16a, 18a into AC power, for example three-phase AC power. In some embodiments, the DC/AC power converter 24 may be bi-directional. For example, DC/AC power converter 24 may be operable as a rectifier to rectify AC power supplied by the electric machine 14 when operating as a generator (i.e., power source rather than load), for instance during a regenerative braking mode.

The power conversion system 12a may also comprise capacitors C₁, C₂ electrically coupled in parallel across the DC/AC power converter 24. The capacitors C₁, C₂, are shared by the DC/AC converter 24 and the DC/DC converters 16a, 18a, with attendant benefits, for example, cost reduction.

The power conversion system 12a may further comprise a controller 28 to control the primary DC/DC power converters 16a, 18a and/or the DC/AC power converter 24 via control signals 28a. The controller 28 may take the form of a microprocessor, digital signal processor (DSP), application specific integrated circuit (ASIC) and/or drive board or circuitry, along with any associated memory such as random access memory (RAM), read only memory (ROM), electrically erasable read only memory (EEPROM), or other memory device storing instructions to control operation. The controller 28 may be housed with the other components of the power conversion system 12a, may be housed separately therefrom, or may be housed partially therewith.

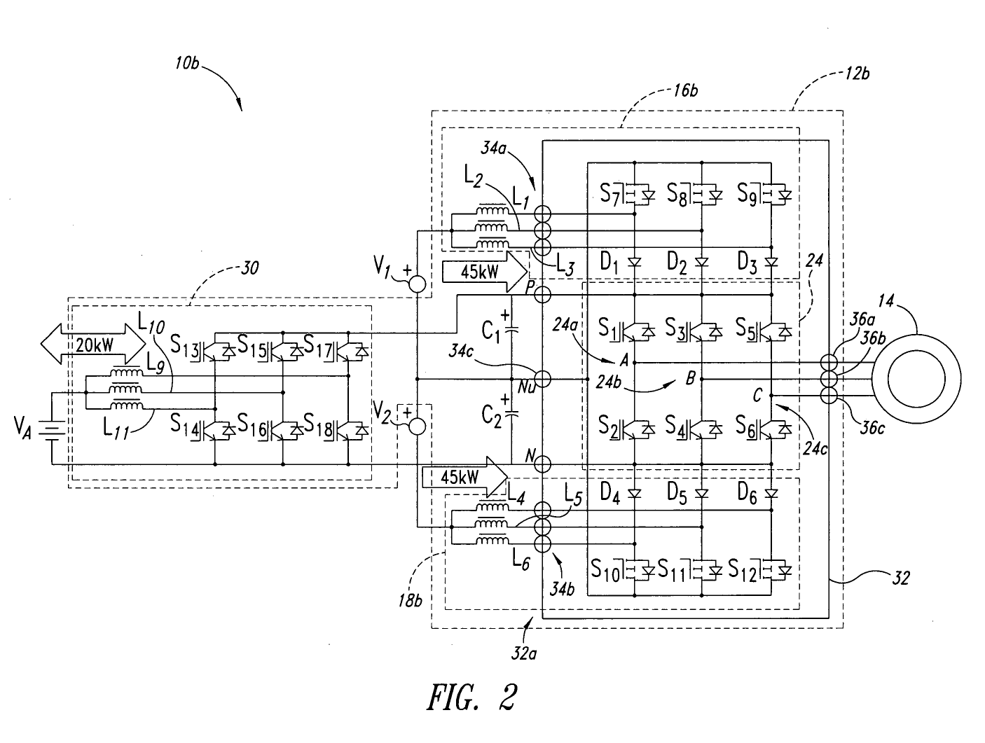

FIG. 2 shows a power system 10b similar to that of FIG. 1, and additionally comprising an auxiliary power source V_{A}. The power conversion system 12b of the power system 10b further comprises an auxiliary power converter 30 for coupling power to, and from, the auxiliary power source V_{A}.

As illustrated in FIG. 2, the DC/AC power converter 24 may take the form of a switch mode power inverter operable, for example, to produce three-phase AC power. The DC/AC power converter 24 may, for example, comprise a first phase leg 24a formed by an upper power semiconductor switch S₁ and a lower power semiconductor switch S₂, a second phase leg 24b formed by an upper power semiconductor switch S₃ and a lower power semiconductor switch S₄ and a third phase leg 24c formed by an upper power semiconductor switch S₅ and lower power semiconductor switch S₆. Each of the phase legs 24a-24c are electrically coupled between the first and second voltage rails 26a, 26b of the high side voltage bus 26. Between each pair of power semiconductor switches S₁-S₂, S₃-S₄, S₅-S₆ forming each phase leg 24a, 24b, 24c respectively, is a phase node A, B, C, upon which the respective phase of the three-phase output of the DC/AC power converter 24 appears during operation. The DC/AC power converter 24 further comprises power semiconductor diodes (referenced as part of the power semiconductor switches S₁-S₆, and not separately called out in drawings for the sake of clarity), electrically coupled in anti-parallel across respective ones of the power semiconductor switches S₁-S₆. The power semiconductor switches S₁-S₆ are controlled via control signals 28a received via the controller 28.

The power semiconductor switches S₁-S₆ of the DC/AC converter 24 may take the form of IGBTs. Alternatively, the power semiconductor switches S₁-S₆ of the DC/AC converter 24 may take the form of more costly MOSFETs. The use of IGBTs may permit the DC/AC converter 24 to reach a switching frequency of approximately 10 kHz, which may be sufficiently fast for certain applications, such as for use in driving an electric or hybrid vehicle.

The first primary DC/DC power converter 16a may take the form of a multi-phase (i.e., multi-channel) interleaved switch mode converter such as a first primary three-phase interleaved switch mode DC/DC converter 16b. The first primary three-phase interleaved switch mode converter 16b comprises boost inductors L₁-L₃, diodes D₁-D₃, and power semiconductor switches and associated anti-parallel diodes, collectively referenced as S₇-S₉. The power semiconductor switches S₇-S₉ may be controlled via control signals 28a provided by the controller 28 (FIG. 1). Likewise the second primary DC/DC power converter 18a may take the form of a multi-phase (i.e., multi-channel) interleaved switch mode converter such as a second primary three-phase interleaved switch mode DC/DC converter 18b. The second primary three-phase interleaved switch mode DC/DC converter 18b comprises boost inductors L₄-L₆, diodes D₄-D₆, power semiconductor switches and associated anti-parallel diodes S₁₀-S₁₂. The first primary three-phase interleaved switch mode DC/DC converter 16b is operable to step-up a voltage from the first primary power source V₁, while the second primary three-phase interleaved switch mode DC/DC converter 18b is operable to step-up (i.e., lower, buck or step-down voltage on the negative voltage rail) a voltage supplied by the second primary power source V₂.

The use of multi-phase interleaved DC/DC converters advantageously reduces the ripple current in the capacitors C₁, C₂ The six boost inductors L₁-L₆ share the input current, increasing efficiency, reducing mass and volume, and thereby making packaging, power density, and thermal management more feasible.

The auxiliary power converter 30 may take a variety of forms, which may depend in part on the type of auxiliary power source V_{A}. For example, where the auxiliary power source V_{A} is an energy storage device capable of storing and releasing electrical energy, the auxiliary power converter 30 may take the form of a buck-boost DC/DC power converter, capable of stepping-up a voltage supplied by the auxiliary power source V_{A} or stepping-down a voltage supplied to the auxiliary power source V_{A}. FIG. 2 shows one embodiment of an auxiliary power converter 30 that may be suitable in the form of a three-phase (i.e., three-channel) buck-boost DC/DC converter, comprising boost inductors L₉-L₁₁ and power semiconductor switches and associated anti-parallel diodes S₁₃-S₁₈. Other types of power converter topologies may be suitable depending on the particular application.

The disclosed topologies discussed above and below, may advantageously house the power semiconductor switches S₇-S₁₂ and the diodes D₁-D₆ of the first and second primary DC/DC power converters 16, 18, and/or the power semiconductor switches S₁-S₆ of the DC/AC converter 24 in a common electrically insulated housing 32 to form a power module 32a. The power module 32a may further comprise appropriate connectors such as primary DC bus bars 34a-34c, auxiliary DC bus bars P, N, and AC phase terminals 36a-36c, which are accessible from an exterior of the housing 32 to make electrical connections to the externally located primary voltage sources V₁, V₂, auxiliary power source V_{A}, and the electric machiner 14. While FIGS. 2, 3, 5 and 6 illustrate the inductors L₁-L₆ and capacitors C₁, C₂, C, as external to the housing 32, in some embodiments one or more of these components may be housed within the housing 32.

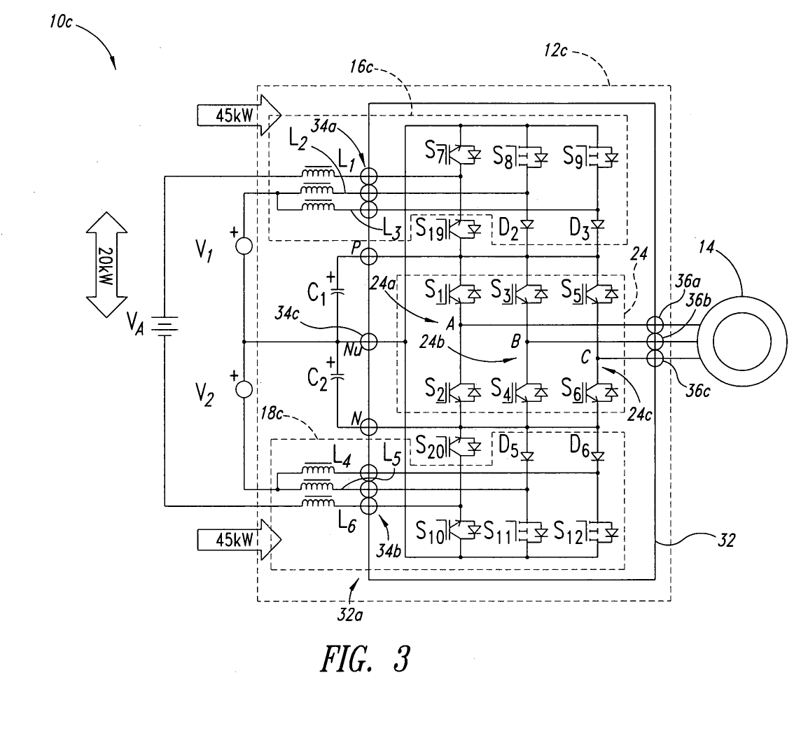

FIG. 3 shows a power system 10c similar to that of FIG. 1, additionally comprising the auxiliary power source V_{A}. The power conversion system 12c of the power system 10c comprises first and second primary DC/DC power converters 16, 18 which may take the form of multi-phase (i.e., multi-channel) interleaved switch mode power converters such as a first primary three-phase interleaved switch mode DC/DC converter 16c and a second primary three-phase interleaved switch mode DC/DC converter 18c. The first primary three-phase interleaved switch mode DC/DC converter 16c comprises boost inductors L₁-L₃, diodes D₂, D₃, and power semiconductor switches and associated anti-parallel diodes S₇-S₉, S₁₉. The second primary three-phase interleaved switch mode DC/DC converter 18c comprises boost inductors L₄-L₆, diodes D₅, D₆, and power semiconductor switches and associated anti-parallel diodes S₁₀-S₁₂, S₂₀. In the first primary three-phase interleaved switch mode DC/DC converter 16c, two phases, between which are 180° phase locked to one another, couples the V₁ to the positive bus of DC/AC power converter 24. In the secondary primary three-phase DC/DC converter 18c, two phases, between which are also 180° phase locked to one another, couples the V₂ to the negative bus of DC/AC power converter 24.

The power conversion system 12c of the power system 10c further comprises an auxiliary DC/DC power converter to couple the auxiliary power source V_{A} to the high voltage bus 26. The auxiliary DC/DC power converter may take the form of a two-phase (i.e., two-channel) DC/DC power converter, the first phase leg formed by boost inductor L₁ and power semiconductor switch and associated anti-parallel diode S₁₉, S₇, and the second phase leg formed by boost inductor L₆ and second power semiconductor switch and associated anti-parallel diode S₂₀, S₁₀. The first and second phase legs are 180° phase locked to one another. The auxiliary DC/DC power converter is operable as a buck-boost DC/DC power converter, capable of stepping-up a voltage supplied by the auxiliary power source V_{A} or stepping-down a voltage supplied to the auxiliary power source V_{A}.

FIG. 4 shows a power system 10d comprising a power conversion system 12d coupled to supply power from the first primary power source V, and the second primary power source V₂ to the electric machine 14 according to another illustrated embodiment. In contrast to the embodiment of FIGS. 1-3, FIG. 4 illustrates an embodiment in which the first and second primary power sources V₁, V₂ are electrically coupled in parallel with one another through a first primary DC/DC power converter 16d and a second primary DC/DC power converter 18d. In particular, the first primary DC/DC power converter 16d is electrically coupled to the first power source V, via the upper and lower voltage rails 20a, 20b of the first low side DC power bus 20. The second primary DC/DC power converter 18d is electrically coupled to the second power source V₂ via the upper and lower voltage rails 22a, 22b of the second low side DC power bus 22. The lower voltage rail 20b of the first low side voltage bus 20 is electrically coupled to the lower voltage rail 22b of the second low side voltage bus 22. Both the first and the second primary DC/DC power converters 16d, 18d, respectively, are electrically coupled between the first and second rails 26a and 26b of the high voltage DC bus 26.

In contrast to the embodiments of FIGS. 1-3, the power conversion system 12d illustrated in FIG. 4 employs a single capacitor C, electrically coupled across the input of the DC/AC power converter 24.

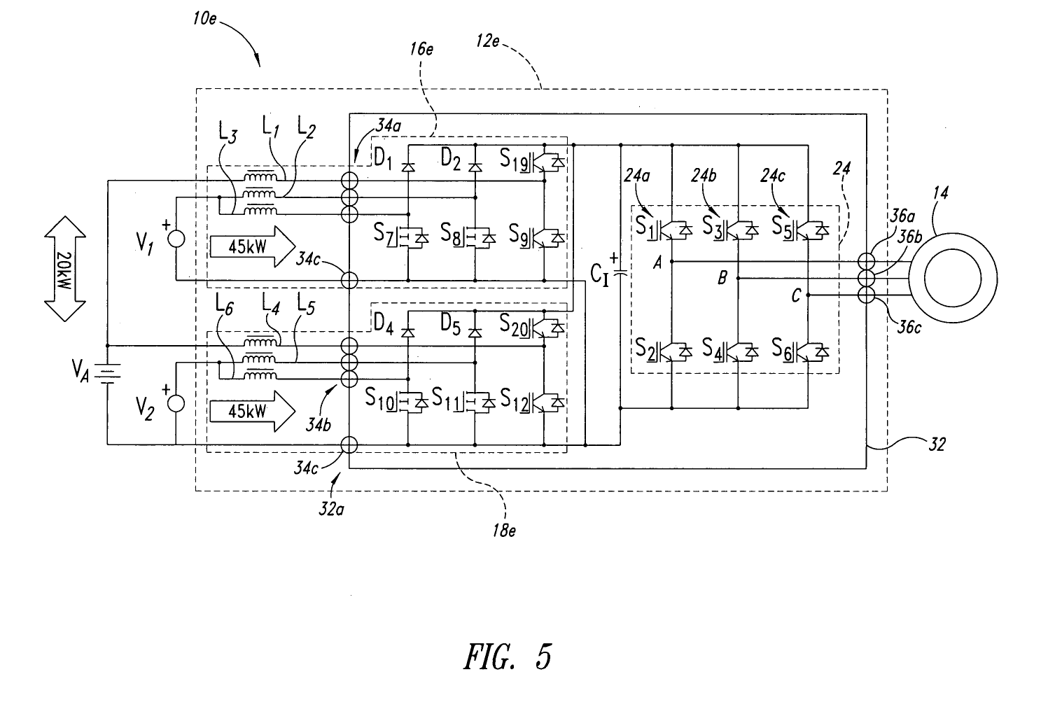

FIG. 5 shows a power system 10e similar to that of FIG. 4, and additionally comprising an auxiliary power source V_{A}.

The power conversion system 12e of the power system 10e comprises first and second primary DC/DC power converters 16e, 18e which may take the form of multi-phase (i.e., multi-channel) interleaved switch mode converters such as a first primary three-phase interleaved switch mode DC/DC converter 16e and a second primary three-phase interleaved switch mode DC/DC converter 18e. The first primary three-phase interleaved switch mode DC/DC converter 16e comprises boost inductors L₁-L₃, diodes D₁, D₂, and power semiconductor switches and associated anti-parallel diodes S₇-S₉. The second primary three-phase interleaved switch mode DC/DC converter 18e comprises boost inductors L₄-L₆, diodes D₄, D₅, and power semiconductor switches and associated anti-parallel diodes S₁₀-S₁₂.

As noted previously, the use of multi-phase interleaved DC/DC converters advantageously reduces the ripple current in the capacitor C₁. The six boost inductors L₁-L₆ share the input current, making packaging and thermal management more feasible.

In the first primary three-phase interleaved switch mode, DC/DC converter 16c, two phases, between which are 180° phase locked to one another, couples the V₁ to the positive bus of DC/AC power converter 24. In the secondary primary three-phase DC/DC converter 18c, two phases, between which are also 180° phase locked to one another, couples the V₂ to the negative bus of DC/AC power converter 24.

The power conversion system 12e of the power system 10e further comprises an auxiliary DC/DC power converter to couple the auxiliary power source V_{A} to the high voltage bus 26 (FIG. 4). The auxiliary DC/DC power converter may take the form of a two-phase (i.e., two-channel) DC/DC power converter, the first phase leg formed by boost inductor L₁ and power semiconductor switch and associated anti-parallel diode S₁₉, and the second phase leg formed by boost inductor L₄ and power semiconductor switch and associated anti-parallel diode S₂₀. The first and second phase legs are 180° phase locked to one another.

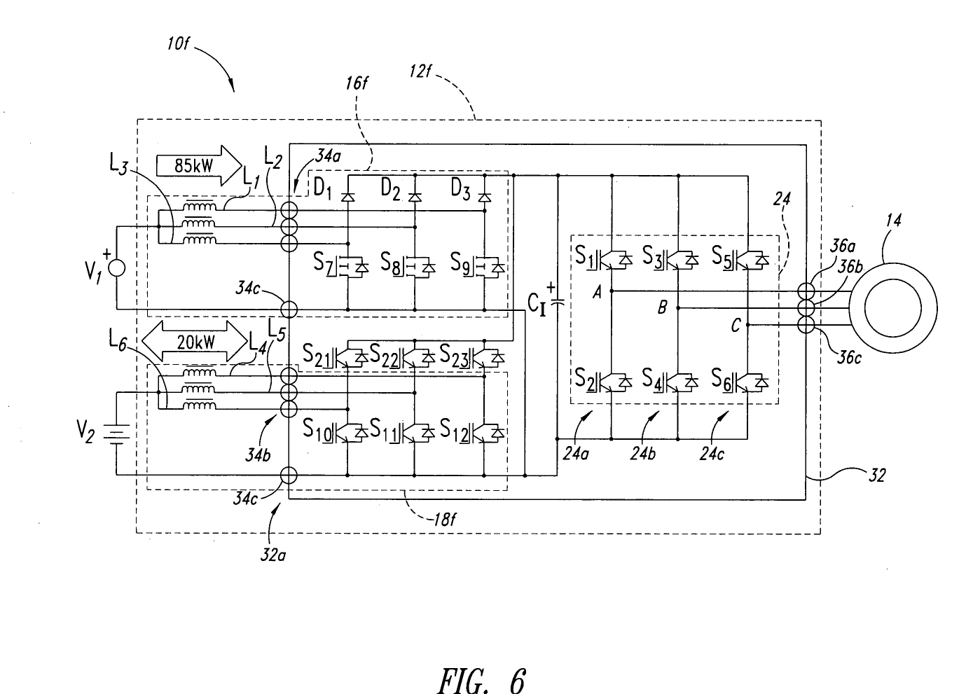

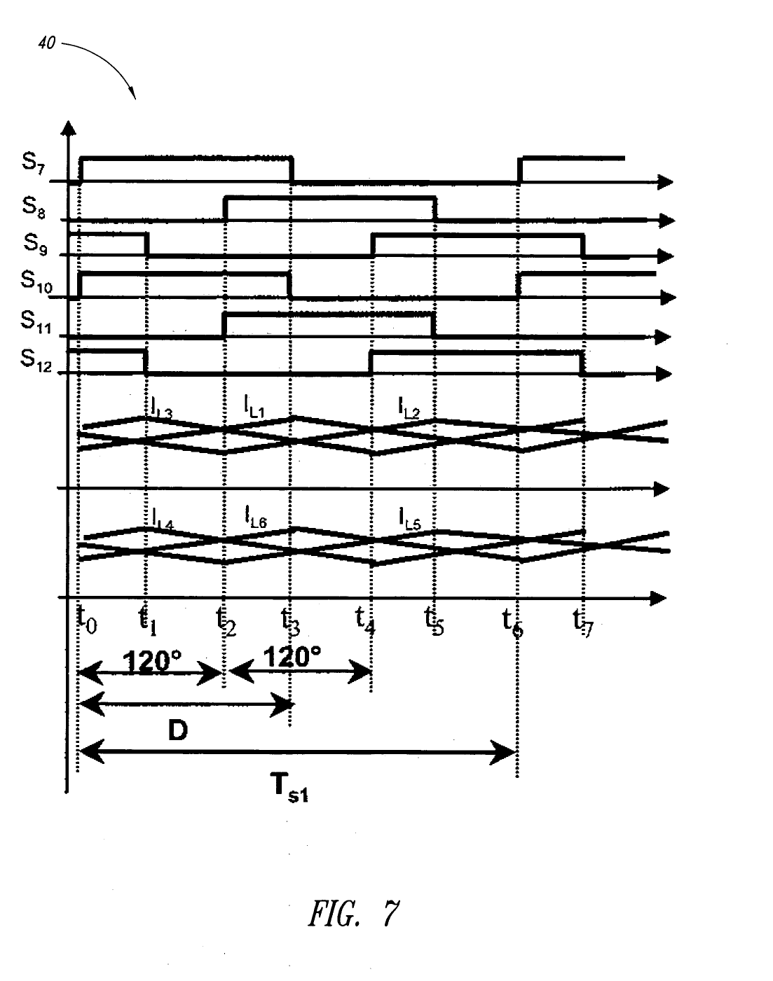

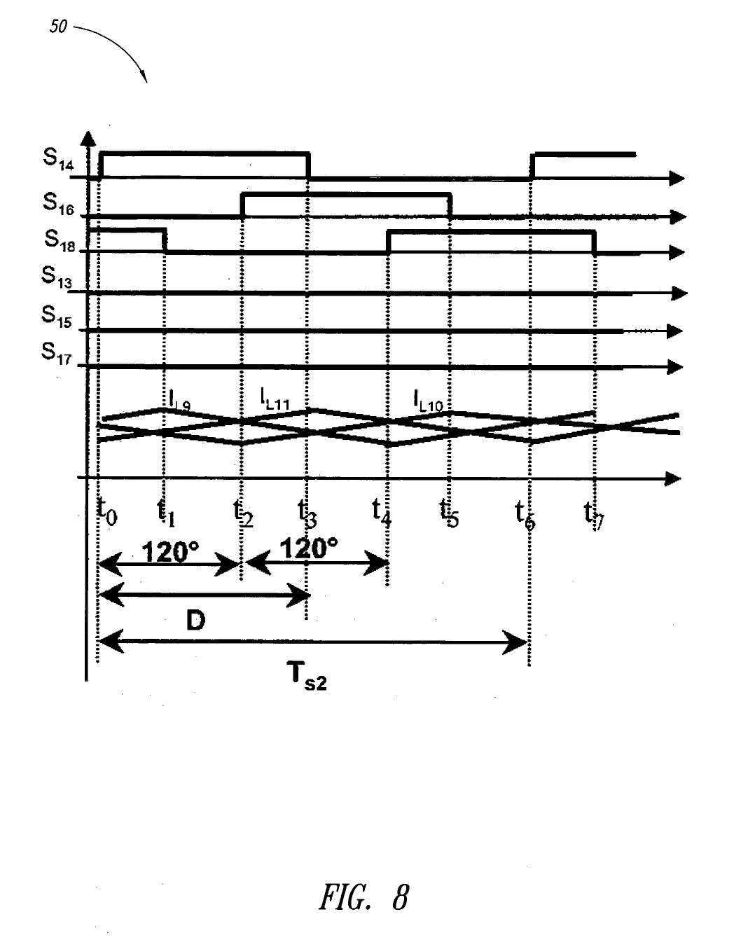

FIG. 6 shows a power system 10f similar to that of FIG. 4, where the first primary power source V₁ is a power production device while the second primary power source V₂ is a power storage device.

The power conversion system 12f of the power system 10f comprises first and second primary DC/DC power converters 16f, 18f which may take the form of multi-phase (i.e., multi-channel) interleaved switch mode converters such as a first primary three-phase interleaved switch mode DC/DC converter 16f and a second primary three-phase interleaved switch mode DC/DC converter 18f. The first primary three-phase interleaved switch mode DC/DC converter 16f comprises a boost converter comprising boost inductors L₁-L₃, diodes D₁-D₃, and power semiconductor switches and associated anti-parallel diodes S₇-S₉. Since the second primary power source V₂ is a power storage device, the second primary three-phase interleaved switch mode DC/DC converter 18f comprises a buck-boost topology comprising boost inductors L₄-L₆ and power semiconductor switches and associated anti-parallel diodes S₁₀-S_{12,} S₂₁-S₂₃. The second primary three-phase interleaved switch mode DC/DC converter 18f is operable to step-up voltage supplied by the second primary power source V₂ and to step-down voltage supplied to the primary power source V₂.

FIG. 7 shows a timing diagram 40 including gating control signals 28a for controlling operation of the first and second primary three-phase interleaved switch mode DC/DC converters 16b, 18b of FIG. 2 to provide power to the electric machine 14, for example in a drive mode. The controller 28 may execute instructions to provide appropriate control signals 28a to the power semiconductor switches S₇-S₁₂ of the first and second primary three-phase interleaved switch mode DC/DC converters 16b, 18b based on the timing diagram 40. The timing diagram 40 also shows the change in currents I_{L1}-I_{L6} over time through the boost inductors L₁-L₆, respectively, of the first and second primary three-phase interleaved switch mode DC/DC converters 16b, 18b.

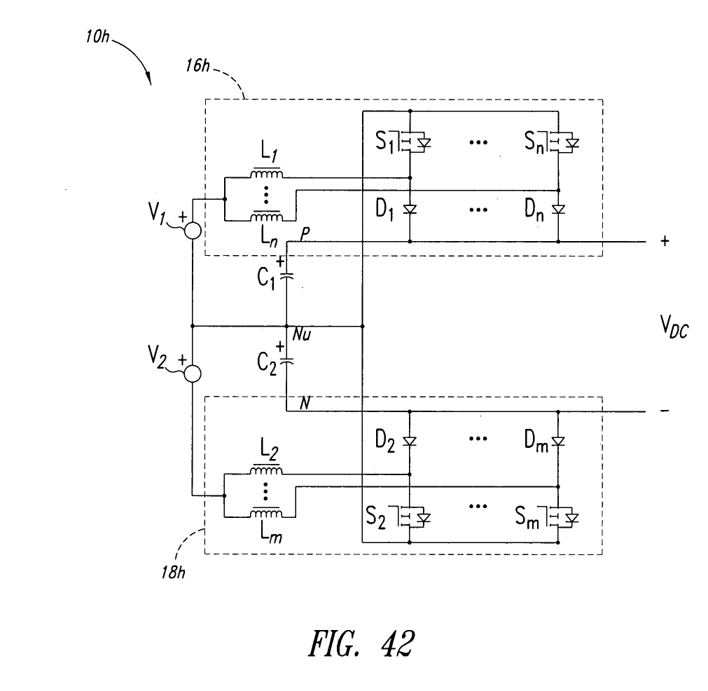

For embodiments having two primary power sources (for example, see at least FIG. 42), the high voltage bus votage (UPN) across nodes P and N can be described as:
U_{PN}=(V_{FC1}+V_{FC2})/(1−D) (1)

where V_{FC1}, V_{FC2} correspond to voltages of the first primary power source V₁ and the second primary power source V₂, respectively, D is the duty cycle of the boost switch, and UPN is the output voltage of the dual feed boost converter. V_{FC1}, V_{FC2} may correspond to, but are not limited to, the fuel cell stack output voltages.

In the above description, duty cycle D is identical for both the upper and lower sections of the converter. However, if there is reason to draw a different power level from either half of the stack, or if the two voltages V_{FC1} and V_{FC2} are different, then D could be controlled independently for the two halves. In such an operational mode, however, the designer must take care to size the neutral conductor for the worst case current that would flow in this unbalanced operation.

FIG. 8 shows a timing diagram 50 including gating control signals 28a for controlling operation of the auxiliary power converter 30 of FIG. 2 to provide power to the electric machine 14, for example in a drive mode. The controller 28 may execute instructions to provide appropriate control signals 28a to the power semiconductor switches S₁₃-S₁₈ of the auxiliary power converter 30 based on the timing diagram 50. The timing diagram 50 also shows the change in currents I_{L9}-I_{L10} over time through the boost inductors L₉-L₁₁, respectively, of the auxiliary power converter 30.

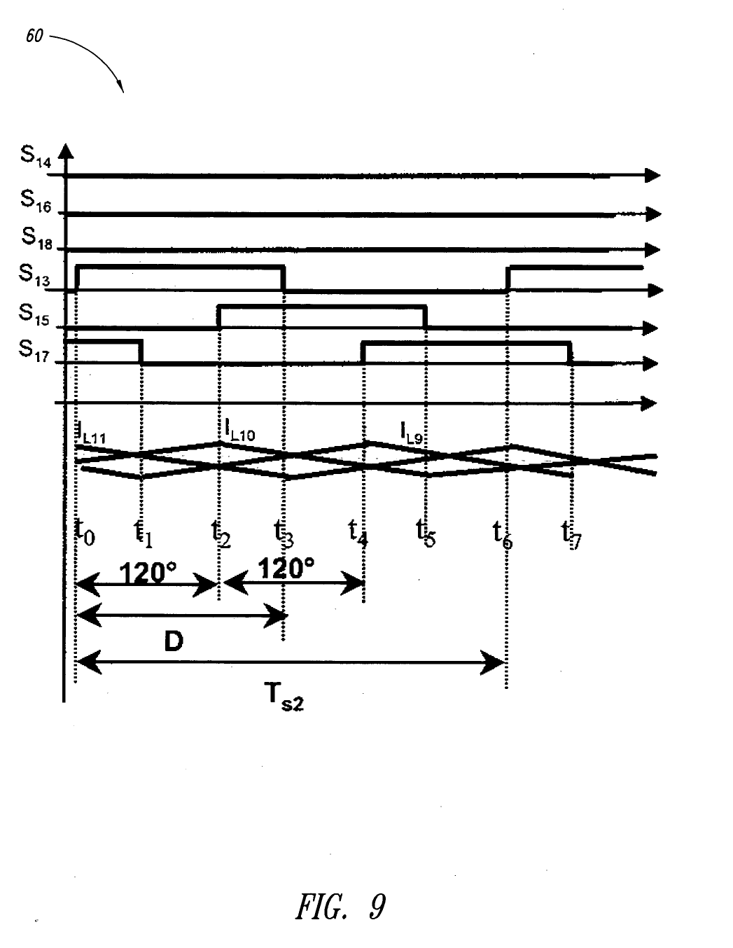

FIG. 9 shows a timing diagram 60 including gating control signals 28a for controlling operation of the auxiliary power converter 30 of FIG. 2 to provide power to the auxiliary power source V_{A} in the form of a power storage device, for example in a regenerative braking mode. The controller 28 may execute instructions to provide appropriate control signals 28a to the power semiconductor switches S₁₃-S₁₈ of the auxiliary power converter 30 based on the timing diagram 60. The timing diagram 60 also shows the change in currents I_{L9}-I_{L11} over time through the boost inductors L₉-L₁₁, respectively, of the auxiliary power converter 30.

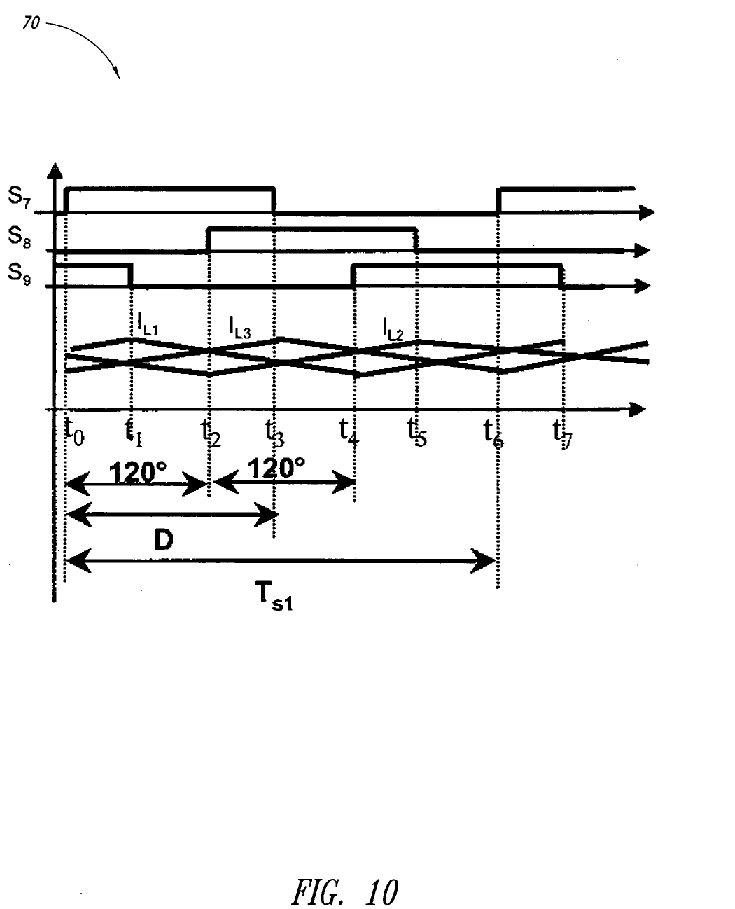

FIG. 10 shows a timing diagram 70 including gating control signals 28a for controlling operation of the first primary three-phase interleaved switch mode DC/DC converter 16f of FIG. 6 to provide power to the electric machine 14, for example in a drive mode. The controller 28 may execute instructions to provide appropriate control signals 28a to the power semiconductor switches S₇-S₉ of the first primary three-phase interleaved switch mode DC/DC converter 16f based on the timing diagram 70. The timing diagram 70 also shows the change in currents I_{L1}-I_{L3} over time through the boost inductors L₁-L₃, respectively, of the first primary three-phase interleaved switch mode DC/DC converter 16f.

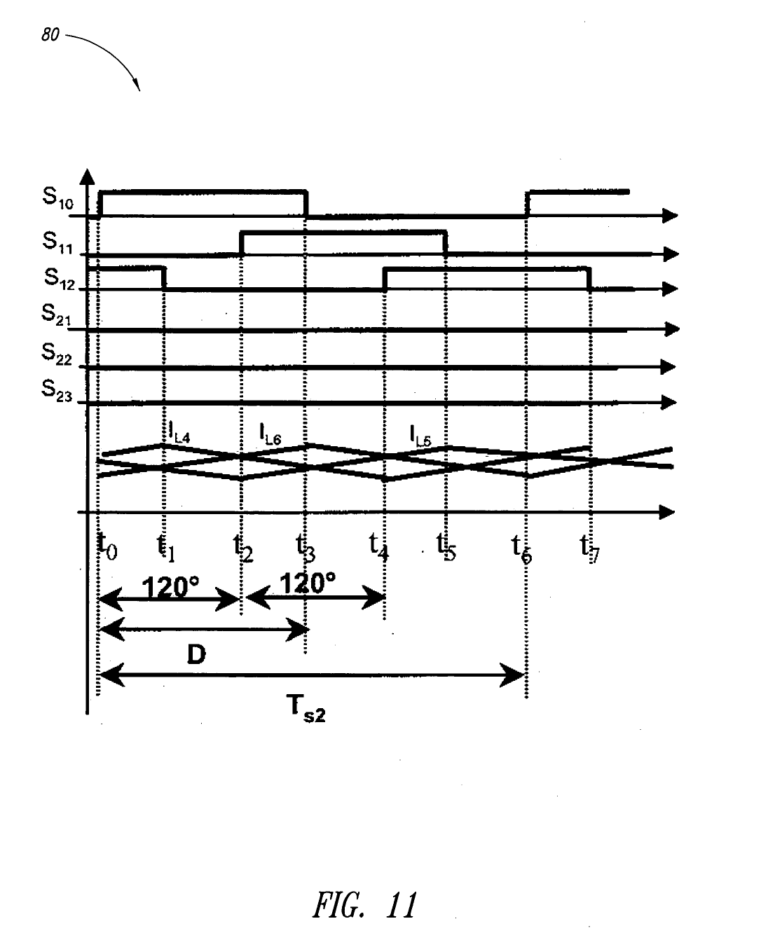

FIG. 11 shows a timing diagram 80 including gating control signals 28a for controlling operation of the second primary three-phase interleaved switch mode buck-boost DC/DC converter 18f of FIG. 6 to provide power to the electric machine 14, for example in a drive mode. The controller 28 may execute instructions to provide appropriate control signals 28a to the power semiconductor switches S₁₀-S₁₂, S₂₁-S₂₃ of the second primary three-phase interleaved switch mode buck-boost DC/DC converter 18f based on the timing diagram 80. The timing diagram 80 also shows the change in currents I_{L4}-I_{L6} over time through the boost inductors L₄-L₆, respectively, of the second primary three-phase interleaved switch mode buck-boost DC/DC converter 18f.

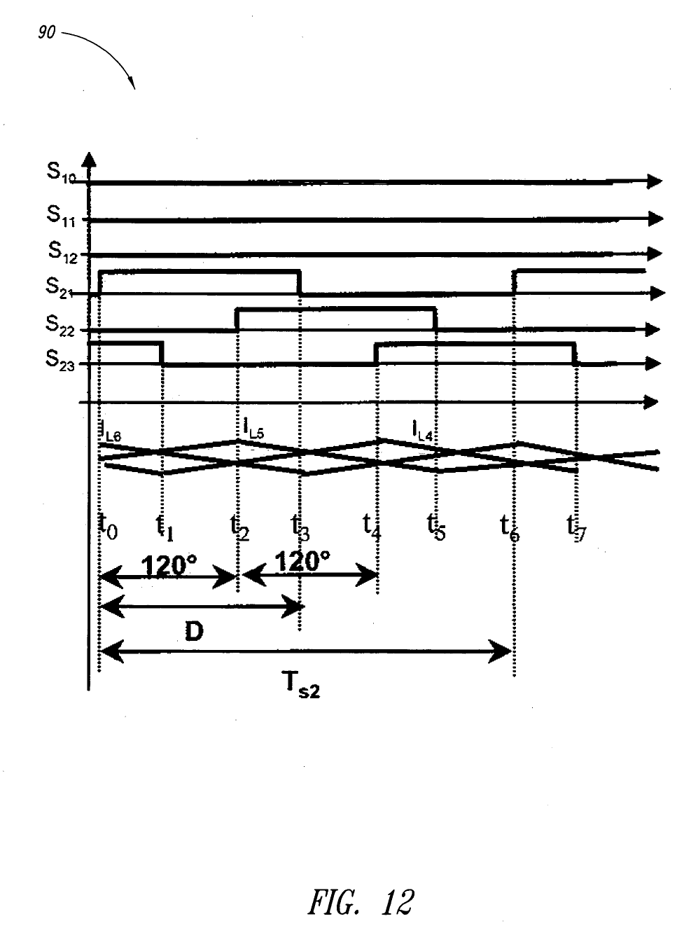

FIG. 12 shows a timing diagram 90 including gating control signals 28a for controlling operation of the second primary three-phase interleaved switch mode buck-boost DC/DC converter 18f of FIG. 6 to provide power to the auxiliary power source V_{A} in the form of a power storage device, for example in a regenerative braking mode. The controller 28 may execute instructions to provide appropriate control signals 28a to the power semiconductor switches S₁₀-S₁₂, S₂₁-S₂₃ of the second primary three-phase interleaved switch mode buck-boost DC/DC converter 18f based on the timing diagram 90. The timing diagram 90 also shows the change in currents I_{L4}-I_{L}6 over time through the boost inductors L4-L₆, respectively, of the second primary three-phase interleaved switch mode buck-boost DC/DC converter 18f.

In some embodiments, the first and second primary power sources V₁, V₂ may take the form of one or more energy producing power sources such as arrays of fuel cells or photovoltaic cells.

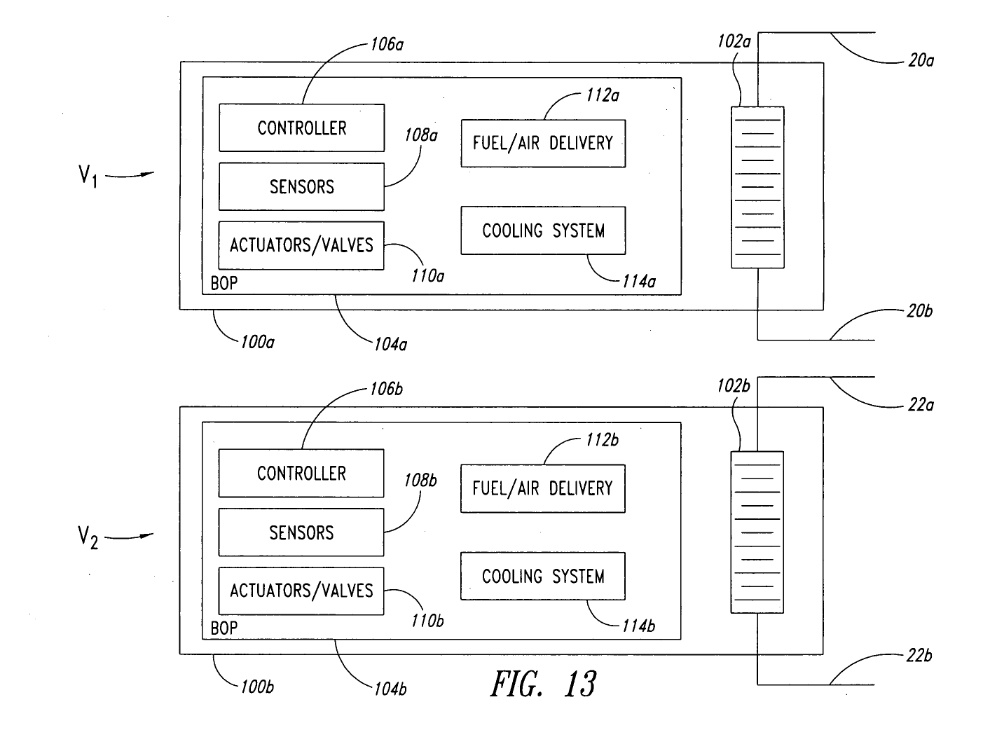

For example, FIG. 13 shows the first and second primary power sources V₁, V₂ in the form of respective fuel cell systems 100a, 100b, each having respective fuel cell stacks 102a, 102b and associated operating components (commonly referred to in the art as “balance of plant” or BOP) 104a, 104b. The BOP 104a, 104b may comprise a controller 106a, 106b, one or more sensors 108a, 108b, one or more actuators and/or valves 110a, 110b, a reactant delivery system 112a, 112b for delivering fuel or air to the fuel cell stack 102a, 102b, and a cooling system 114a, 114b for controlling the temperature of the fuel cell stack 102a, 102b.

The controller 106a, 106b (collectively 106) may take the form of one or more microprocessors, DSPs, ASICS with, or without associated memory, and/or hardwired circuits for controlling operation of the fuel cell system 100a, 100b (collectively 100). The sensors 108a, 108b (collectively 108) may take a variety of forms including but not limited to oxygen sensors, hydrogen sensors, flow rate sensors, pressure sensors, humidity sensors, valve position sensors, and/or temperature sensors. The actuators and/or valves may include various types of actuators, for example solenoids or contactors, and various types of valves to control fluid communication between the fuel cell stack 102a, 102b (collectively 102) and one or more sources of fuel and/or air or other reactant. The reactant delivery system 112a, 112b (collectively 112) may comprise one or more compressors and/or fans to, for example, provide air to the fuel cell stack 102 and/or to provide fuel such as hydrogen to the fuel cell stack 102, as well as any associated valves and actuators 110a, 110b (collectively 110). The cooling system 114a, 114b (collectively 114) may comprise one or more fans or compressors to circulate a coolant, such as air or a liquid coolant to control maintain the temperature of the fuel cell stack 102 within an acceptable operational temperature range.

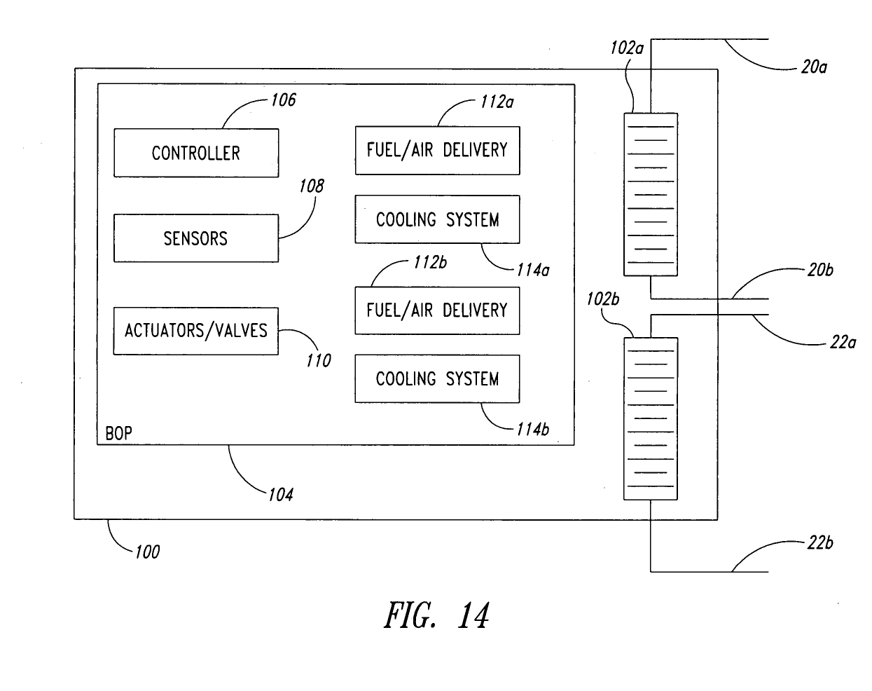

Also for example, FIG. 14 shows the first and the second primary power sources V₁, V₂ in the form of respective fuel cell stacks 102a, 102b which may share some of the BOP 104, for example, the controller 106, sensors 108 and/or actuators/ valves 110, according to one illustrated embodiment.

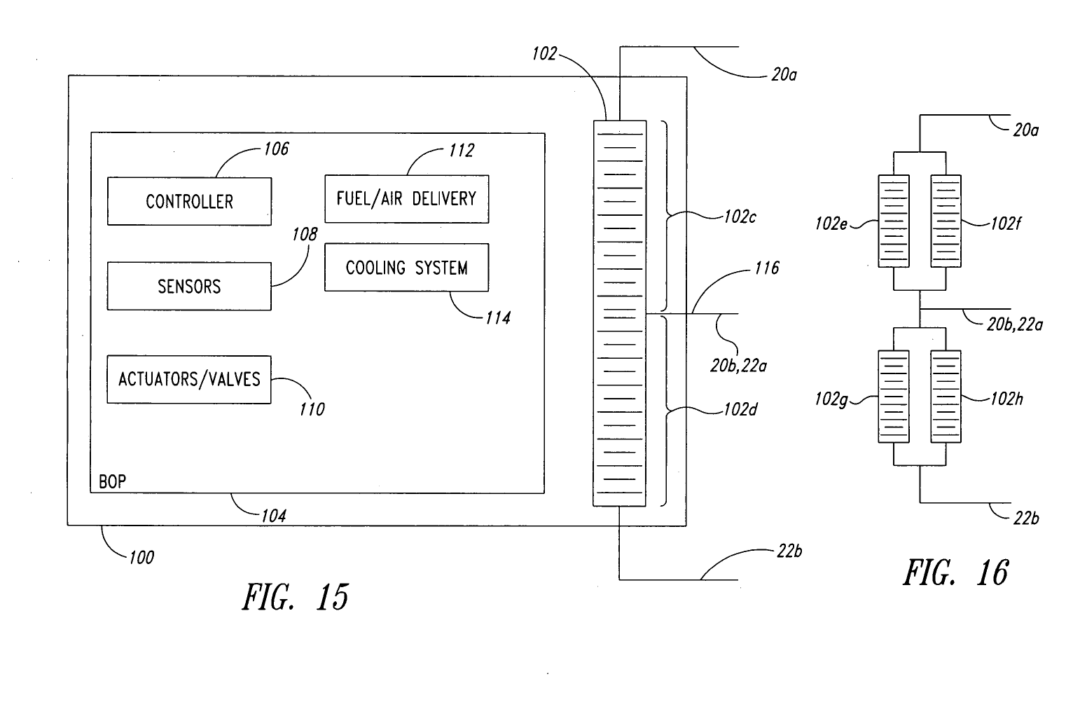

As a further example, FIG. 15 shows the first and the second primary power sources V₁, V₂ in the form of portions of a single fuel cell stack 112 which share substantially all BOP 104, according to another illustrated embodiment. The embodiment of FIG. 15 includes a center tap 116 electrically coupled between the ends of the single fuel cell stack 102. The center tap 116 will typically be coupled at the midpoint of the fuel cell stack 102 such that each portion 102c, 102d of the fuel cell stack provides an approximately equal voltage, although the center tap 116 could be coupled at other points of the fuel cell stack 102 in some embodiments. For convenience, embodiments corresponding to FIG. 15 may be referred to as a split voltage and/or center-tapped fuel cell stack such that the positive and negative DC bus or the AC power inverter are fed separately.

Alternatively, as discussed above in reference to FIG. 6, one or more of the primary power sources V₁, V₂ may take the form of one or more energy storage devices, such as arrays of battery cells and/or super- or ultra-capacitors

The auxiliary power source V_{A} will typically take the form of one or more energy storage devices such as arrays of battery cells and/or super- or ultra-capacitors. Alternatively, the auxiliary power source V_{A} may in some embodiments take the form of one or more power production devices, for example fuel cells or photovoltaic cells.

Where the primary power source V₁, V₂ takes the form of one or more fuel cell stacks 102, the controller 28 may be configured to temporarily create a short circuit path across one or more of the fuel cell stacks 102 to eliminate non-operating power loss (NOPL). Such operation is discussed in more detail in U.S. patent application Ser. No. 10/430,903, entitled METHOD AND APPARATUS FOR IMPROVING THE PERFORMANCE OF A FUEL CELL ELECTRIC POWER SYSTEM, filed May 6, 2003. Using separate fuel cell stacks 102a, 102b, or a fuel cell stack 102 with separate portions 102c, 102d, allows shorting one fuel cell stack or portion at a time while drawing power form the other power source(s), allowing performance and startup benefits without significantly disturbing overall system performance.

Shorting of the fuel cell stack 102 may also allow faster startup in cold weather conditions, such as conditions close to or below the freezing point of water 0° C. Shorting of the fuel cell stack 102 may also allow startup in very cold weather conditions, for example −30° C., where startup would not otherwise have been possible. In this respect, it is noted that fuel cells warm up faster at lower cell voltages, generating more heat per unit of hydrogen, and allowing a higher current draw. This may be made possible since at least some of the above described topologies permit the fuel cell stack 102 to operate at very low voltages. Thus, providing an “extra” boost during startup in freezing or near freezing conditions, maximizes the internal heating of the fuel cell stack 102, while reducing the need to “dump” excess current to a resistive element such as a heater (not shown). This may permit the elimination of the heater. Heaters may not be particularly useful in freezing or near freezing conditions since the heater adds thermal mass to the system and the startup time may be less than the time it takes to transfer heat from the heater to the fuel cell stack 102.

FIG. 16 shows a topology for a fuel cell system suitable for use with the approach taught herein, and with at least some of the embodiments discussed above in reference to FIGS. 13-15. A first fuel cell stack 102e is electrically coupled in parallel with a second fuel cell stack 120f. A third fuel cell stack 102g is electrically coupled in parallel with a fourth fuel cell stack 102h. The first pair of fuel cell stacks 102e, 102f are electrically coupled in series with the second pair of fuel cell stacks 102g, 102h. Where each fuel cell stack 102e-102h is capable of producing 130V, the overall fuel cell stack combination may have an open circuit voltage (OCV) of 260V (i.e., 130V in parallel with 130V plus 130V in parallel with 130V). Thus, the multi-feed approach approximately halves the OCV over single feed approaches.

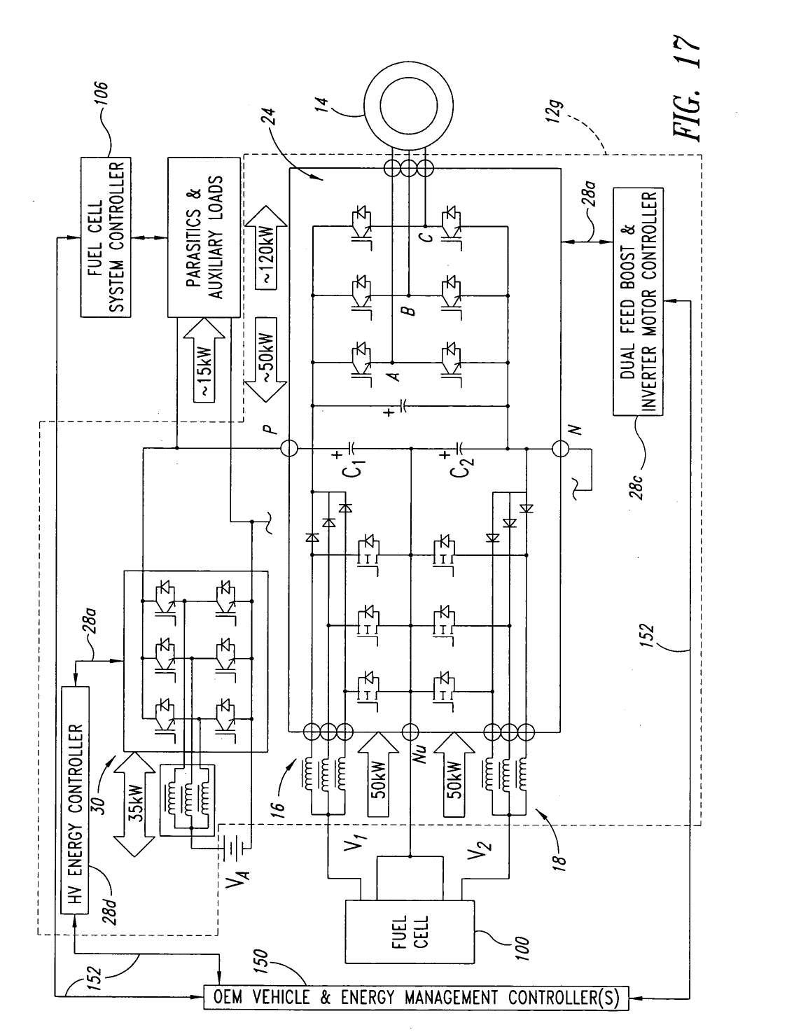

FIG. 17 is a schematic diagram of a power conversion system 12g similar to that of FIG. 1 in an electric or hybrid vehicle embodiment, showing various controllers that cooperatively control the various power producing, power storing and power converting elements of the power conversion system 12g.

As illustrated in FIG. 17, in some embodiments, control may be coordinated among various control systems. For example, the power conversion system controller 28 may comprise a dual feed back and inverter/motor controller 28c coupled to provide control signals 28a to the primary DC/DC power converters 16,18, as well as a high voltage (HV) energy controller 28d coupled to provide control signals 28a to an auxiliary power converter, for example, auxiliary power converter 30. Additionally, the fuel cell system 100 may comprise one or more fuel cell system controllers 106 for operating the fuel cell system 100. The dual feed back and inverter/motor controller 28c, HV energy controller 28d, and fuel cell system controllers 106 may cooperate with one or more original equipment manufacturer (OEM) vehicle and energy management controllers 150, to control the various power sources, primary power converters 16, 18, 24, and/or auxiliary power converter 30, based on various operating conditions of the electric machine 14, primary power sources V₁, V₂ , and/or auxiliary power sources V_{A}. Communications between the various controllers 28c, 28d, 150 may take place over a communications bus, such as a controller area network (CAN) bus 152.

For example, where the electric machine 14 takes the form of a traction motor of an electric or hybrid vehicle, the OEM vehicle and energy management controller 150 may produce current commands requesting certain torque currents I_{q} and/flux currents I_{d} based on a variety of factors including a position of a throttle such as an accelerator pedal and/or a brake actuator such as a brake pedal. The dual feed boost and inverter/motor controller 28c responds accordingly to supply the requested currents I_{q}, I_{d} to the electric machine 14 by applying appropriate gating signals to the gates of the primary power converters 16, 18, 24 and/or auxiliary power converter 30 to increase or decrease power to the electric machiner 14.

The HV energy controller 28d may also respond accordingly, supplying additional power or sinking excessive power to the high voltage DC bus 26 (FIGS. 1 and 4) as required to quickly accommodate changes in demanded power or surplus power. The fuel cell system controller 106 may also respond accordingly, for example, increasing or decreasing the flow of fuel and/or air or oxygen to the fuel cell stack 102 to more slowly accommodate changes in demanded power or surplus power than the response of the HV energy controller 28d, auxiliary power source V_{A}, and auxiliary power converter 30.

Additionally, or alternatively, the fuel cell system controller 106 may place one or more of the fuel cell stacks 102 into a standby or an OFF mode, where the fuel cell stacks 102 produce little or no power. Such operation may increase overall efficiency, for example, where an electric or hybrid vehicle is operating at high speed and low torque for an extended period, or when coasting or braking for an extended period.

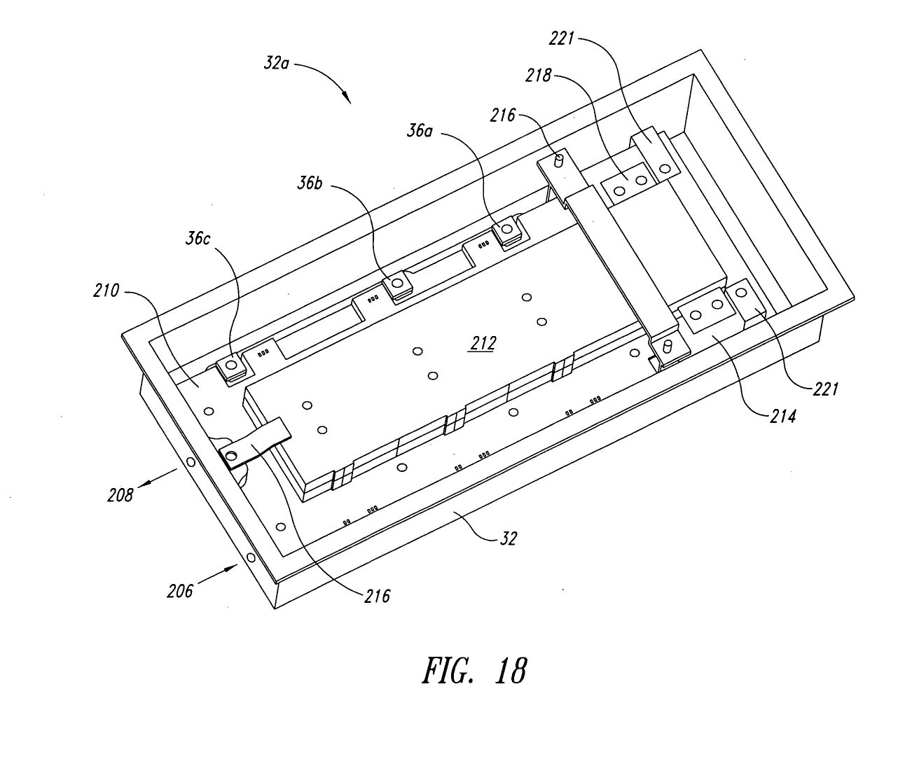

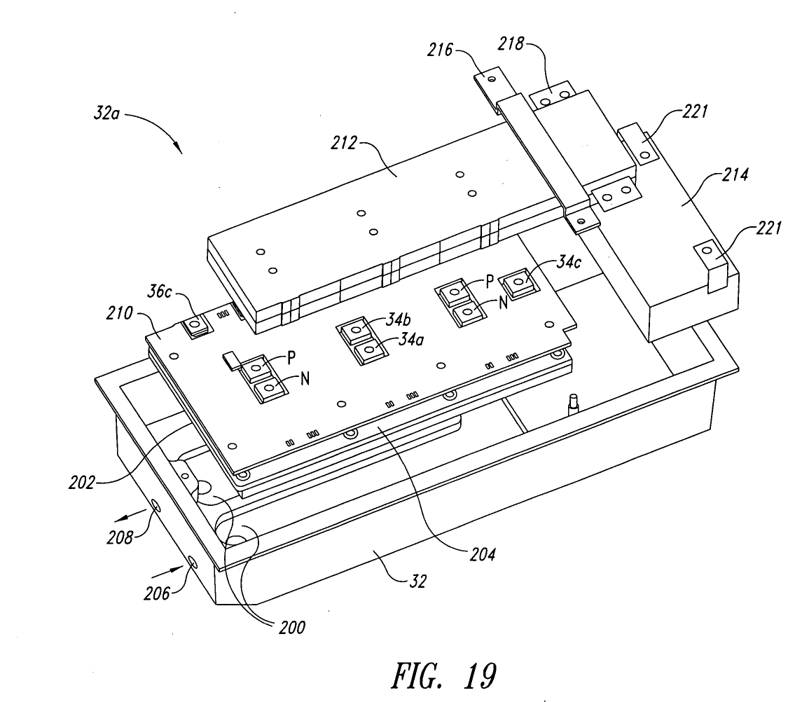

FIGS. 18 and 19 show a power module 32a, comprising a housing 32 formed of an electrically insulative material. The housing 32 may provide an enclosure for all or a portion of the power conversion system 12 discussed above.

The housing 32 may provide an enclosure or channels 200 to provide liquid cooling to a cold plate 202 which carries the various power semiconductor devices of the primary power converters 16,18, 24 and/or auxiliary power converters such as auxiliary power converter 30. The cold plate 202 may take the form of a pin finned aluminum silicon carbide (ALSIC) plate. The use of a ALSIC plate closely matches the thermal expansion properties of a substrate 204 on which the power semiconductor devices are mounted, thus reducing cracking and the void formation associated with thermal cycling. The illustrated embodiment employs liquid cooling of the cold plate 202 via inlet 206 and outlet 208.

As illustrated in FIGS. 18 and 19, the housing 32 may also house a gate driver board 210 which may form part of the controller 28 or which may serve as an intermediary between the controller 28 and the various active power semiconductor devices, for example, power semiconductor switches S₁-S₁₂, S₁₉-S₂₃.

Also as illustrated in FIGS. 18 and 19, in at least one embodiment the capacitors C₁, C₂ or C₁ may take the form of one or more high frequency capacitors 212 and bulk capacitors 214, suitable for a variety of high power applications, for example, supplying power to a traction motor of an electric or hybrid vehicle. The high frequency and bulk capacitors 212, 214 advantageously provide a relatively inexpensive and small footprint option to existing power converters.

The high frequency capacitor 212 may be a film capacitor, rather than an electrolytic capacitor. The high frequency capacitor 212 may be physically coupled adjacent the gate driver board 210 via various clips, clamps, and/or fasteners 216, 218. This provides a tightly coupled, low impedance path for high frequency components of the current. The high frequency capacitor 212 may overlay a portion of the housing 32, and may be electrically coupled to the primary DC bus bars 34a-34c and/or the auxiliary bus bars P,N via terminal portions of the bus bars that may extend through the gate drive board 210.

The bulk capacitor 214 may be an electrolytic capacitor or a film capacitor such as a polymer film capacitor, and may be physically coupled adjacent the gate driver board 210 via various clips, clamps, and/or fasteners 221. The bulk capacitor 214 may be electrically coupled to the primary DC bus bars 34a-34c via the terminal portions. Alternatively, the anode of the bulk capacitor 214 may be electrically coupled to the anode of the high frequency capacitor 212 and the cathode of the bulk capacitor 214 may be electrically coupled to the cathode of the high frequency capacitor 212 via DC interconnects.

Tightly coupling the bulk capacitor 214 and high frequency capacitor 212 to the primary DC bus bars 34a-34c (FIG. 2) avoids bus bar problems typically associated with primary DC bus bars 34a-34c, and may allow the elimination of overvoltage (i.e., snubber) capacitors. The high frequency capacitor 212 provides a very low impedance path for the high-frequency components of the switched current. This my contrast to providing discrete high-frequency paths (sometimes called “decoupling” or “snubber” paths) placed in one or more discrete packages external to the housing 32 of the power module 32a. Since such externally located paths included a significant stray inductance, the discrete package was large. For example, in one embodiment, the discrete capacitor is 1 uF. However, the inclusion of the high frequency capacitor 212 serves the purpose better, but with only 50 nF (5% of the capacitance). Further, this makes the capacitors so small they do not significantly impact the size of the power module 32a, thus possibly eliminating the need for external hardware and volume requirements. Details regarding the use of high frequency and bulk capacitors are taught in commonly assigned U.S. patent application Ser. No. 10/664,808, filed Sep. 17, 2003.

Further details regarding the BOP and operation of fuel cell systems are taught in U.S. patent application Ser. No. 09/916,241, entitled “Fuel Cell Ambient Environment Monitoring and Control Apparatus and Method”; Ser. No. 09/916,117, entitled “Fuel Cell Controller Self-Inspection”; Ser. No. 10/817,052, entitled “Fuel Cell System Method, Apparatus and Scheduling”; Ser. No. 09/916,115, entitled “Fuel Cell Anomaly Detection Method and Apparatus”; Ser. No. 09/916,211, entitled “Fuel Cell Purging Method and Apparatus”; Ser. No. 09/916,213, entitled “Fuel Cell Resuscitation Method and Apparatus”; Ser. No. 09/916,240, entitled “Fuel Cell System Method, Apparatus and Scheduling”; Ser. No. 09/916,239, entitled “Fuel Cell System Automatic Power Switching Method and Apparatus”; Ser. No. 09/916,118, entitled “Product Water Pump for Fuel Cell System”; Ser. No. 09/916,212, entitled “Fuel Cell System Having a Hydrogen Sensor”; Ser. No.10/017,470, entitled “Method and Apparatus for Controlling Voltage from a Fuel Cell System”; Ser. No. 10/017,462, entitled “Method and Apparatus for Multiple Mode Control of Voltage from a Fuel Cell System”; Ser. No. 10/017,461, entitled “Fuel Cell System Multiple Stage Voltage Control Method and Apparatus”; Ser. No. 10/440,034, entitled “Adjustable Array of Fuel Cell Systems”; Ser. No. 10/430,903, entitled “Method and Apparatus for Improving the Performance of a Fuel Cell Electric Power System”; Ser. No. 10/440,025, entitled “Electric Power Plant With Adjustable Array of Fuel Cell Systems”; Ser. No. 10/440,512, entitled “Power Supplies and Ultracapacitor Based Battery Simulator”; and Ser. No. 60/569,218, entitled “Apparatus and Method for Hybrid Power Module Systems,” and Ser. No. 10/875,797 filed Jun. 23, 2004 .

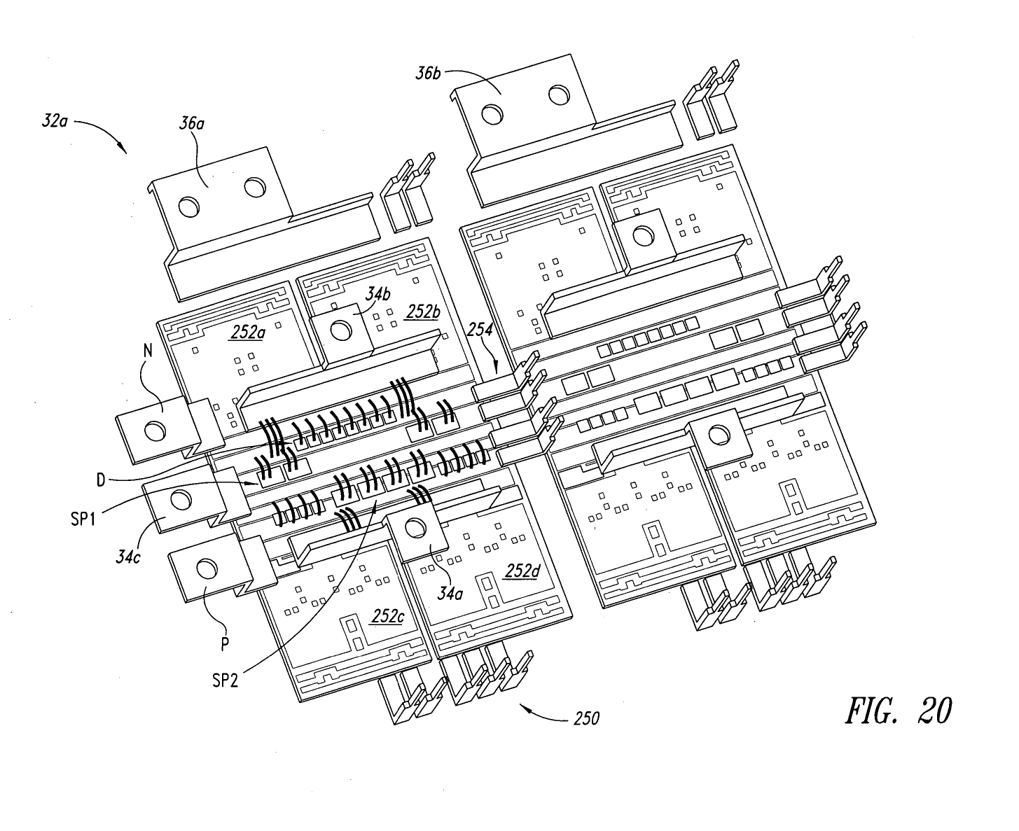

FIG. 20 shows a portion of a power module 32a similar to that of FIG. 2, according to at least one illustrated embodiment.

The power module 32a comprises a primary positive DC bus bar 34a, a primary negative DC bus bar 34b, and a primary neutral DC bus bar 34c. The primary DC bus bars 34a-34c or a terminal portion thereof are each accessible from an exterior of the housing 32 (FIGS. 2-3, 5-6) of the power module 32a, to, for example, make electrical connections to the primary power sources V₁, V₂ via the boost inductors L₁-L₆ (FIGS. 2-3, 5-6). In some embodiments, the boost inductors L₁-L₆ may be housed within the housing 32, thus the primary positive and negative DC bus bars 34a, 34b may not need to be accessible from the exterior of the housing 32. In some embodiments, terminal portions of the primary positive and negative DC bus bars 34a, 34b may located between the primary power sources V₁, V₂ and the inductors L₁-L₆, for example where the boost inductors L₁-L₆ are integrated into the substrate.

The primary DC bus bars 34a-34c are coupled to the power semiconductor diodes D₁-D₆ (collectively D) and switches S₇-S₁₂ (collectively S_{P1}, S_{P2}) of the DC/DC power converter 16, 18 via wire bonds and/or conductive portions of a substrate, for example, a die or direct bonded copper (DBC) or similar substrate. Such a substrate may be formed (etching or depositioning) to have electrically isolated portions to carry current to the respective devices, which may, for example, be surface mounted to the respective portions. The housing 32 may carry a first set of gate terminals 250 that permit electrical connections to the controller 28 (FIGS. 1 and 4) to provide gating control signals 28a, for example from a gate drive board of the controller, to the power semiconductor switches S_{P1}, S_{P2} of the DC/DC power converters 16, 18.

The power module 32a also comprises a positive auxiliary DC bus bar P and a negative auxiliary DC bus bar N. The positive and negative auxiliary DC bus bars P, N or a terminal portion thereof are each accessible from an exterior of the housing 32 (FIGS. 2-3, 5-6) of the power module 32a, to, for example, make electrical connections to the auxiliary power source V_{A} via the auxiliary power converter 30 (FIG. 2). Some embodiments may omit the positive and negative auxiliary DC bus bars P, N, for example, where the auxiliary power source V_{A} is omitted. The positive and negative auxiliary DC bus bars P, N are coupled to the power semiconductor diodes D and switches S_{P1}, S_{P2} of the DC/DC power converter 16, 18 via wire bonds and/or conductive portions of a substrate, for example, a DBC or similar substrate.

The power module 32a further comprises AC phase terminals 36a-36c which are accessible from an exterior of the housing 32 (FIGS. 2-3, 5-6) to make electrical connections to the electric machine 14 (FIGS. 1-6). While the illustrated portion of the power module 32a of FIG. 20 shows only two AC phase terminals 36a, 36b, some embodiments may contain three or even more AC phase terminals for electrically coupling multiphase phase AC power between the power module 32a and the electric machiner 14. For example, many applications may employ three-phase AC power. The AC phase terminals 36a-36b are coupled to the power semiconductor switches S₁-S₆ (omitted from FIG. 19 for clarity of illustration) of the DC/AC power converter 24 via wire bonds and/or conductive portions of a substrate, for example, a DBC or similar substrate. The power semiconductor switches S₁-S6 may, for example, be surface mounted to the substrate at positions 252a-252d. The housing 32 may carry a second set of gate terminals 254 permit electrical connections to the controller 28 to provide gating control signals 28a to the power semiconductor switches S₁-S₆ of the DC/AC power converter 24.

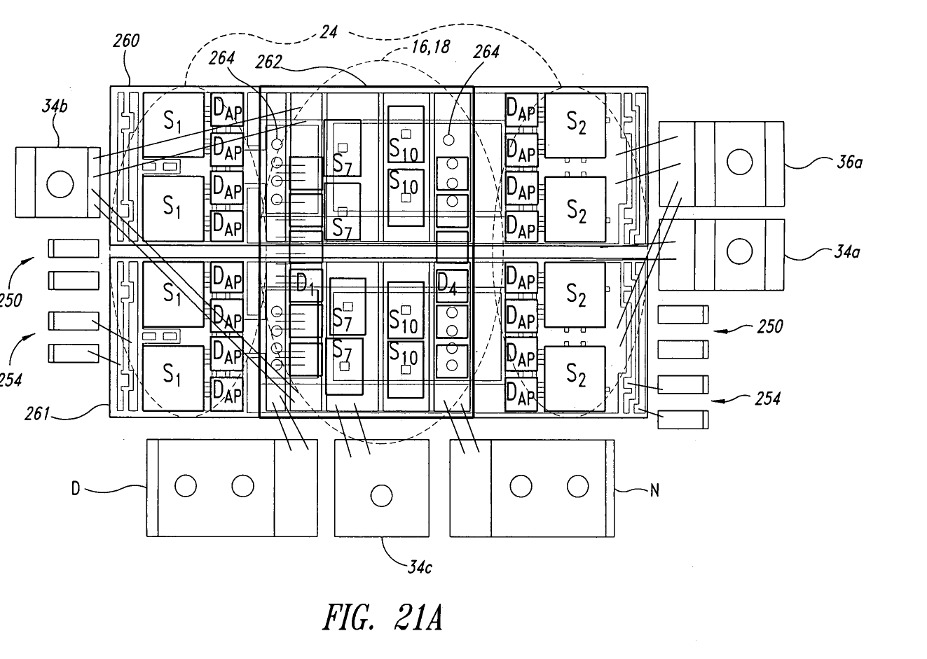

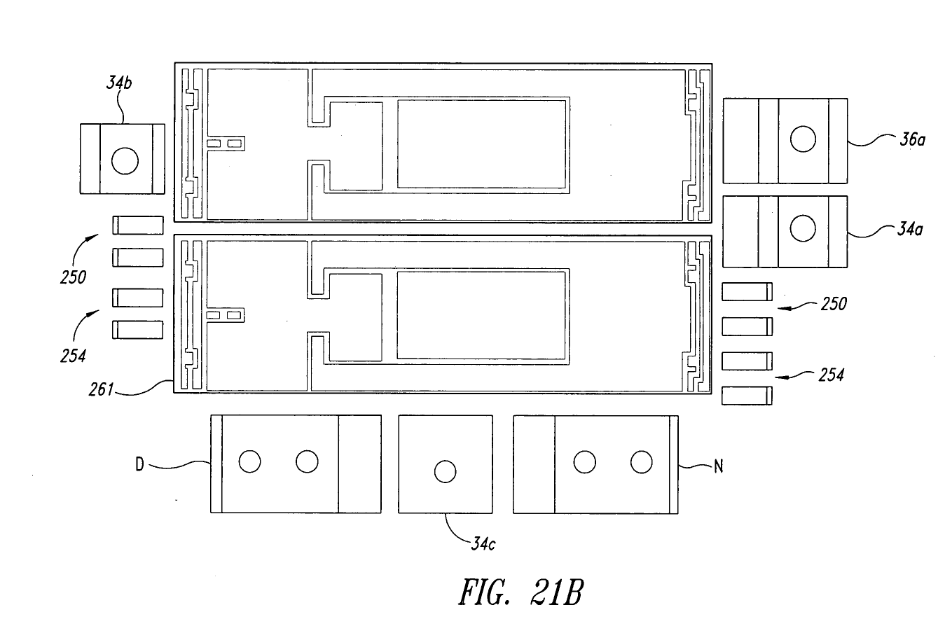

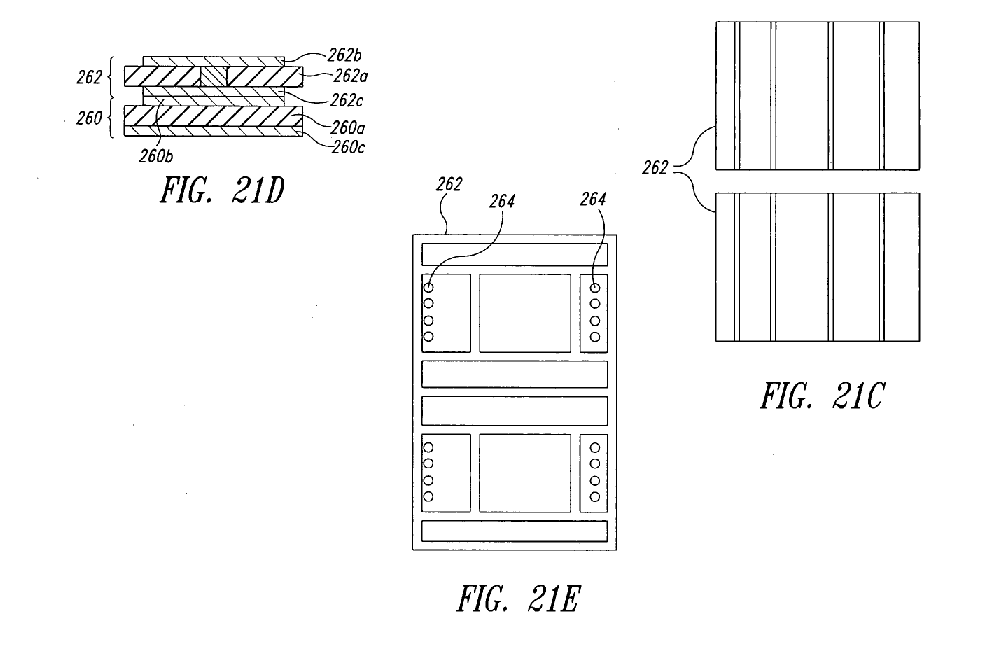

FIG. 21A shows the topology for a single phase of a power module 32a according to one illustrated embodiment employing three substrates in a three-dimensional arrangement to limit the number of wire bonds used in the power module 32.

A first substrate 260 and a second substrate 261 parallel to the first substrate 260, each carry the DC/AC power converter 24 components. For example, the first and the second substrates 260, 261 may carry the power semiconductor switches S₁, S₂ in the form of IGBTs and associated discrete anti-parallel diodes D_{AP}. Note, that in the illustrated embodiment the power semiconductor switches S₁, S₂ are each implemented as four IGBTs electrically coupled in parallel. Also note that in the illustrated embodiment, two anti-parallel diodes D_{AP}are provided for each of the IGBTs.

As best illustrated in FIG. 21 D, the first and second substrates 260, 261 may take the form of multi-layer substrates, for example, DBC substrates comprising a ceramic layer 260a sandwiched by upper and lower electrically conductive layers 260b, 260c, respectively, which may for example comprise copper layers. As best illustrated in FIG. 21 B, the electrically conductive layers 260b, 260c of the first and second substrates 260, 261 are patterned to form electrical patterns, traces or connections to electrically couple some components with other components, and to electrically isolate some components from other components. In particular, the electrically conductive upper layer 260a may be patterned to form various conductive regions on which the IGBTs and anti-parallel diodes D_{AP} are surface mounted.

With returning reference to FIG. 21A, a third substrate 262 overlies the first and second substrates 260, 261. The third substrate carries the DC/DC power converter 16, 18 components, such as the semiconductor switches and associated anti-parallel diodes S₇, S₁₀, and the diodes D₁, D₄ (only two specifically called out in the Figure for the sake of clarity). Note, that in the illustrated embodiment the power semiconductor switches S₁, S₂ are each implemented as four MOSFETs and their associated body diodes electrically coupled in parallel, and the diodes D₁, D₄ are each implemented by six semiconductor diodes electrically coupled in parallel. FIG. 21A also illustrates a number of wire bonds, for example, wire bonds that electrically couple the DC bus bars 34a-34c, N, P, and AC phase terminals 36a to the substrates 260, 261, 263, as well as wire bonds that electrical couple various components to one another or to various regions. Thus, while wire bonds are not eliminated, this topology advantageously reduces the number of wire bonds.

As best seen in FIG. 21D, the third substrate 262 may take the form of a multi-layer substrate, for example, a DBC substrate comprising a ceramic layer 262a sandwiched by upper and lower electrically conductive layers 262b, 262c, which may for example comprise copper layers. The electrically conductive upper and lower layers 262b, 262c of the third substrate 262 are patterned to form electrical patterns, traces or connections to electrically couple some components with other components, and to electrically isolate some components from other components. In particular, as best shown in FIG. 21C, the electrically conductive upper layer 262b of the third substrate 262 is patterned to patterned to form various conductive regions on which the MOSFETs and diodes D_{AP} are surface mounted. The electrically conductive bottom layer 262c of the third substrate 262 is soldered to the electrically conductive upper layer 260b of the first and the second substrates 260, 261. Thus, the electrically conductive bottom layer 262c of the third substrate 262 should be patterned, as best illustrated in FIG. 21E, to approximately match the patterned portions of the electrically conductive upper layer 260b of the first and second substrates 260, 261 over which the third substrate 262 lays, to avoid inadvertently providing a short circuit path between the various conductive regions. Vias 264 (indicated by open circles, only a few of which are specifically called out in the Figures for sake of clarity) formed in the third substrate 262 extending through the insulative layer 262a, provide electrical couplings (indicated by darken circles, only a few of which are specifically called out in the Figures for sake of clarity) between the upper conductive layer 262b of the third substrate 262 to the upper conductive layers 260b of the first and second substrates 260, 261 by way of the lower electrically conductive layer 262c of the third substrate 262.

The above described topology employs patterns, traces or connections and/or vias to eliminate a large number of wire bonds that would otherwise be employed. The reduction in the number of wire bonds required reduces the footprint of the power module 32a, and may reduce cost and/or complexity by reducing the number of discrete elements (wire bonds), and steps associated with attaching those wire bonds. Other phases of the power module 32a may employ similar topologies.

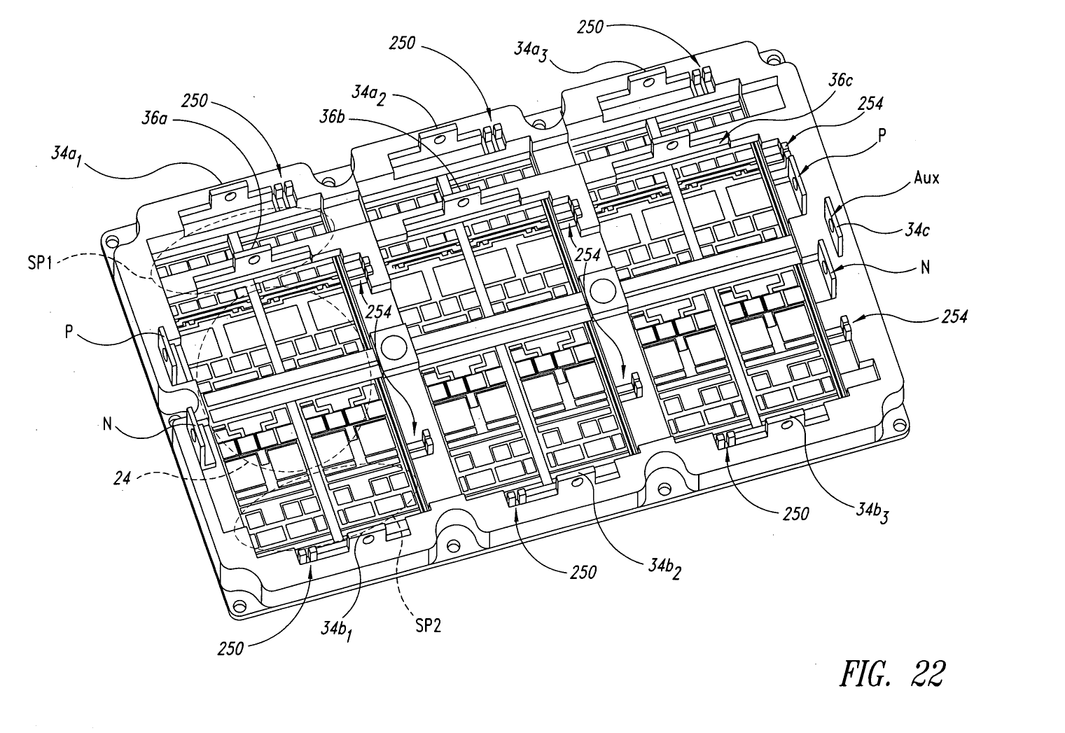

FIG. 22 shows a power module 32b according to another illustrated embodiment.

The power module 32b comprises a set of three primary positive DC bus bars 34a₁-34a₃, a set of three primary negative DC bus bars 34b₁-34b₃, and a primary neutral DC bus bar 34c. The primary positive, negative and neutral bus DC bus bars 34a-34c or a terminal portion thereof are each accessible from an exterior of the housing 32 (FIGS. 2-3, 5-6) of the power module 32b, to, for example, make electrical connections to the primary power sources V₁, V₂ via the boost inductors L₁-L₆ (FIGS. 2-3, 5-6). In some embodiments, the boost inductors L₁-L₆ may be housed within the housing 32, thus the primary positive and negative DC bus bars 34a, 34b may not need to be accessible from the exterior of the housing 32. In some embodiments the primary positive and negative DC bus bars 34a, 34b may be located between the primary power sources V₁, V₂ and the inductors L₁-L₆, for example where the boost inductors L₁-L₆ are integrated into or onto the substrate.

The primary DC bus bars 34a-34c are coupled to the power semiconductor diodes D₁-D₆ (FIGS. 2-3, 5-6) and switches S₇-S₁₂, S₁₉-S₂₃ (not individually called out in FIG. 22, but collectively called out as S_{P1}, S_{P2} for clarity of illustration) of the DC/DC power converter 16, 18 via wire bonds and/or conductive portions of a substrate, for example, a DBC or similar substrate. Such a substrate may be formed to have electrically isolated portions to carry current to the respective devices, which may, for example, be surface mounted to the respective portions. The housing 32 may carry a first set of gate terminals 250 that permit electrical connections to the controller 28 (FIGS. 1 and 4) to provide gating control signals 28a to the power semiconductor switches S₇-S₁₂, S₁₉-S₂₃ of the DC/DC power converters 16, 18 (FIGS. 2-3, 5-6).

The power module 32a also comprises a positive auxiliary DC bus bar P and a negative auxiliary DC bus bar N. The positive and negative auxiliary DC bus bars P, N or a terminal portion thereof are each accessible from an exterior of the housing 32 (FIGS. 2-3, 5-6) of the power module 32a, to, for example, make electrical connections to the auxiliary power source V_{A} via the auxiliary power converter 30 (FIG. 2). Some embodiments may omit the positive and negative auxiliary DC bus bars P, N, for example, where the auxiliary power source V_{A} is omitted. The positive and negative auxiliary DC bus bars P, N are coupled to the power semiconductor diodes D and switches S_{P1}, S_{P2} of the DC/DC power converter 16, 18 via wire bonds and/or conductive portions of a substrate, for example, a DBC or similar substrate. The capacitors C₁, C₂ (FIGS. 1-3), may be coupled between the primary neutral DC bus bar 34c₃ and the positive auxiliary DC bus bar P and a negative auxiliary DC bus bar N, respectively.

The power module 32a further comprises AC phase terminals 36a-36_{c}. The AC phase terminals 36a-36c or a terminal portion thereof are accessible from an exterior of the housing 32 (FIGS. 2-3, 5-6) to make electrical connections to the electric machine 14 (FIGS. 1-6). Each of the AC phase terminals 36a-36c may electrically couple a respective phase of multiphase AC power between the power module 32a and the electric machiner 14. The AC phase terminals 36a-36c are coupled to the power semiconductor switches S₁-S₆ (not individually called out in FIG. 22, but collectively called out for clarity of illustration) of the DC/AC power converter 24 via wire bonds and/or conductive portions of a substrate, for example, a DBC or similar substrate. The housing 32 may carry a second set of gate terminals 254 permit electrical connections to the controller 28 to provide gating control signals 28a to the power semiconductor switches S₁-S₆ (FIGS. 2-3, 5-6) of the DC/AC power converter 24.

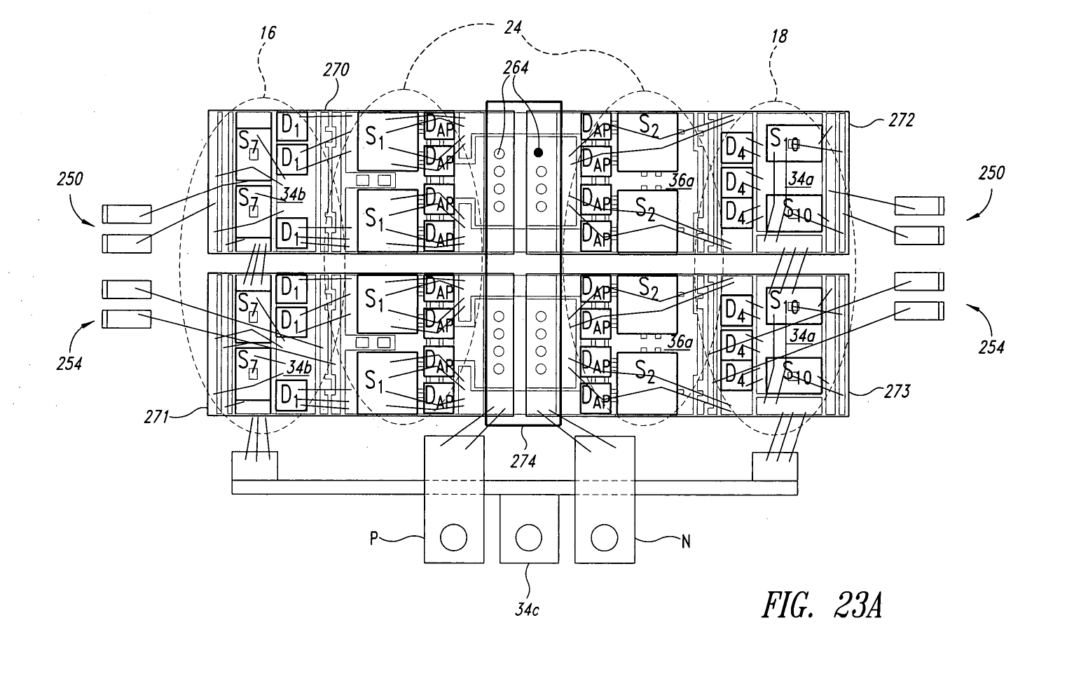

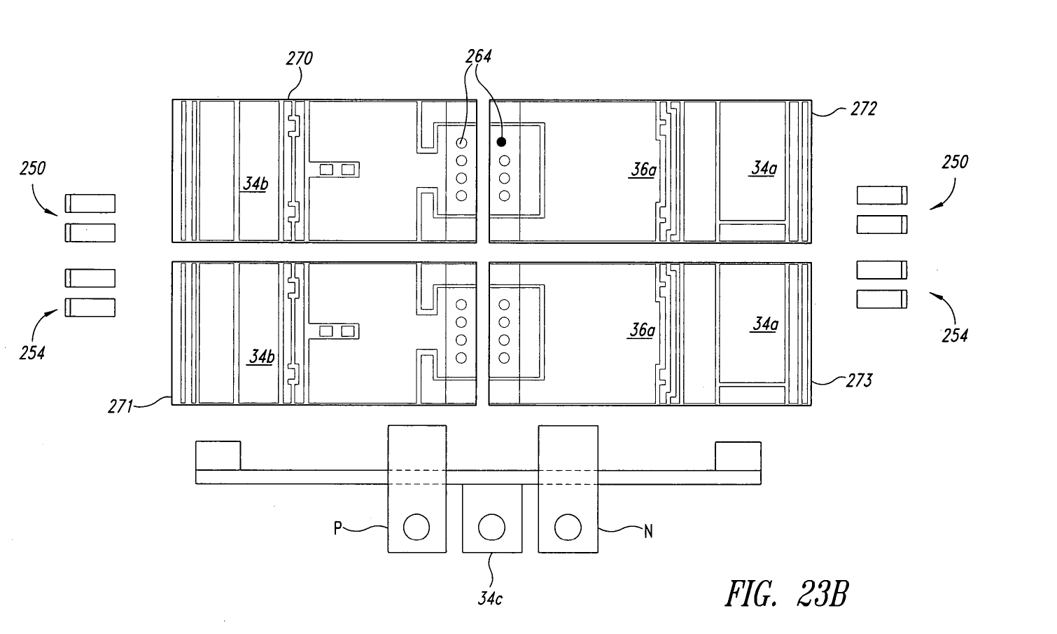

FIG. 23A shows the topology for a single phase of a power module 32a according to one illustrated embodiment employing five substrates in a three-dimensional arrangement to limit the number of wire bonds used in the power module 32a.

First and second substrates 270, 271 each carry components of the first primary DC/DC power converter 16 and DC/AC power converter 24. For example, the first and second substrates 270, 271 may carry the semiconductor switches and associated anti-parallel diodes S₇, and the diodes D₁, as well as, the power semiconductor switches S₁ in the form of IGBTs and associated discrete anti-parallel diodes D_{AP}. Similarly, the third and fourth substrates 272, 273 each carry components of the second primary DC/DC power converter 18 and DC/AC power converter 24. For example, the third and the fourth substrates 272, 273 may carry the power semiconductor switches and associated anti-parallel diodes S₁₀, and the diodes D₄, as well as, the power semiconductor switches S₂ in the form of IGBTs and associated discrete anti-parallel diodes D_{AP}. Note, that in the illustrated embodiment the power semiconductor switches S₁, S₂ are each implemented as four IGBTs electrically coupled in parallel. Also note that in the illustrated embodiment, two anti-parallel diodes D_{AP} are provided for each of the IGBTs. Also note that in the illustrated embodiment the power semiconductor switches S₁, S₂ are each implemented as four MOSFETs and their associated body diodes electrically coupled in parallel, and the diodes D₁, D₄ are each implemented by six semiconductor diodes electrically coupled in parallel.

The first, second, third and fourth substrates 270-273 may each take the form of multi-layer substrates, for example a DBC substrate, similar to that illustrated in FIG. 21D. Thus, the first, second, third and fourth substrates 270-273 may each comprise a ceramic layer 260a sandwiched by upper and lower electrically conductive layers 260b, 260c, respectively. As best illustrated in FIG. 23B, the electrically conductive layers 260b, 260c of the first, second, third and fourth substrates 270-273 are patterned to form electrical patterns, traces or connections to electrically couple some components with other components, and to electrically isolate some components from other components. In particular, the electrically conductive upper layer 260a may be patterned to form various conductive regions on which the IGBTs S₁, anti-parallel diodes D_{AP}, MOSFETs and associated anti-parallel diodes S₇, S₁₀, and diodes D₁, D₄ are surface mounted.

With returning reference to FIG. 23A, a fifth substrate 274 overlies the first, second, third and fourth substrates 270-273. The fifth substrate 274 serves main bus. The fifth substrate 274 may take the form of a multi-layer substrate, for example a DBC substrate, similar to that illustrated in FIG. 21 B. Thus, the fifth substrate 274 may comprise a ceramic layer 262a sandwiched by upper and lower electrically conductive layers 262b, 262c. The electrically conductive upper and lower layers 262b, 262c of the fifth substrate 274 are patterned to form electrical patterns, traces or connections to electrically couple some components with other components, and to electrically isolate some components from other components. In particular, the electrically conductive bottom layer 262c of the fifth substrate 274 is soldered to the electrically conductive upper layer 260b of the first, second, third and fourth substrates 270-273. Thus, the electrically conductive bottom layer 262c of the fifth substrate 274 should be patterned to approximately match the patterned portions of the electrically conductive upper layer 260b of the first, second, third and fourth substrates 270-273 over which the fifth substrate 274 lays, to avoid inadvertently providing a short circuit path between the various conductive regions. Vias 264 (indicated by circles, only a few of which are specifically called out in the Figures for sake of clarity) formed in the fifth substrate 274 extending through the insulative layer 262a, provide electrical couplings between the upper conductive layer 262b of the fifth substrate 274 to the upper conductive layers 260b of the first, second, third and fourth substrates 270-273 by way of the lower electrically conductive layer 262c of the fifth substrate 274.

FIG. 23A also illustrates a number of wire bonds, for example, wire bonds that electrically couple the DC bus bars 34c, N, P to the substrates 270-274, as well as wire bonds that electrical couple various components to one another or to various regions. Thus, while wire bonds are not eliminated, this topology advantageously reduces the number of wire bonds.

In this embodiment, respective regions of the first, second, third and fourth substrates 270-273 serve as the primary DC bus bars 34a, 34b and the AC phase terminals 36a. Suitable connectors or terminals may be mounted to these regions.

The above described topology employs patterns, traces or connections and/or vias to a large number of wire bonds that would otherwise be employed. The reduction in the number of wire bonds required reduces the footprint of the power module 32a, and may reduce cost and/or complexity by reducing the number of discrete elements (wire bonds), and steps associated with attaching those wire bonds. Other phases of the power module 32a may employ similar topologies.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other power conversion systems, not necessarily the exemplary two primary DC/DC power converter embodiments generally described above. For example, the power conversion system may comprise additional primary DC/DC power converters or primary DC/DC power converters with different topologies, as may be suited to the particular application. Additionally or alternatively, while the illustrated embodiments generally show three-phase interleaved DC/DC power converter topologies for the primary DC/DC power converters 16,18, some embodiments can include four or more phase legs. Likewise, while some of the illustrated embodiments show two-phase interleaved DC/DC power converter topologies for the auxiliary DC/DC power converters 30, some embodiments can include three or more phase legs. Additionally, or alternatively, the power conversion system 12 may omit the DC/AC power converter 24, or may employ a different topology for the DC/AC converter 24 than that illustrated in the Figures.

As used herein and in the claims, the term “power semiconductor device” includes semiconductor devices designed to handle large currents, large voltages and/or large amounts of power with respect to standard semiconductor devices, including power semiconductor switch devices, power semiconductor diodes and other such devices used in power distribution, for example, grid or transportation related applications. As discussed above, some of the power semiconductor switches discussed herein, for example the semiconductor switches S₇-S₁₂ of the DC/DC converters 16, 18 may, for example, take the form of MOSFETs, while others of the semiconductor switches discussed herein, for example, the semiconductor switches S₁-S₆ of the DC/AC converter 24 may take the form of IGBTs. As noted above, the use of MOSFETS permits the primary DC/DC power converters 16, 18 to operate at higher switching frequencies than would otherwise be possible with IGBTs. However, in some embodiments the semiconductor switches S₇-S₁₂ of the DC/DC converters 16, 18 may take the form IGBTs or other suitably rated switching devices, particular where the desired operating frequency of the DC/DC converters 16, 18 is sufficiently low. Further, in some embodiments the semiconductor switches S₁-S₆ of the DC/AC converter 24 may take the form of MOSFETS, particularly where cost factors permit such.

As noted above, the use of silicon carbide diodes permit higher frequency operation of the primary DC/DC power converters 16, 18 than would otherwise be possible. The use of silicon carbide diodes and MOSFETs in the DC/DC converters 16, 18 may permit switching frequency of approximately 50 kHz or greater, for example 100 kHz. This may be contrasted with the switching frequency of the DC/AC converter 24 employing IGBTs which may be approximately 10 kHz. The relatively high switching frequency realizable through the use of silicon carbide diodes and MOSFETs allows the use of smaller boost inductors L₁-L₆, than could otherwise be used, with attendant advantages such as lower costs, smaller package, and less weight.

In embodiments employing two three-phase interleaved switch mode converters electrically coupled in series, such as the exemplary circuit shown in FIG. 2, each inductor takes ⅓ of the fuel cell output current. However, the inductance is ½ compared with a conventional 3-phase interleaved boost converter (at the same ripple current). With six smaller inductors used by embodiments employing two three-phase interleaved switch mode converters electrically coupled in series, rather than three larger ones used by conventional 3-phase interleaved boost converters, packaging efficiency for the various embodiments is improved. In part, improved packaging efficiency is due to the more favorable form factor of the smaller inductors, relative to the rest of the converter components.

In the various embodiments, the boost switches and diodes operate at 50% of the total DC/DC output voltage. For example, for a total DC output voltage range of 250V to 430V, each half of the converter operates at 125V to 215V. The use of devices with a V_{DSS} of 300V becomes acceptable. 300V MOSFETs typically have R_{DS}_{ON} which is ¼ that of a 600V device. Similarly, a 300V ultrafast diode has a reverse recovery loss Qᵣᵣ which is 1/10 of a 600V ultrafast diode. Because of the dramatically reduced Qrr loss, operating at 100 kHz becomes feasible for a 100 kW converter. These improvements lead to improved efficiency and lower thermal stress.

In some embodiments, the power anti-paralleled semiconductor diodes may constitute a part of the power semiconductor switches, for example, as a body diode, while in other embodiments the power semiconductor diodes may take the form of discreet semiconductor devices. While typically illustrated as a single switch and diode, each of the power semiconductor switches and/or diodes discussed herein may take the form of one or more power semiconductor devices electrically coupled in parallel.

The foregoing detailed description provides apparatus and methods that permit the power source, power conversion system and electric machine to be treated as a single system, allowing greater opportunity for the optimization and improvement of the overall system. This approach permits realizes such by making the voltage of the power source essentially independent from the voltage of the electric machine, employing the unique power conversion system 12 topologies to provide the desired voltage to the electric machine without demanding excessive boost ratios of the DC/DC power converters 16, 18. Such may significantly reduce the cost of and/or improve the efficiency of the power conversion system 12.

This approach permits, for example, new power source designs, for example new fuel stack designs such as separate fuel cell stacks or a center tapped fuel cell stack. Such may reduce or eliminate problems associated with larger fuel cell stacks, such as sealing and mechanical tolerance problems. Such may also allow better matching of electrical and fluid turndown, for example, each fuel cell stack 102a, 102b, or portion 102c, 102d may spend approximately half the time in an idle state. Each fuel cell stack 102a, 102b, or portion 102c, 102d may have half of the turndown ratio, doubling idle current density. Such may have a beneficial effect in extending lifetime and reliability, particular where the fuel cells are PEM fuel cells. Such may also provide a “limp home” capability, where the system operates using power supplied from only one of the fuel cell stacks where the other fuel cell stack or system is inoperable. Such may also significantly solve problems with starting up the fuel cell stack in low temperatures, particular around or below the freezing point of water.

Generally, fuel cells generate a voltage that drops with increasing load. For an exemplary embodiment, described hereinbelow, the design at heavy load conditions assumes that voltage drops towards 200V (100V for each half of the stack). At lighter load, the design of the exemplary embodiment assumes that fuel cell voltage increases to about 400V, and current through all components reduces. Thus, the full load operating condition determines the worst case design point for the dual feed converter. For this exemplary embodiment, the design targets are:
P_{FC}ₒᵤₜ=100 kW
V_{FC1}=V_{FC2}=100V
V_{PN}=250V−430V

For embodiments having two primary power sources and three inductors in a primary DC/DC power converter (for example, see at least FIG. 42), the inductor average current may be calculated as:

$${I}_{{L}_{avg}} = \frac{1}{3} * {P}_{{FC}_{out}} / ( {V}_{FC1} + {V}_{FC2} ) \qquad ( 2 )$$

Given the commanded output voltage, the duty cycle for this exemplary embodiment is determined by the above-described equation (1). The higher the V_{PN}, the larger the duty cycle D. Ignoring the inductor ripple current for now, the RMS current of switches S7-S12, and diodes D1-D6, can be calculated as:
I_{SW} _{ᵣₘₛ}=I_{L}_{_{avg}}*\sqrt{D} (3)
I_{D}_{_{avg}}=I_{L}_{_{avg}}* (1−D) (4)

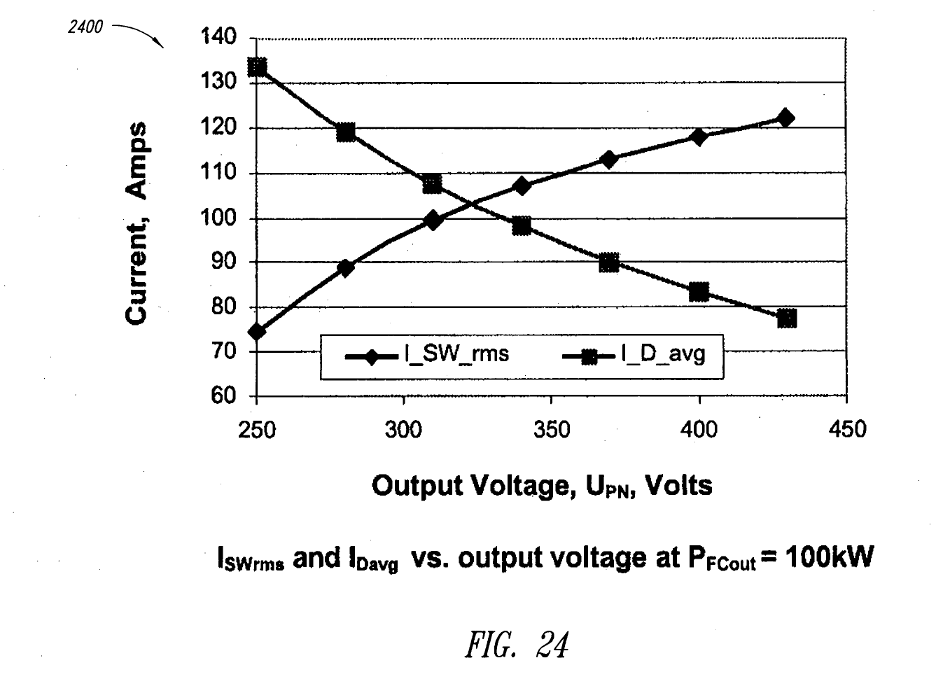

FIG. 24 is a chart 2400 illustrating, for an exemplary MOSFET switch, RMS current and diode average current versus the output voltage at 100 kW input power and 200V total stack input voltage employed in the exemplary embodiment. Given these operating conditions, appropriate MOSFETs and diodes are selected. A “worst case” current for the MOSFET is assumed to be 122 Aᵣₘₛ at an output voltage of 430V, while the diode “worst case” condition is assumed to be 134 A_{avg} at an output voltage of 250V.

For the above-described exemplary embodiment to operate under the above-described conditions, commercially available die have been selected. These commercially available die are shown in Table 1.

TABLE 1
Selected silicon power devices.

| Silicon | Part | | |
|---|---|---|---|
| Device | Number | Die Rating | Die in Parallel |
| MOSFET | IXFD130N30- | 300 V, | 4 |
| | 9Y | 22 mOhm, | |
| | | 130 A | |
| Diode | 30CPH03 | 300 V, 0.85 V, | 5 |
| | | 30 A | |

For this exemplary embodiment, calculation of MOSFET and diode conduction losses is straightforward. The equations are shown in (5) and (6). The loss shown in FIG. 5 for each switch and diode is calculated by using the R_{DS}_{_{—}}_{ON} and V_{f} values at Tⱼ=125° C. at P_{FC}=100 kW.
P_{SW}_{_{cond}}=iᵣₘₛ²* R_{DS}_{_{—}}_{ON}) (5)
P_{D}_{_{cond}}=i_{D}_{_{avg}}*V_{f} (6)

The diode reverse recovery loss is calculated as in (7), given Qᵣᵣ, switching frequency fs, the number of diodes in parallel N, and the impressed voltage U_{d}:
P_{D}_{_{Qrr}}=fₛ*Qᵣᵣ*U_{d}*N (7)

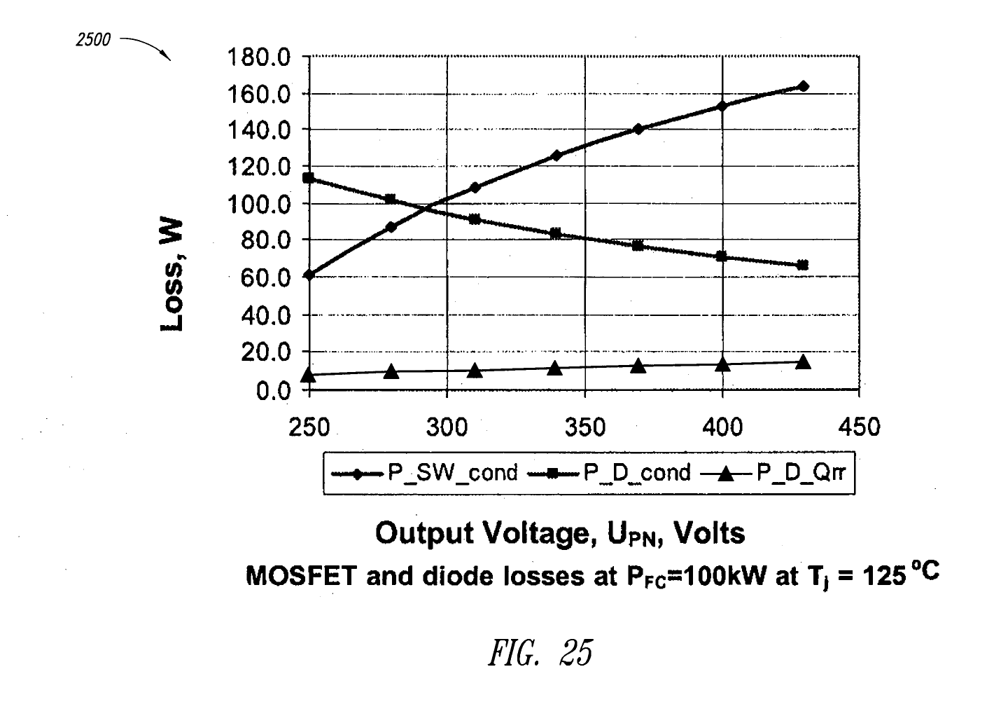

By summing the loss components, total silicon loss for any given operating point are determinable. FIG. 25 is a chart 2500 illustrating, for a 200V input case, an exemplary MOSFET and diode conduction losses, as well as the diode reverse recovery loss for all output voltages, for each of the exemplary six switch/diode pairs. Given the silicon losses, and making an assumption about the inductor and other ohmic losses, a total, full load efficiency is determinable.

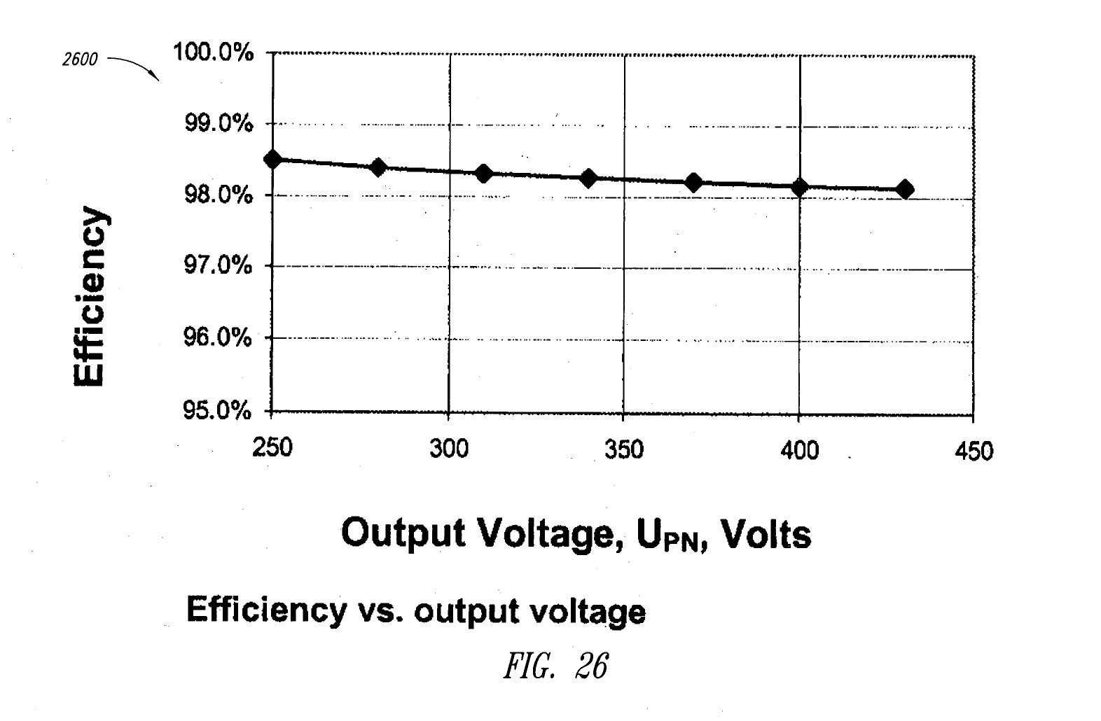

FIG. 26 is a chart 2600 illustrating efficiency mapping for the above-described exemplary embodiment, assuming a 100 kW input power, 200V input voltage, and output voltage range of 250V to 430V. For this design, the full load efficiency varies from 98.1% to 98.5%, decreasing with higher boost ratios.

Note in FIG. 25 that the diode reverse recovery losses are very small, even with 100 kHz switching, relative to the diode conduction losses. As mentioned above, the 300V devices have about 1/10 the Qᵣᵣ than 600V devices. This shows a significant benefit of the various dual feed design embodiments. Conventional devices using 600V diodes would experience an order of magnitude increase in reverse recovery losses, significantly exceeding the diode conduction losses and having a dramatic effect on overall efficiency. As a practical matter, being constrained to use 600V diodes in conventional devices forces a much lower switching frequency and has negative consequences for the inductor and capacitor designs.

Various embodiments may employ Silicon Carbide (SiC) devices. Advantages for SiC include a thermal conductivity three times higher than silicon, the ability to operate at higher temperatures, and an electrical breakdown field that is ten times higher than silicon, or gallium arsenide. Being a wide energy bandgap semiconductor, SiC embodiments are better suited to high frequency applications and where power density is at a premium.

Embodiments employing SiC Schottky devices exhibit superior transient behavior in applications such as this DC:DC converter where the operating voltage ranges between 300V and 600V and the reverse recovery current is reduced to a minimum. Companion benefits to the higher frequency operation include the ability to use smaller inductors and reduced filtering components to minimize EMI production. Given the present economic trade-off between silicon and SiC diode cost, some embodiments parallel several SiC devices to achieve high current operation. The positive temperature coefficient of SiC devices is favorable for paralleling. However, paralleling SiC devices is accompanied by a large V_{f} conduction loss for the same current value as the operating temperature increases. Advances in the processing of ultrafast silicon diodes to improve the lifetime control of recombination centers in the n- region now make ultrafast Si diodes very competitive with the major benefit of SiC devices. Accordingly, embodiments employing SiC devices have significantly lower Qrr reverse recovery energy and a controlled turn-off in the tb region of this recovery. They also feature a lower V_{f} conduction loss which is enhanced by the negative temperature effect of silicon. A comparison between the two diode types has been carried out at the system level in this application. The two part's characteristics are summarized in Table 2.

TABLE 2
Ultrafast Si comparison to SiC Diodes.

| | Part | | | | |
|---|---|---|---|---|---|
| Device | Number | V-I Rating | V_{f} | Qᵣᵣ | # in // |
| Ultrafast | 30CPH03 | 300 V 30 A | 0.85 | 137 nC | 5 |
| SiC | CSD10030 | 300 V 10 A | 1.40 | 11.5 nC | 15 |

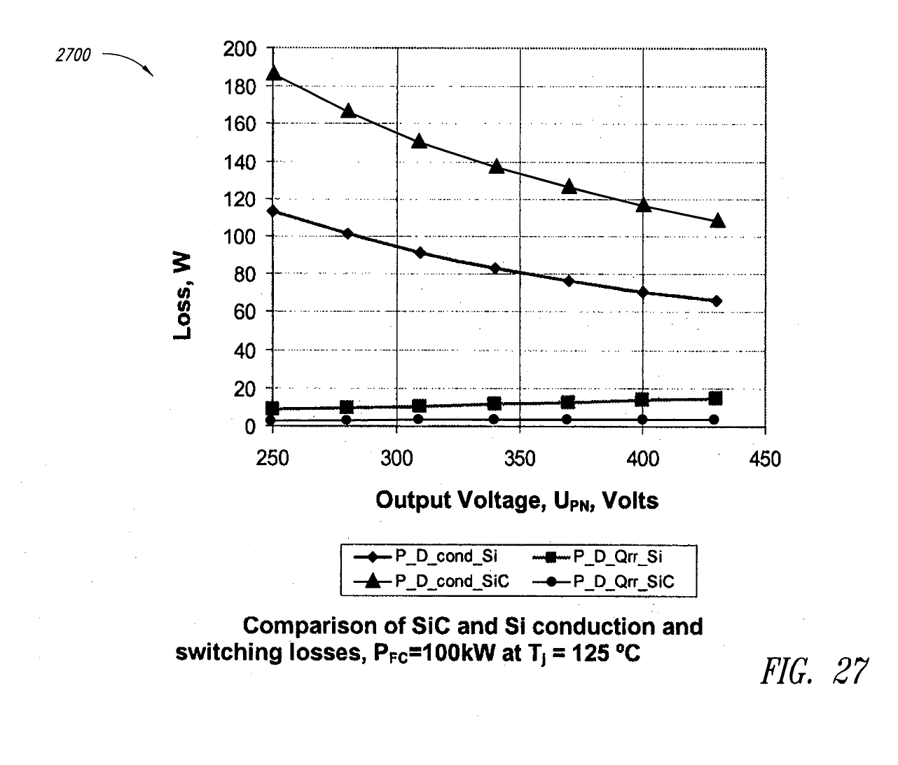

Salient properties of these the above-described devices in Table II are the forward drop and the reverse recovery charge. In the above-described embodiments, the “worst case” condition is full load with minimum input voltage. To compare embodiments employing the two diodes, FIG. 27 illustrates total conduction loss and reverse recovery loss for both diodes over the full boost range. FIG. 27 is a chart 2700 illustrating that the reverse recovery losses for the SiC diode are significantly better than the ultrafast Si diode, but the conduction losses favor the Si diode.

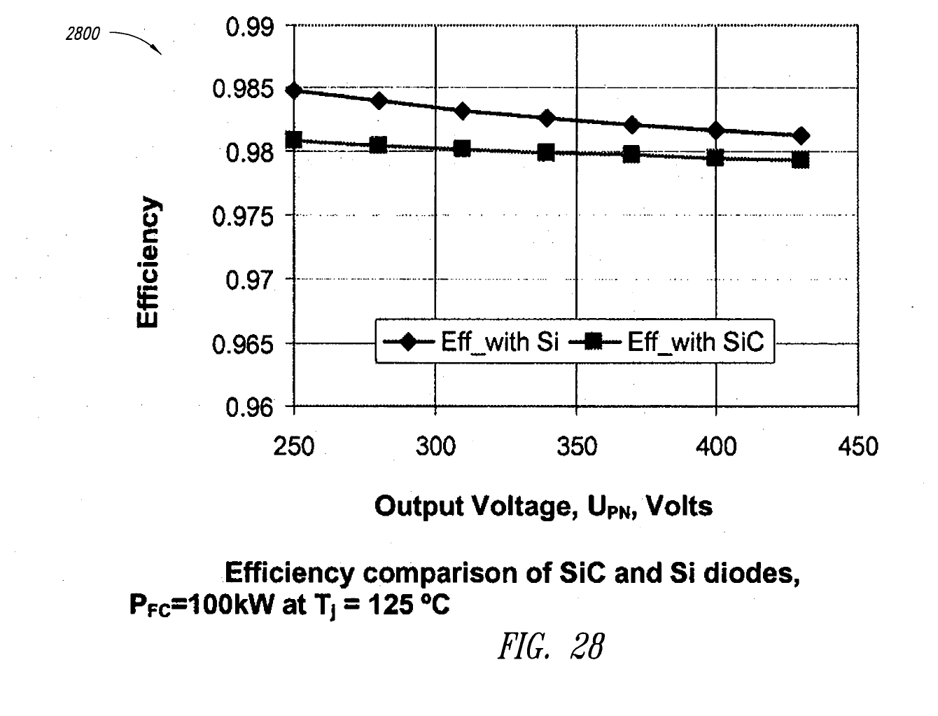

In high power, high switching frequency applications such as this converter, SiC is very attractive because of the low EMI characteristics, even if a small efficiency loss results. FIG. 28 is a chart 2800 illustrating a comparison of system efficiency with SiC diodes compared to ultrafast Si diodes. The penalty with SiC diodes varies from 0.2% to 0.4% overall. However, further development in the SiC diode properties that reduce the V_{f} would be beneficial for these high power converter applications.

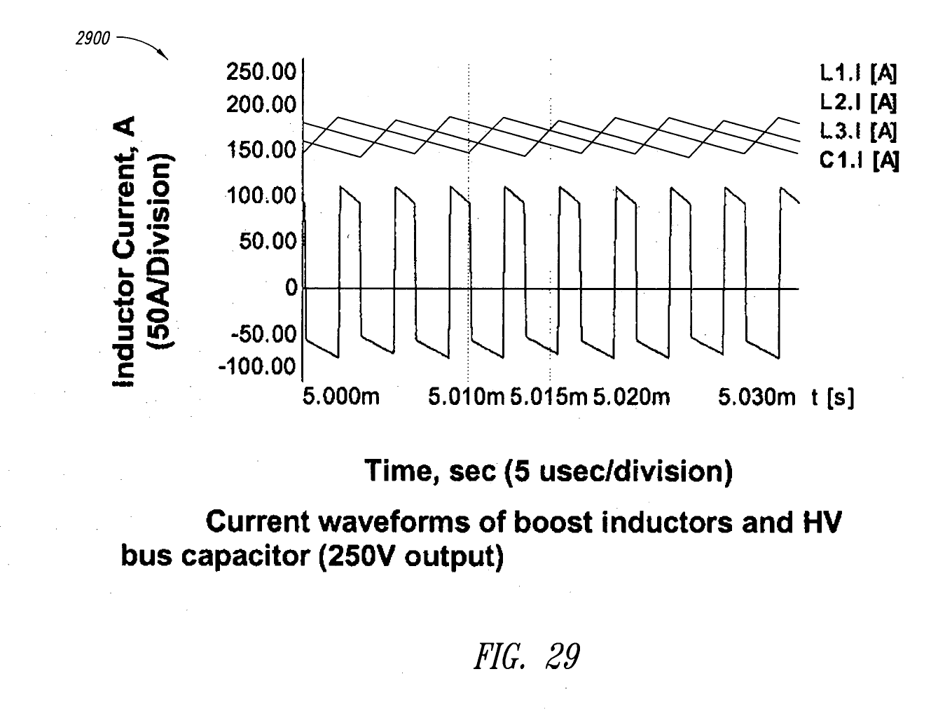

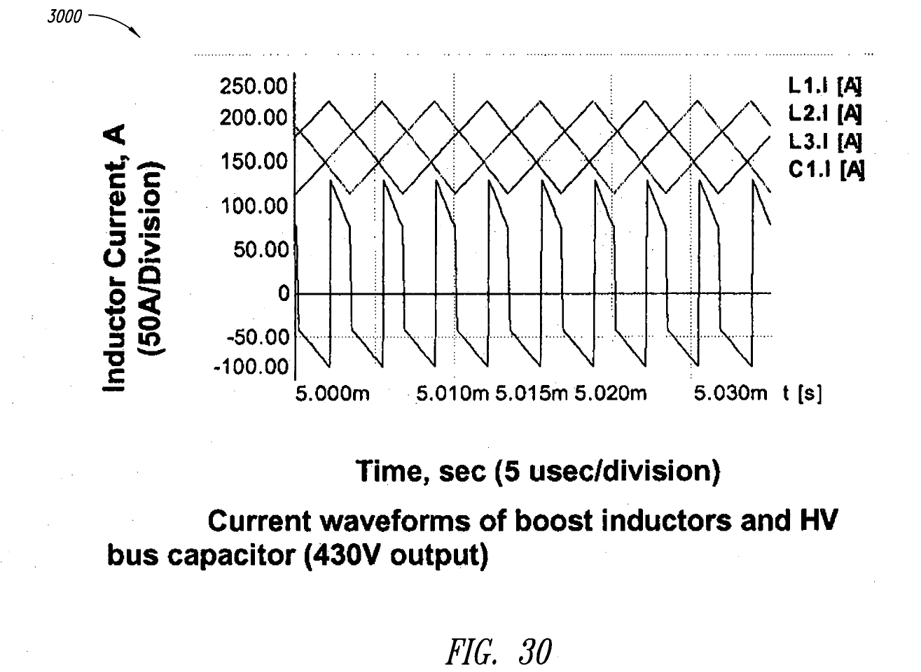

FIGS. 29 and 30 are charts 2900 and 3000, respectively, illustrating the current waveforms of an exemplary embodiment for the boost inductors and high voltage bus capacitor, for the full load operation with input voltage of 200V, and output voltages of 250V and 430V, respectively. This shows the benefit of interleaving for reducing the capacitor ripple current. Inductor peak-to-peak ripple current ΔI_{Lf} is given by:
ΔI_{Lf}=Tₛ* V_{FC1}* D/L_{f} (8)

For this design, Tₛ is 10 usec, L_{f} is 5 uH. The peak to peak ripple current varies from 40 to 107 A for output voltage range of 250V to 430V.

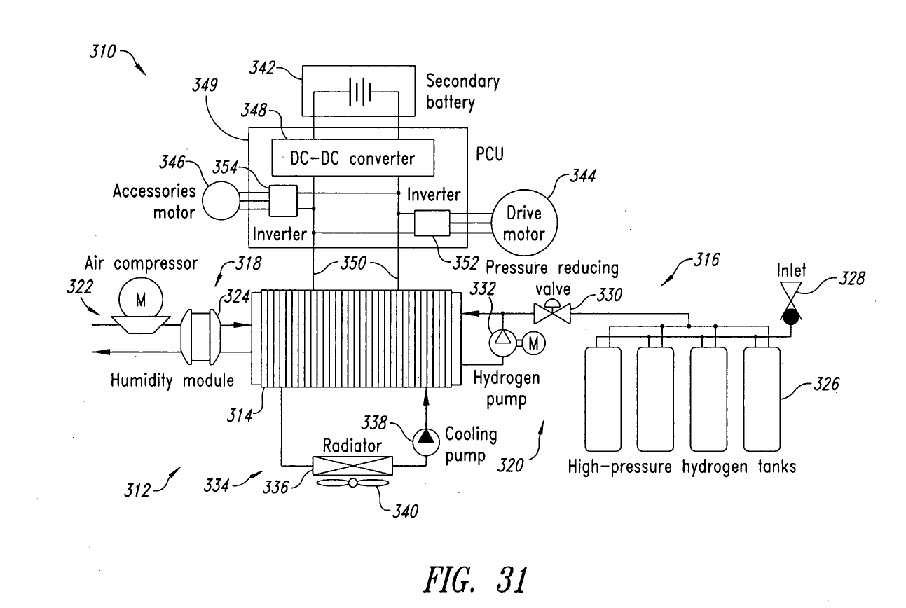

FIG. 31 is a schematic diagram of a power system 310 for a vehicle, for example, but not limited to, a fuel cell vehicle, an electric vehicle or hybrid vehicle employing an embodiments that comprise first and second DC/DC converters electrically coupled in series in a single power module 349.

The power system 310 comprises a fuel cell system 312 including a fuel cell stack 314 and balance of plant 316. The balance of plant 316 may comprise an oxidant supply subsystem 318 to supply an oxidant, for example air, to the fuel cell stack 314. The balance of plant 316 may also comprise a fuel supply subsystem 320 for providing fuel, for example, hydrogen, to the fuel cell stack 314. In particular, the oxidant supply subsystem 318 may, for example, include an air compressor, blower or fan 322 to provide a flow of air at an adjustable rate, and/or a humidifier module 324 operable to maintain a moisture level of the air at desirable levels, and appropriate conduit. The fuel supply subsystem 320 may include a fuel reservoir such as one or more high pressure tanks 326 for storing hydrogen, which may be supplied via an inlet 328, and/or and appropriate conduit. The fuel supply subsystem 320 may also include a pressure reducing valve 330 and/or a hydrogen pump 332 operable to provide a flow of hydrogen at a desired rate and/or pressure.

The balance of plant 316 may further comprise a temperature control subsystem 334 for maintaining a temperature of the fuel cell stack 314 within acceptable limits. The temperature control subsystem 334 may, for example, include a radiator 336, a cooling pump 338 and appropriate conduit to move a heat transport medium between the fuel cell stack 314 and the radiator 336. The temperature control subsystem 334 may also optionally include a fan 340 operable to provide a flow of air across the radiator 336.

The power system 310 of FIG. 31 also comprises an auxiliary or secondary battery 342 for storing excess electrical power, and releasing stored electrical power when required. The secondary battery 342 will typically take the form of an array of lead acid batteries.

The power system 310 also comprises and one or more power converters for providing power between the fuel cell stack 314, the secondary battery 342, and various motors and/or loads. For example, one or more power converters may provide power from the fuel cell stack 314 to a drive or traction motor 344 and/or to one or more accessory motors 346. Also for example, one or more power converters may also provide power from the secondary battery 342 the traction motor 344 and/or accessory motors 346, and may be able to provide power from the traction motor 344 to the secondary battery 342, for example when the traction motor 344 is operated in a regeneration mode.

In the illustrated embodiment, a bi-directional DC/DC power converter 348, that comprises a first and a second DC/DC converter electrically coupled in series, electrically couples the secondary battery 342 to the fuel cell stack 314 via a main power bus 350. A traction drive inverter 352 electrically couples the traction motor 344 to the main power bus 350 and is operable to invert DC power on the main power bus 350 to AC power to drive the traction motor 344. The traction drive inverter 352 may also be operable to rectify AC power produced by the traction motor 344 to DC power for storage by the secondary battery 342, for example when the traction motor 344 is operating in a regeneration mode. An accessories inverter 354 electrically couples the accessories motors 346 to the main power bus 350 and is operable to invert DC power on the main power bus 350 to AC power to drive the accessory motors 346.

The U.S. Department of Energy has identified certain technical targets for transportation related fuel cell stacks, which are identified in Table 1, below.

TABLE 3
Technical Targets: 80-kW (net) Transportation Fuel Cell Stacks
Operating on Direct Hydrogen.

| | | 2004 | | | |
|---|---|---|---|---|---|
| Characteristic | Units | Status | 2005 | 2010 | 2015 |
| Stack power density | W/L | 1330 | 1500 | 2000 | 2000 |
| Stack specific power | W/kg | 1260 | 1500 | 2000 | 2000 |
| Stack efficiency @ 25% of | % | 65 | 65 | 65 | 65 |
| rated power | | | | | |
| Stack efficiency @ rated | % | 55 | 55 | 55 | 55 |
| power | | | | | |
| Precious metal loading | g/kW | 1.3 | 2.7 | 0.3 | 0.2 |
| Cost | $/kW | 75 | 65 | 30 | 20 |
| Durability with cycling | hours | ˜1000 | 2000 | 5000 | 5000 |
| Transient response | Sec | 1 | 2 | 1 | 1 |
| (time for 10% to 90% of | | | | | |
| rated power) | | | | | |
| Cold startup time to 90% of | | | | | |
| rated power | | | | | |
| @ −20° C. ambient | sec | 120 | 60 | 30 | 30 |
| temperature | | | | | |
| @ +20° C. ambient | sec | <60 | 30 | 15 | 15 |
| temperature | | | | | |
| Survivability | ° C. | −40 | −30 | −40 | −40 |

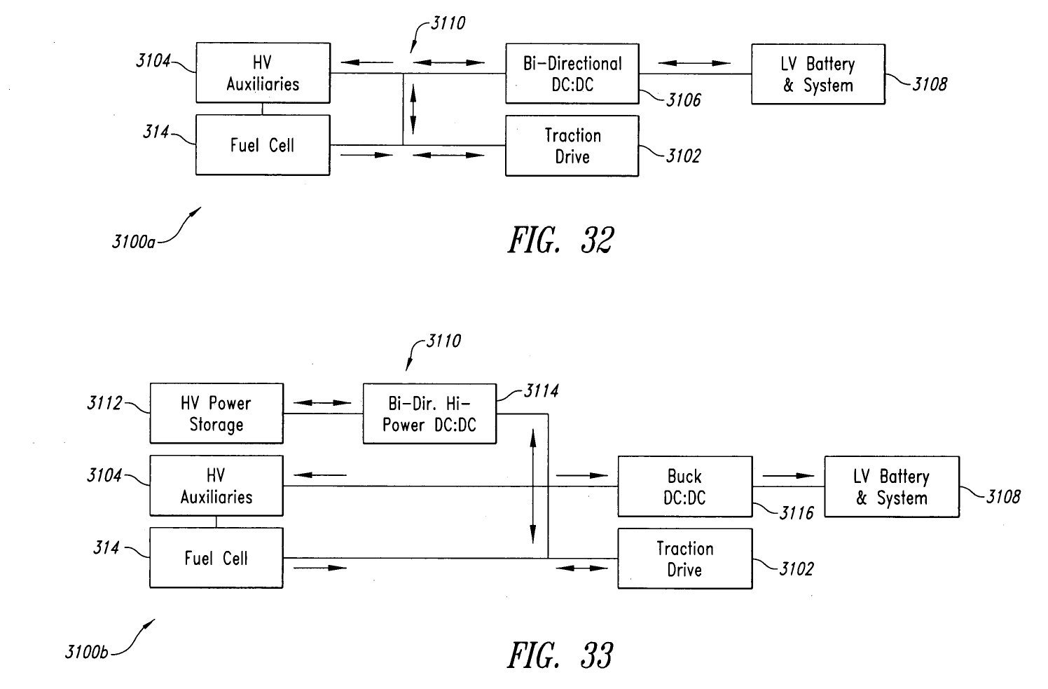

These technical targets address the equivalency, economics and environment of fuel cell stack operation. Achieving the targets is a desirable step toward the goal of commercially practical fuel cell powered vehicles. Several power system topologies which may be useful in achieving these targets are set out below in FIGS. 32-35.

FIG. 32 is a schematic diagram of a “lean” power system topology for a vehicle according to one illustrated embodiment.

The power system 3100a of FIG. 32 comprises a fuel cell system such as that illustrated in FIG. 31, where the fuel cell stack 314 is coupled to a traction drive 3102 and high voltage auxiliaries 3104 without an intervening power converter. The power system 3100a also comprises a bi-directional DC/DC power converter 3106, that comprises a first and a second DC/DC converter electrically coupled in series, coupling a low voltage side represented by low voltage battery and system 3108 to a high voltage side 3110 of the power system 3100a. In particular, the bi-directional DC/DC power converter 3106 may step down a voltage of power from the fuel cell stack 314 for supply to an voltage appropriate for the low voltage battery and system 3108.

The power system 3110a of FIG. 32 has the advantage of being a very simple system, which may be easy and inexpensive to manufacture. However, the power system 3100a may have limited ability to handle regeneration since the power system 3100a lacks any high voltage power storage devices. Also the fuel cell stack 314 needs to handle all transients (i.e., upward or downward changes in power draws). Further, the voltage across the high voltage auxiliaries 3104 is the same as the voltage across the fuel cell stack 314.

FIG. 33 is a schematic diagram of a “fuel cell following hybrid” power system topology for a vehicle according to another embodiment.

The power system 3100b of FIG. 33 comprises a fuel cell system such as that illustrated in FIG. 31, where the fuel cell stack 314 is coupled to a traction drive 3102 and high voltage auxiliaries 3104 without an intervening power converter. The power system 3100b also comprises a high voltage power storage device 3112 and a bi-directional high power DC/DC power converter 3114, which may comprise a first and a second DC/DC converter electrically coupled in series, and that electrically couples the high voltage power storage device 3112 to the fuel cell stack 314 and the traction drive 3102. The bi-directional high power DC/DC power converter 3114 is operable to step-up or step-down a voltage when transferring high power between the high voltage power storage device 3112 and the fuel cell stack 314 or traction drive 3102.

The power system of FIG. 33 further comprises a buck DC/DC power converter 3116, which may comprise a first and a second DC/DC converter electrically coupled in series, and that electrically couples a low side represented as a low voltage battery and system 3108 to a high voltage side 3110 of the power system 3100b. The buck DC/DC power converter 3116 is operable to step-down a voltage of power supplied to the low voltage battery and system 3108 from the high voltage side 3110 of the power system 3100b.

The power system 3100b of FIG. 33 has a relatively large ability to handle regeneration (i.e., traction drive producing power while operating in regeneration mode). The high voltage power storage device 3112 can handle some of the transients, which may be particularly advantageous since such a power storage device 3112 is typically faster to respond to changes in demand than a fuel cell system. The power system 3100b may employ a relatively small high voltage power storage device 3112, for example an array of batteries or super- or ultracapacitors. The fuel cell stack 314 is advantageously both the energy and the power source. The voltage across the high voltage power storage device 3112 is advantageously decoupled from the voltage across the traction drive 3102.

FIG. 34 is a schematic diagram of a “battery following hybrid” power system topology for a vehicle according to another embodiment.

The power system 3100c of FIG. 34 comprises a fuel cell system such as that illustrated in FIG. 31, where the fuel cell stack 314 is electrically coupled to the high voltage auxiliaries 3104 without an intervening power converter. The power system 3100c also comprises a high power DC/DC power converter 3120, which may comprise a first and a second DC/DC converter electrically coupled in series, and that electrically couples the fuel cell stack 314 to the traction drive 3102 and to a high voltage power storage device 3112. The high power DC/DC power converter 3120 is operable to step-up or step-down a voltage when transferring power between the fuel cell stack 314 and either the high voltage power storage device 3112 or the traction drive 3102.

The power system 3100c further comprises a buck DC/DC power converter 3116, which may comprise a first and a second DC/DC converter electrically coupled in series, and that electrically couples a low voltage battery and system 3108 to a high voltage side 3110 of the power system 3100c. The buck DC/DC power converter 3116 is operable to step-down a voltage of power supplied to a low side represented by the low voltage battery and system 3108 from the high voltage side 3110 of the power system 3100c.

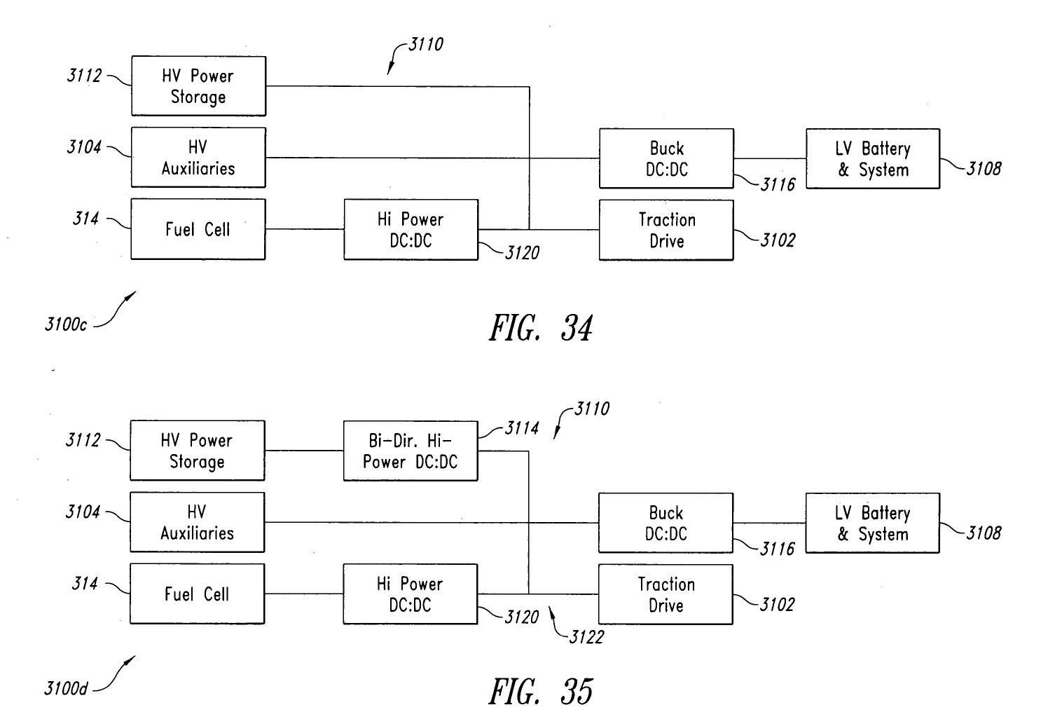

FIG. 35 is a schematic diagram of a “regulated inverter bus hybrid” power system topology for a vehicle according to one illustrated embodiment.

The power system 3100d of FIG. 35 comprises a fuel cell system such as that illustrated in FIG. 31, where the fuel cell stack 314 is electrically coupled to the high voltage auxiliaries 3104 without an intervening power converter. The power system 3100d also comprises a high power DC/DC power converter 3120, which may comprise a first and a second DC/DC converter electrically coupled in series, and electrically coupling the fuel cell stack 314 to a traction drive 3102. The high power DC/DC power converter 3120 is operable to step-up or step-down a voltage when transferring power.

The power system 3100d additionally comprises a bi-directional high power DC/DC power converter 3114, which may comprise a first and a second DC/DC converter electrically coupled in series, and electrically coupling a high voltage power storage device 3112 to the high power DC/DC power converter 3120, traction drive 3102 and high voltage auxiliaries 3104 via a main power bus 3122. The bi-directional high power DC/DC power converter 3114 is operable to step-up or step-down a voltage across in transferring power the high voltage power storage device 3112 and the main power bus 3122.

The power system 3100d further comprises a buck DC/DC power converter 3116, which may comprise a first and a second DC/DC converter electrically coupled in series, and that electrically couples a low side represented as low voltage battery and system 3108 to a high voltage side 3110 of the power system 3100d. The buck DC/DC power converter 3116 is operable to step-down a voltage of power supplied to the low voltage battery and system 3108 from the high voltage side 3110 of the power system 3100d.

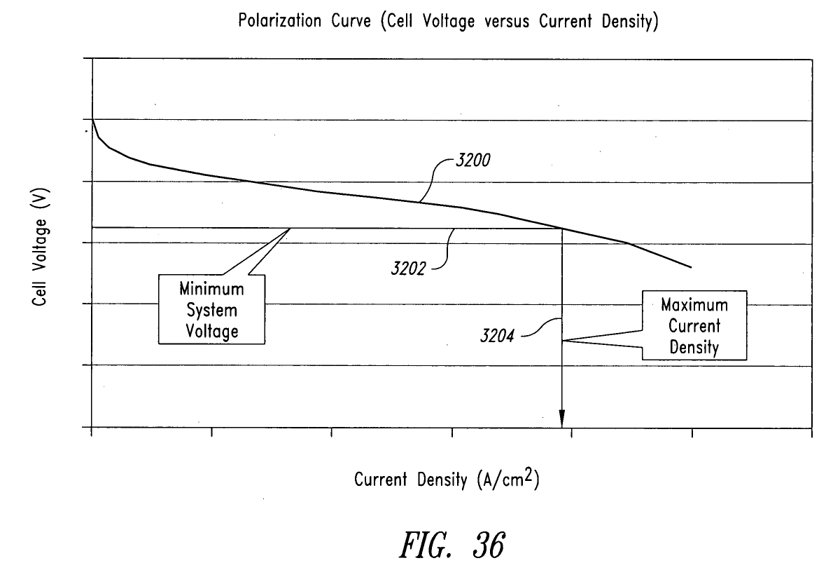

FIG. 36 is a graph showing an exemplary polarization curve 3200 illustrating a relationship between cell voltage and current density for an exemplary PEM fuel cell structure, according to one illustrated embodiment. Also illustrated are the minimum system voltage 3202 and maximum current density 3204 for the PEM fuel cell structure.

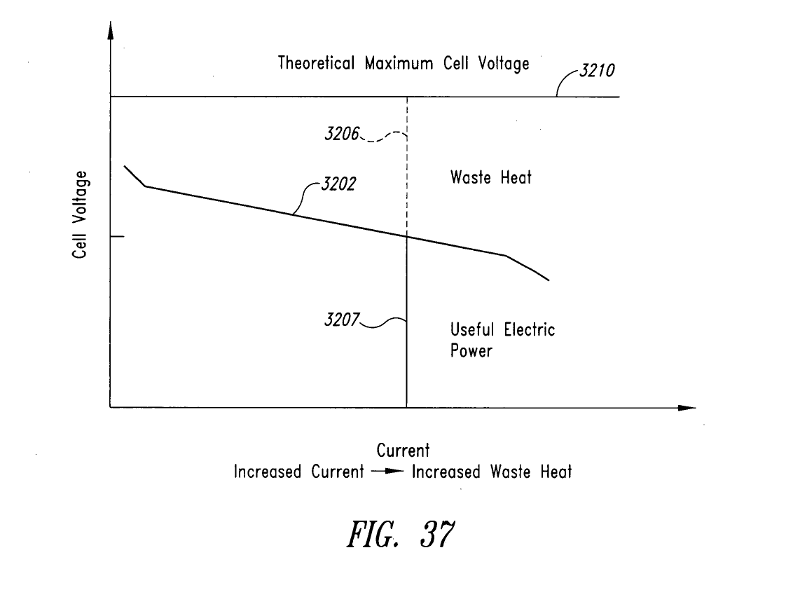

FIG. 37 is a graph showing the exemplary polarization curve 3202 of FIG. 36, illustrating a relationship between power wasted as heat (area 3206 above the curve 3202 at any given point on the curve 3202) and useful power provided (area 3208 below the curve 3202 at any given point on the curve 3202), as well as the theoretical maximum cell voltage 3210, according to one illustrated embodiment. As this Figure illustrates, an increase in current results in an increase in waste heat.

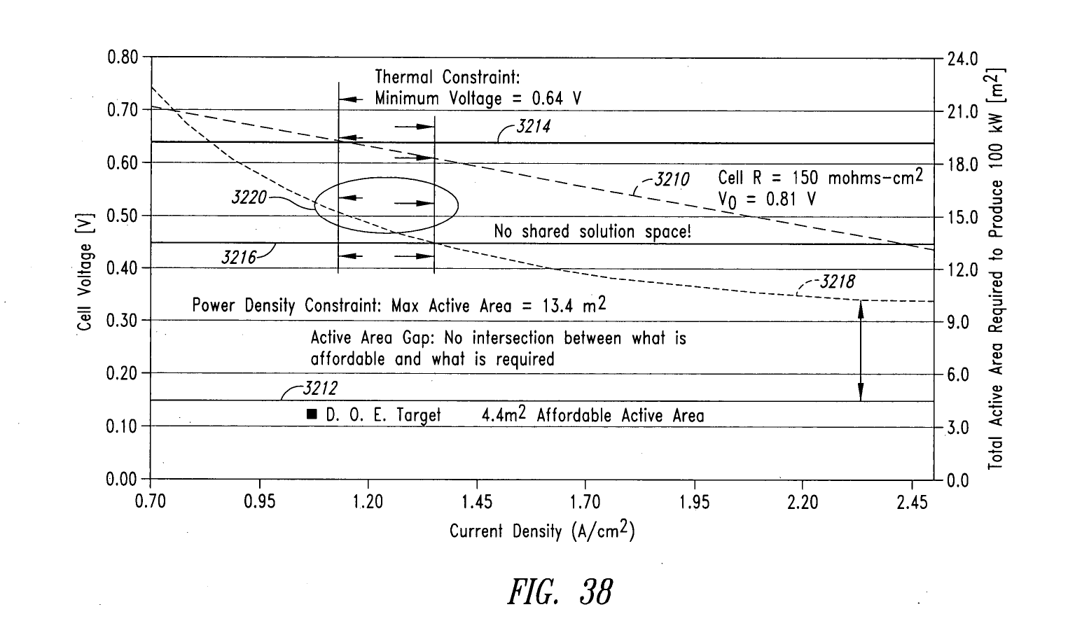

FIG. 38 is a graph showing the various theoretical constraints set out in Table 1 to reducing costs associated with a conventional power system such as that illustrated in FIG. 1. In particular, FIG. 38 shows the cell voltage constraint 3210 (in Volts), cost constraint 3212 ($45/kW for fuel cell system), thermal constraint 3214 (V_{c} min), power density constraint 3216 (meters squared), and total stack active area required constraint 3218 (meters squared). As is illustrated by the ellipse 3220, no shared solution space exists.

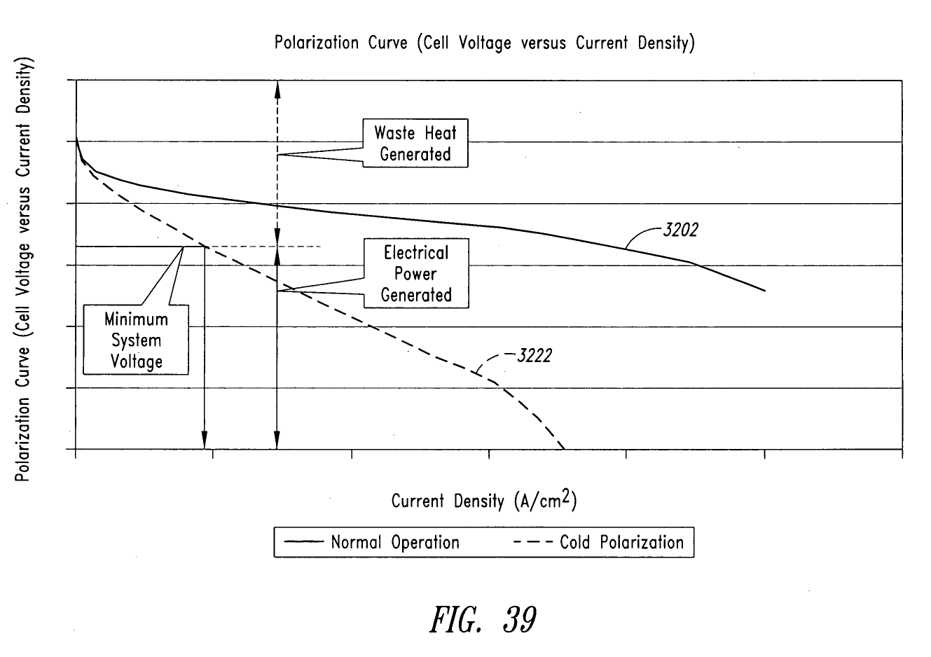

FIG. 39 is a graph showing a polarization curve 3222 for cold or freeze startups along with the polarization curve 3202 for normal operation. As is illustrated by FIG. 39, the lower the acceptable cell voltage during cold or freeze startups, the more waste heat is produced per water molecule, which may be advantageously employed in addressing the design goals. For example as illustrated in FIG. 40, adding functionality in the power electronics allows for a decreased minimum system voltage requirement during cold startup. This allows for fast, reliable cold or freeze startups, for example in freezing temperatures. Low voltage operation on cold or freeze startup is one of many possible methods to achieve effective cold or freeze startup.

In common usage, the term “converter” applies generically to all power conversion components whether operated as inverters, rectifiers and/or DC/DC converters, and is used herein and in the claims in that generic sense. More particularly, DC/DC converters that comprise at least a first and a second DC/DC converter electrically coupled in series are described herein and in the claims in that generic sense. One or more power conversion subsystem components may be provided as a self-contained unit, commonly referred to as a power module, which comprises an electrically insulative housing that houses at least a portion of the power conversion system component, and appropriate connectors such as terminals or bus bars. The power module may, or may not, form a portion of an integrated drive train or traction drive.

As used herein and in the claims, the terms high voltage and low voltage are used in their relative sense and not in any absolute terms. While not necessarily limiting, in a vehicle application the term high voltage will typically encompass the range of voltages suitable for driving a traction motor (e.g., approximately 200V-500V), while the term low voltage will typically encompass the range of voltages suitable for power control systems and/or accessories (e.g., 12V or 42 V, or both).

While the embodiments of FIGS. 33-35 may employ an array of lead acid batteries as the high voltage power storage device 3112, other types of power storage devices may be employed. For example, the embodiments of FIGS. 33-35 may employ batteries of other chemistry types as the high voltage power storage device 3112. Alternatively, the embodiments of FIGS. 32-35 may employ arrays of super- or ultra-capacitors, and/or flywheels as the high voltage power storage device 3112.

While not illustrated in detail in FIGS. 32-35, the traction drive 3102 will typically include one or more converters operable as an inverter to transform a direct current to an alternating current (e.g., single phase AC, three phase AC) for driving an AC electric motor of the traction drive. Such converters may also be operable as a rectifier to transform an alternating current to a direct current. Alternatively, the traction drive 3102 may optionally employ discreet rectifiers to transform the AC to DC. In addition to the converters and AC electric motor, the traction drive 3102 also typically includes transmission and gearing mechanisms for transferring power for the AC electric motor to traction or drive wheels, as well as a control system which may include one or more sensors, actuators and processors or drive circuits.

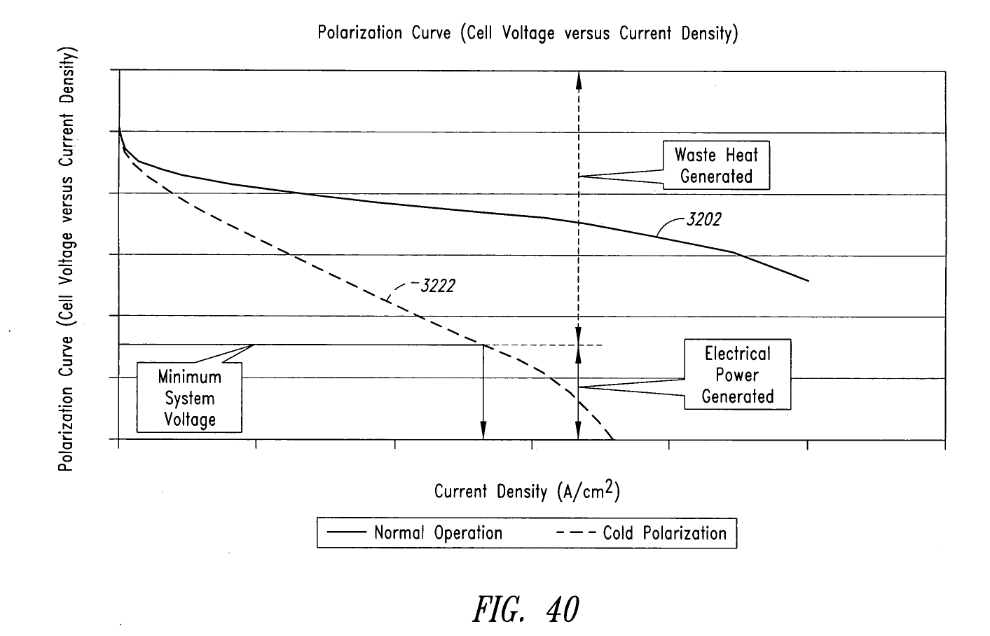

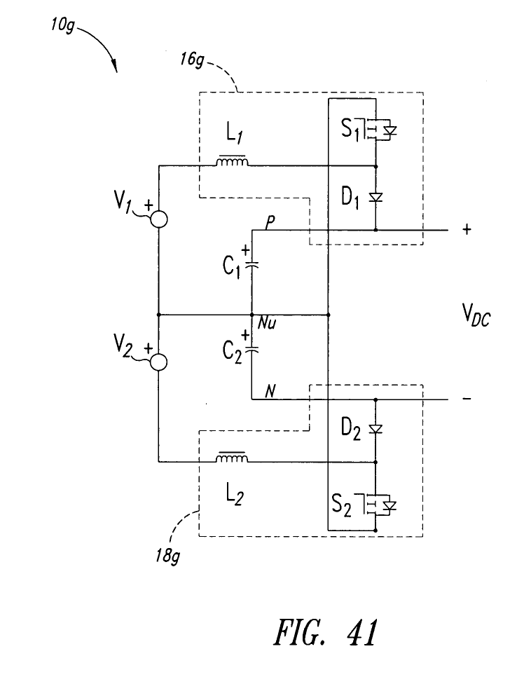

FIG. 41 is a schematic diagram of a system 10g, with a first primary DC/DC power converter 16g and a second primary DC/DC power converter 18g electrically coupled in series, wherein the first and second DC/DC converters 16g, 18g each comprise a single inductor (L₁ and L₂, respectively), a switch (Si and S₂, respectively) and a diode (D₁ and D₂, respectively). A group of the above-described elements which comprises an inductor, a switch and a diode (for example: L₁, S₁ and D₁) may be referred to herein as a “leg” or as a “circuit leg” for convenience. The first and second primary DC/DC powers 16g, 18g may take the form of single phase switch mode converters. Other components of the system 10g (not shown) may be similar to the components illustrated in FIG. 2.

The first primary DC/DC power converter 16g takes the form of a single inductor L₁, diode D₁, and power semiconductor switches and associated anti-parallel diodes, collectively referenced as S₁. The power semiconductor switch S₁ may be controlled via control signals 28a provided by the controller 28 (FIG. 1). Likewise the second primary DC/DC power converter 18g may take the form of a single inductor L₂, diode D₂, and power semiconductor switches and associated anti-parallel diodes, collectively referenced as S₂. The first primary DC/DC power converter 16g is operable to step-up a voltage from the first primary power source V₁, while the second primary DC/DC power converter 18g is operable to step-up a voltage supplied by the second primary power source V₂.

FIG. 42 is a schematic diagram of a system 10h, with a first primary DC/DC power converter 16h and a second primary DC/DC power converter 18h electrically coupled in series, wherein the first and second primary DC/DC power converters 16h, 18h each comprise a plurality of single inductor, switch and diode legs. The first and second primary DC/DC power converter, 16h, 18h may be referred to as a multi-phase interleaved switch mode converters. Other components of the system 10h (not shown) may be similar to the components illustrated in FIG. 2.

The first primary DC/DC power converter 16h takes the form of a plurality of legs, each leg having a single inductor L₁through Lₙ, a single diode D₁ through Dₙ, and power semiconductor switches and associated anti-parallel diodes, collectively referenced as S₁ through Sₙ, respectively. The power semiconductor switches S₁ through Sₙ may be controlled via control signals 28a provided by the controller 28 (FIG. 1).

Similarly, the second primary DC/DC power converter 18h may take the form of a plurality of legs, each leg having a single inductor L₂ through Lₘ, a single diode D₂ through Dₘ, and power semiconductor switches and associated anti-parallel diodes, collectively referenced as S₂ through Sₘ, respectively.

The first primary DC/DC power converter 16h is operable to step-up a voltage from the first primary power source V₁. Similarly, the second primary DC/DC power converter 18h is operable to step-up a voltage supplied by the second primary power source V₂.

It is appreciated that the embodiment system 10b illustrated in FIG. 2 and described hereinabove is the special case where there are three legs in the first and second primary DC/DC power converters 16h, 18h (i.e.: n=3 and m=3). Similarly, the embodiment system 10g illustrated in FIG. 41 and described hereinabove is the special case where there is one leg in the first and second primary DC/DC power converters 16h, 18h (i.e.: n=1 and m=1). The values of n and m above may be any value. Furthermore, the values of n and m need not be the same. Such embodiments may be desirable if the voltage and/or current of the first primary power source V₁ and the second primary power source V₂ are not the same.

The plurality of single switch and diode legs allows finer control of the switching of the above-described semiconductor switches. Also, the addition of legs in the primary and/or secondary primary DC/DC power converters 16h and 18h, respectively, further reduces the ripple current in the capacitors C₁, C₂. Furthermore, the more legs used in the primary and/or secondary primary DC/DC power converters 16h and 18h, respectively, results in lower RMS voltage and/or current ratings of the semiconductor devices, and alleviates attendant packing, thermal management and reliability problems. Additionally, total losses are reduced in the system 10g. And, greater flexibility in packaging design is also provided, as noted hereinabove.

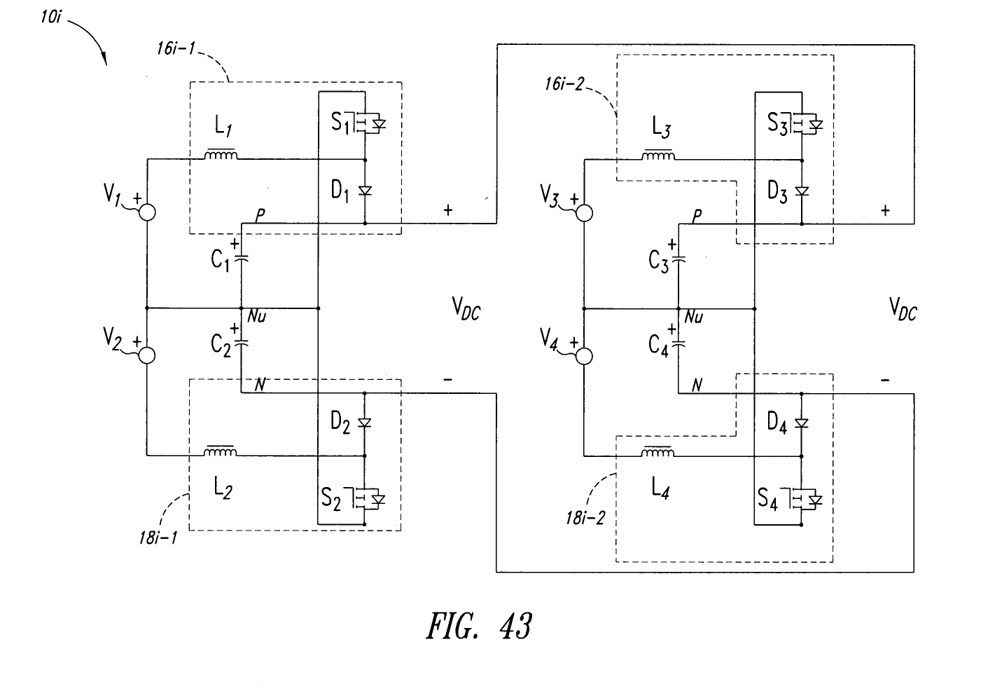

FIG. 43 is a schematic diagram of a system 10i, with a plurality of parallel sets of first primary DC/DC power converters 16i and second primary DC/DC power converters 18i. For convenience, the first and second primary DC/DC power converters 16i, 18i each comprise a single inductor, switch and diode leg. Other embodiments with parallel sets of the first and second primary DC/DC power converters may use any of the above-described multi-phase interleaved switch mode converters. Other components of the system 10i (not illustrated in FIG. 43) may be similar to the components illustrated in FIG. 2.

Each of the groups of first and second primary DC/DC power converters 16i, 18i is coupled to its own respective first primary power source and second primary power source. In the embodiment illustrated in FIG. 43, the first group of first and second primary DC/DC power converters 16i-1, 18i-1 are coupled to the first primary power source V₁ and second primary power source V₂, respectively. The second group of first and second primary DC/DC power converters 16i-2, 18i-2 are coupled to the first primary power source V₃ and second primary power source V₄, respectively.

Other embodiments may employ more than two groups of first and second primary DC/DC power converters 16i, 18i. For example, three groups of first and second primary DC/DC power converters could be used. In other embodiments, the number of first primary DC/DC power converters 16i may be different from the number of second primary DC/DC power converters 18i that are in parallel.

In some embodiments, the relative size of the capacitors, inductors, diodes and/or switches may be different from group to group. That is, individual components of a group may be selected based upon the unique characteristics of that group. For example, if a first group is coupled to first and second primary power sources that are relatively larger than the power sources of a second group, the capacitors, inductors, diodes and/or switches of the first group may have a greater capacity than those corresponding components of the second group.

Such embodiments may advantageously provide for the use of different types, numbers and capacities of primary power sources in a power system 10i. Further, such embodiments may advantageously provide for subsequent expansion of the power capacity of the power system 10i as additional groups of first and second primary DC/DC power converters 16i, 18i are added (along with their respective first and second primary power sources).

As noted above, various embodiments of the serially connected first and second primary DC/DC power converters provide for bi-directional current transfers. For example, in a primary power source is capable or receiving and storing energy, then the bi-directional capability allows the recharging of the primary power source. For example, if installed in a vehicle, excess power may be available when coasting or braking, or if a fuel cell system is employed, excess power may be available when fuel cell output exceeds the system load requirements.

In the various above-described embodiments, DC power is transferred form the primary voltage sources (V₁ and V₂) to the DC voltage rails (+V_{dc} and −V_{dc}). In some operating environments, it may be desirable to transfer DC power from the DC voltage rails (+V_{dc} and −V_{dc}) to the primary voltage sources (V₁ and V₂). Such alternative embodiments may be configured by simply swapping the positions of the primary voltage sources (V₁ and V₂) and the DC voltage rails (+V_{dc} and −V_{dc}) in the above FIGS. 1-43. For brevity, new figures corresponding to FIGS. 1-44, and associated descriptions, are not provided herein. One skilled in the art will readily appreciate the straightforward component alterations required to construct and operate such embodiments. All such alternative embodiments are intended to be included within the scope of this disclosure and be protected by the accompanying claims.

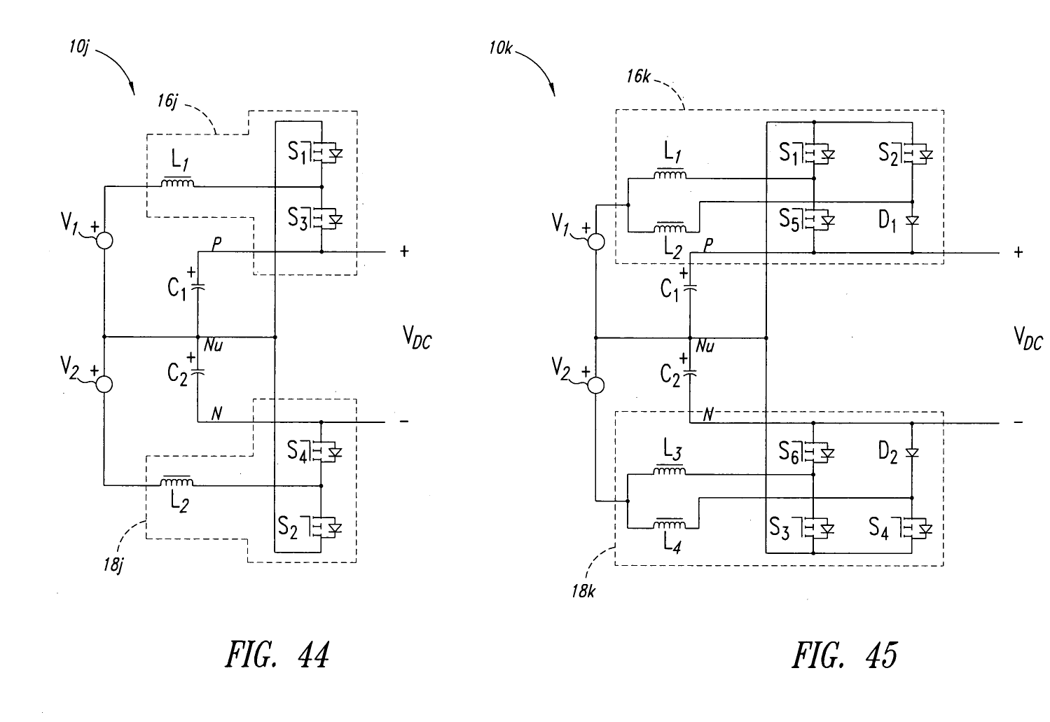

FIG. 44 is a schematic diagram of a bi-directional system 10j, with a first primary DC/DC power converter 16j and a second primary DC/DC power converter 18j. For convenience, the first and second primary DC/DC power converters 16j, 18j each comprise an inductor and two switches per leg. Other embodiments may use any of the above-described multi-phase interleaved switch mode converters. Other components of the system 10j (not shown) may be similar to the components illustrated in FIG. 2.

The first and second primary DC/DC power converters 16j, 18j are similar to the first and second primary DC/DC power converters 16g, 18g of FIG. 41 in that both embodiments include primary sources V₁ and V₂, capacitors C, and C₂, inductors L₁ and L₂, and switches S₁ and S₂. However, in the first primary DC/DC power converter 16j and the second primary DC/DC power converter 18j embodiments, the diodes D₁ and D₂ of the converters 16g, 18g of FIG. 41 are replace with switches S₃ and S₄. Accordingly, switches S₃ and S₄ are controllable via control signals 28a provided by the controller 28 (FIG. 1). Thus, current may be transferred from the high voltage and low voltage DC rails (+V_{dc} and −V_{dc}), through the first and second primary DC/DC power converters 16g, 18g, and provided to the primary sources V₁ and V₂. In other applications, power may be provided to other components, such as the exemplary embodiments illustrated in FIGS. 32-35. Such components may include, but are not limited to, rechargeable batteries, ultra-capacitors or auxiliary loads.

In other embodiments employing bi-directional configurations, the alternative embodiments replace the respective diodes with a suitable power semiconductor switch. For example, referring to FIG. 42, a multi-phase interleaved switch mode converter embodiment, the diodes D₁, D₂, Dₙ and Dₘ are replaced with suitable power semiconductor switches.

In some embodiments, selected ones of the diodes may be replaced with switches to provide a bi-directional capacity that is different in either direction. For example, FIG. 45 is a schematic diagram of a bi-directional system wherein the capacity in the direction from the primary energy source to the voltage rail is different from the capacity in the voltage rail to the primary energy source. In this exemplary embodiment, the first primary DC/DC power converter 16k and the second primary DC/DC power converter 18k are two-phase interleaved switch mode converters. The power semiconductor switches may be controlled via control signals 28a provided by the controller 28 (FIG. 1). Furthermore, switches S₅ and S₆ may provide protection from the loads.

The first primary DC/DC power converter 16k employs inductors L₁ and L₂, and power semiconductor switches S₁ and S₂, to facilitate current flow from the primary source V₁ to the DC voltage rails (+V_{dc} and −V_{dc}). The capacity of the first primary DC/DC power converter 16k in direction of the primary source V₁ to the DC voltage rails (+V_{dc} and −V_{dc}) is determined, in part, by the ratings of power semiconductor switches S₁ and S₂.

To support bi-directional current flows from the DC voltage rails to the primary source V₁, the first primary DC/DC power converter 16k employs the inductor L₁ and switch S₅. The capacity of the first primary DC/DC power converter 16k in direction of the DC voltage rails to the primary source V₁ is determined, in part, by the rating of power semiconductor switches S₅.

Likewise the second primary DC/DC power converter 18k employs inductors L₃ and L₄, and power semiconductor switches S₃ and S₄, to facilitate current flow from the primary source V₂ to the DC voltage rails (+V_{dc} and −V_{dc}). The capacity of the second primary DC/DC power converter 18k in direction of the primary source V₁ to the DC voltage rails is determined, in part, by the ratings of power semiconductor switches S₃ and S₄.

To support bi-directional current flows from the DC voltage rails (+V_{dc} and −V_{dc}) to the primary source V₂, the second primary DC/DC power converter 18k employs the inductor L₃ and switch S₆. The capacity of the second primary DC/DC power converter 18k in the direction of the DC voltage rails to the primary source V₂ is determined, in part, by the rating of power semiconductor switches S₆.

In embodiments which replace one of the above-described diodes with a second switch, the bi-directional capacity can be optimized in both directions. For instance, in the above-described exemplary embodiment, if the primary sources V₁ and V₂ are batteries capable of sinking fifty percent (50%) of their maximum discharge current (i.e., they can deliver twice as much instantaneous power as they can sink), the switches S₅ and S₆ may be sufficient (so that diodes D₁ and D₂ are employed). If the batteries were capable of sinking 100% of their discharge current, then diodes D₁ and D₂ could be replaced with suitable switches (similar to switches S₅ and S₆).

It is appreciated that the above-described embodiments providing bi-directional capacity may employ any suitable number of legs, wherein the bi-directional legs include an inductor and two switches. Further, any number of legs limited to transferring power from a primary source to the voltage rails may be used (wherein such legs include an inductor, a switch, and a diode) to provide different capacities in each direction. All such variations are intended to be included within the scope of this disclosure and to be protected by the accompanying claims.

In the various embodiments described above, the diodes (for example, D₁ through D₆ illustrated in FIG. 2) residing in the legs of the primary DC/DC power converters protect the primary power sources V₁ and/or V₂ from electrical problems occurring on the load side of the power system. The diodes may also protect the switches and/or inductors. For example, a variation in the load may cause an attendant change in the voltage and/or current drawn from the high and low voltage rails (+V_{dc} and −V_{dc}). Accordingly, a voltage fluctuation on the load side will not propagate back through the system and harm the components protected by the diodes.

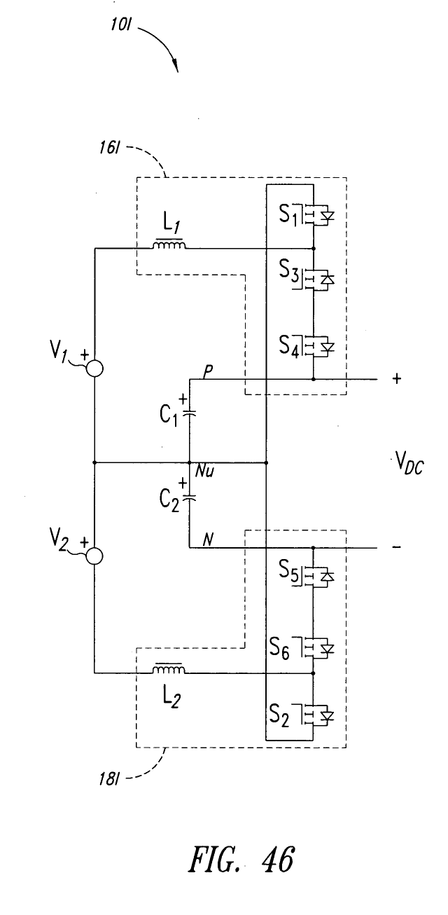

FIG. 46 is a schematic diagram of a bi-directional system 101 wherein an additional switch (S₃ and S₆) is employed in each leg to protect the load from the primary power sources V₁ and V₂. Opening switches S₃ and S₆ will protect the CD voltage rails (+V_{dc} and −V_{dc}), and loads or devices connected thereto, from electrical problems occurring on the primary sources V₁ and/or V₂. Protection may be provided to any of the above-described embodiments. The additional switches are required in all legs.

The switches and/or diodes of the various embodiments illustrated in FIGS. 41-46 may be housed in a common electrically insulated housing (not shown), similar to the insulated housing 32 of FIG. 2, to form a power module. Embodiments having a plurality of legs may be housed together in a single common electrically insulated housing, or may each be separately housed in a common electrically insulated housing . Such power modules may facilitate modular construction of systems 10 into an integrated DC power system of any desirable size and/or configuration

The above-described embodiments may be employed in a variety of power systems. For convenience, many of the exemplary applications of the above-described embodiments were described as being employed in vehicles powered by one or more fuel cells and/or battery systems. Any of the above-described embodiments may be employed in other types of vehicles, such as, but not limited to, hybrid fuel vehicles or electric vehicles such as automobiles, trains or aircraft.

Furthermore, above-described embodiments may be employed in other power systems, such as, but not limited to, bulk energy and/or high voltage electric power systems. Electric utilities provide electricity, usually alternating current (AC) power, to end use customers at a variety of end utilization voltages. For example, a residential customer in the United States typically receives electricity from the providing electric utility at 240 volts and 120 volts, and at a frequency of 60 hertz (Hz). In other countries, the voltage and/or the frequency may vary.

In some end-user applications, the customer may desire to have power provided at one or more specified DC voltages and currents. Embodiments of the serially connected primary DC/DC power converters may be configured to couple to an AC/DC conversion system having a particular DC voltage and current rating. Accordingly, the various embodiments could be coupled to the DC side of the AC/DC converter to provide different specified DC voltages and currents to the customer.

In power supply applications, an energy source may generate a DC voltage and current, which is converted into AC power by a DC/AC converter. Examples of DC power sources include, but are not limited to, solar cells, batteries, fuel cells and DC generators. DC generators may be powered by a variety of sources, such as wind, water, fuel combustion, garbage recycling, waste heat recovery, geothermal heated fluids, or other energy sources. The converted power is supplied to a bulk transmission system for delivery to end use customers. In situations wherein one or more of the DC energy sources operate at a voltage different than the DC voltage of the DC/AC converter, the various embodiments of a serially connected primary DC/DC power converter could be coupled to the DC side of the DC/AC converter.

In another exemplary power supply application, electric power may be converted from AC power to DC power with a first AC/DC converter, and then back to AC power using a second DC/AC converter. These devices are generally referred to in the industry as back-to-back DC converter stations. For example, AC power grids may be physically (and electrically) separated from each other. The AC power grids may operate at the same frequency. However, the frequency of the two power grids may not be in synchronism with each other. To maintain synchronism of the two AC power grids while power it being transported between them, the transferred electric power is converted from AC power (at the frequency of the transmitting system), to DC power, and then back to AC power (at the frequency of the transmitting system). Furthermore, the frequencies of the two AC systems need not be the same. The various embodiments of the serially connected primary DC/DC power converter could be coupled to the DC sides of the DC/AC converters to modulate DC voltages and/or currents, or to supply various auxiliary loads.

Auxiliary power systems may be used to provide DC power to an auxiliary load at a specified DC voltage and current rating. Such auxiliary power systems are typically supplied by either a DC power source or an AC power source. If supplied by an AC power source, a suitable AC/DC converter is employed to convert the AC power to DC power. In situations where one or more of the auxiliary loads operate at a voltage different than the DC voltage provided by the AC/DC converter, various embodiments of the serially connected primary DC/DC power converter could be coupled to the DC side of the AC/DC converter to supply the auxiliary loads.

Various embodiments may be described as a direct current to direct current (DC/DC) power converter electrically coupling a low voltage side of a direct current (DC) power system to a high voltage side of the DC power system. The embodiment comprises a first primary DC/DC power converter 16a-i (FIGS. 1-6 and 41-46) coupled between a first voltage bus P of the high voltage side and a positive voltage bus (+V₁) of the low voltage side, such that the first primary DC/DC power converter 16a-i controls a voltage difference between the first voltage bus P and the positive voltage bus (+V₁). The embodiment also comprises a second primary DC/DC power converter 18a-i serially connected to the first primary DC/DC power converter 16a-i, and coupled between a second voltage bus of the high voltage side N and a negative voltage bus (−V₂) of the low voltage side such that the second primary DC/DC power converter 18a-i controls a voltage difference between the second voltage bus D and the negative voltage bus (−V₂).

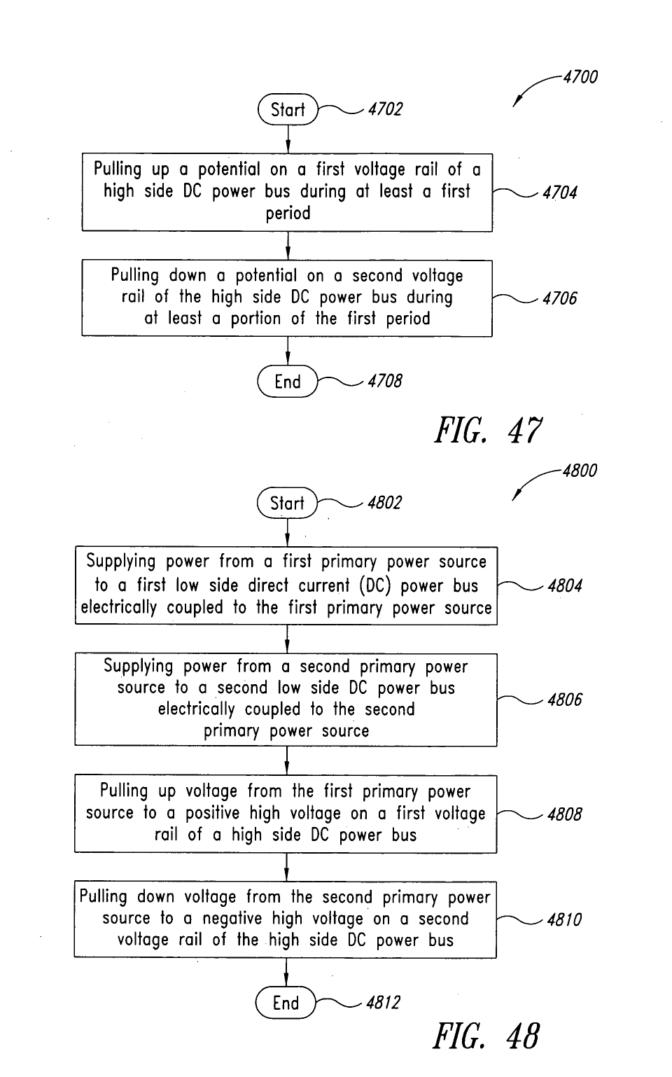

FIGS. 47-51 are flow charts 4700, 4800, 4900, 5000 and 5100, respectively, illustrating various processes of operating power systems using the various embodiments described herein. It should be noted that in some alternative implementations, the functions noted in the blocks may occur out of the order noted in FIGS. 47-51, or may include additional functions. For example, two blocks shown in succession in FIGS. 47-51 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

FIG. 47 is a flow chart 4700 illustrating a process of operating a power system. The process starts at block 4702. At block 4704, a potential on a first voltage rail of a high side DC power bus is pulled up during at least a first period. At block 4706, a potential on a second voltage rail of the high side DC power bus is pulled down during at least a portion of the first period. The process ends at block 4708.

FIG. 48 is a flow chart 4800 illustrating another process of operating a power system. The process starts at block 4802. At block 4804, power is supplied from a first primary power source to a first low side DC power bus electrically coupled to the first primary power source. At block 4806, power is supplied from a second primary power source to a second low side DC power bus electrically coupled to the second primary power source. At block 4808, voltage from the first primary power source is pulled up to a positive high voltage on a first voltage rail of a high side DC power bus. At block 4810, voltage from the second primary power source is pulled down to a negative high voltage on a second voltage rail of the high side DC power bus. The process ends at block 4812.

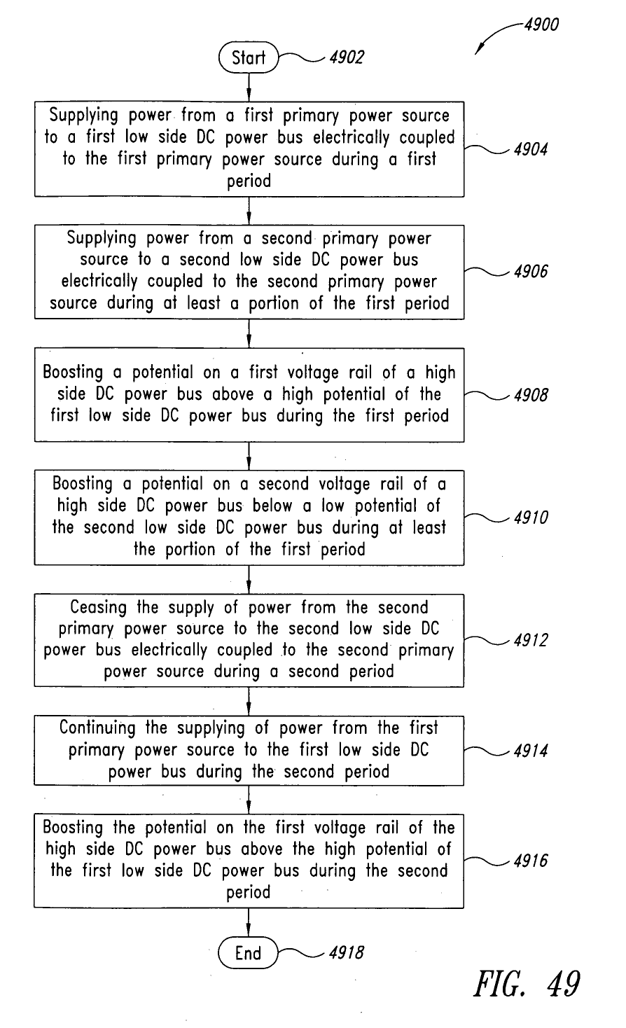

FIG. 49 is a flow chart 4900 illustrating another process of operating a power system. The process starts at block 4902. At block 4904, power is supplied from a first primary power source to a first low side DC power bus electrically coupled to the first primary power source during a first period. At block 4906, power is supplied from a second primary power source to a second low side DC power bus electrically coupled to the second primary power source during at least a portion of the first period. At block 4908, a potential on a first voltage rail of a high side DC power bus is boosted above a high potential of the first low side DC power bus during the first period. At block 4910, a potential on a second voltage rail of the high side DC power bus is boosted below a low potential of the second low side DC power bus during at least the portion of the first period. At block 4912, the supplying of power from the second primary power source to the second low side DC power bus electrically coupled to the second primary power source is ceased during a second period. At block 4914, the supplying of power from the first primary power source to the first low side DC power bus during the second period is continued. At block 4916, the potential on the first voltage rail of the high side DC power bus is boosted above the high potential of the first low side DC power bus during the second period. The process stops at block 4918.

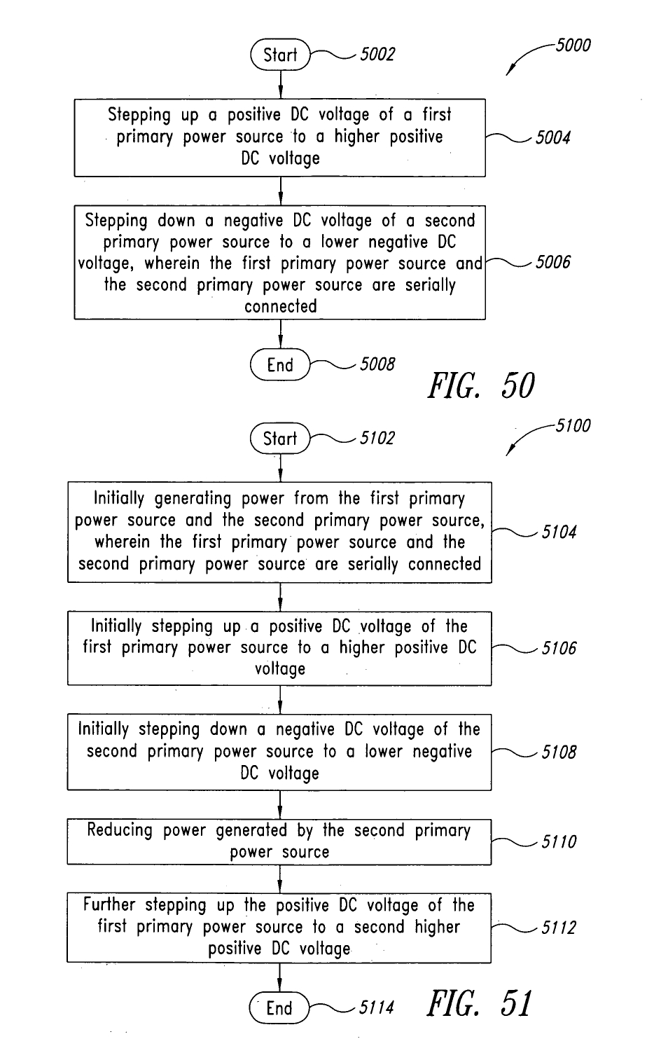

FIG. 50 is a flow chart 5000 illustrating another process of operating a power system. The process starts at block 5002. At block 5004, a positive DC voltage of a first primary power source is stepped up to a higher positive DC voltage. At block 5006, a negative DC voltage of a second primary power source is stepped down to a lower negative DC voltage, wherein the first primary power source and the second primary power source are serially connected. The process ends at block 5008.

FIG. 51 is a flow chart 5100 illustrating yet another process of operating a power system. The process starts at block 5102. At block 5104, power is initially generated from the first primary power source and the second primary power source, wherein the first primary power source and the second primary power source are serially connected. At block 5106, a positive DC voltage of the first primary power source is initially stepped up to a higher positive DC voltage. At block 5108, a negative DC voltage of the second primary power source is initially stepped down to a lower negative DC voltage. At block 5110, power generated by the second primary power source is reduced. At block 5112, the positive DC voltage of the first primary power source is further stepped up to a second higher positive DC voltage. The process ends at block 5114.

As used herein and in the claims the term “primary power source” means the primary power source for the high voltage bus 26. In some embodiments, this “primary power source” may also serve as the primary power source for the electric machiner 14. In other embodiments, the “primary power source” may serve as a secondary or auxiliary power source for the electric machine 14, for example where the power conversion system 12 takes the form of an uninterruptible power supply (UPS) or other backup power supply.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure. In at least one embodiment, the controller 28 maintains a commanded output voltage on the capacitors C₁, C₂, or C₁ by varying the duty cycles of the power semiconductor switches S₇-S₁₂ of the DC/DC converters 16, 18. In some embodiments, control may be coordinated among the power conversion system controller 28, the fuel cell system controller 106, and an integrated power train controller (not shown).

In addition, those skilled in the art will appreciate that the control mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to:

U.S. patent application Ser. No.10/360,832, filed Feb. 7, 2003 and entitled INTEGRATED TRACTION INVERTER MODULE AND DC/DC CONVERTER;

U.S. Pat. No. 6,573,682, issued Jun. 3, 2003;

U.S. patent publication Nos. 2003/0022038, 2003/0022036, 2003/0022040, 2003/0022041, 2003/0022042, 2003/0022037, 2003/0022031, 2003/0022050, and 2003/0022045, all published Jan. 30, 2003; 2003/0113594 and 2003/0113599, both published Jun. 19, 2003; 2004/0009380, published Jan. 15, 2004; and 2004/0126635, published Jul. 1, 2004;

U.S. patent application Ser. No. 10/817,052, filed Apr. 2, 2004; Ser. No. 10/430,903, filed May 6, 2003; Ser. No. 10/440,512, filed May 16, 2003; Ser. No. 10/875,797 and Ser. No. 10/875,622, both filed Jun. 23, 2004; 10/738,926, filed Dec. 16, 2003; Ser. No. 10/664,808, filed Sep. 17, 2003; Ser. No. 10/964,000, filed Oct. 12, 2004, using Express Mail No. EV529821584US, and entitled “INTEGRATION OF PLANAR TRANSFORMER AND/OR PLANAR INDUCTOR WITH POWER SWITCHES IN POWER CONVERTER”; and Ser. No. 10/861,319, filed Jun. 4, 2004; and

U.S. provisional patent application Ser. No. 60/569,218, filed May 7, 2004; Ser. No. 60/560,755, filed Jun. 4, 2004; and Ser. No. 60/621,012 filed Oct. 20, 2004, using Express Mail No. EV529821350US, and entitled “POWER SYSTEM METHOD AND APPARATUS”; are incorporated herein by reference, in their entirety. Aspects of the present systems and methods can be modified, if necessary, to employ systems, circuits and concepts of the various patents, applications and publications to provide yet further embodiments of the invention.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

We/I claim:

1. A power system comprising:
a high side DC power bus comprising a first voltage rail and a second voltage rail;
a first low side DC power bus;
a second low side DC power bus;
first means for boosting a potential on the first voltage rail of the high side DC power bus above a high potential of the first low side DC power bus; and
second means for boosting a potential on the second voltage rail of the high side DC power bus below a low potential of the second low side DC power bus.

2. The power system of claim 1 wherein the first means for boosting a potential on the first voltage rail of the high side DC power bus above a high potential of the first low side DC power bus comprises a first DC/DC power converter circuit, and wherein the second means for boosting a potential on the second voltage rail of the high side DC power bus below a low potential of the second low side DC power bus comprises a second DC/DC power converter circuit, an output of each of the first and the second DC/DC power converter circuits electrically coupled in series with one another across the high side DC power bus during at least one time.

3. The power system of claim 2 wherein the first DC/DC power converter circuit is a DC/DC boost power converter circuit.

4. The power system of claim 2 wherein the first DC/DC power converter circuit is a DC/DC buck-boost power converter circuit.

5. The power system of claim 2 wherein the first DC/DC power converter circuit is electrically coupled between an upper voltage rail of the first low side DC power bus and an intermediate node, and wherein the second DC/DC power converter circuit is electrically coupled between a lower voltage rail of the second low side DC power bus and the intermediate node, wherein the intermediate node electrically couples a lower voltage rail of the first low side DC power bus and an upper voltage rail of the second low side DC power bus.

6. The power system of claim 2 wherein the first DC/DC power converter circuit comprises at least a first inductor electrically coupled in series to an upper voltage rail of the first low side DC power bus, and wherein the second DC/DC power converter circuit comprises at least a second inductor electrically coupled in series to a lower voltage rail of the second low side DC power bus, and further comprising:
at least a first capacitor electrically coupled across an output of the first DC/DC power converter circuit; and
at least a second capacitor electrically coupled across an output of the second DC/DC power converter circuit.

7. The power system of claim 6, wherein the first DC/DC power converter circuit comprises at least a first diode electrically coupled in series to an output of the first DC/DC power converter circuit; and wherein the second DC/DC power converter circuit comprises at least a second diode electrically coupled in series to an output of the second DC/DC power converter circuit.

8. The power system of claim 7 wherein the first and the second diodes are each silicon carbide diodes.

9. The power system of claim 2, further comprising:
an auxiliary energy storage device; and
an auxiliary buck-boost power converter electrically coupling the auxiliary energy storage device to the high side DC power bus.

10. The power system of claim 9, further comprising:
a DC/AC power converter electrically coupled in series between the output of the first DC/DC power converter circuit and the output of the second DC/DC power converter circuit, wherein at least one pair of switches of the auxiliary buck-boost power converter are electrically coupled in parallel with at least one pair of switches of the DC/AC power converter.

11. The power system of claim 9, further comprising:
a DC/AC power converter electrically coupled in series between the output of the first DC/DC power converter circuit and the output of the second DC/DC power converter circuit, wherein at least one pair of switches of the auxiliary buck-boost power converter are electrically coupled in series with at least one pair of switches of the DC/AC power converter.

12. The power system of claim 2 wherein the first DC/DC power converter circuit is electrically coupled across an upper and a lower voltage rail of the first low side DC power bus and the second DC/DC power converter circuit is electrically coupled across an upper and a lower voltage rail of the second low side DC power bus, wherein the upper voltage rails of the first and the second low side DC power buses are electrically commonly coupled, and wherein the lower voltage rails of the first and the second low side DC power buses are electrically commonly coupled.

13. The power system of claim 12 wherein the first DC/DC power converter circuit comprises at least a first inductor electrically coupled in series to the upper voltage rail of the first low side DC power bus, and wherein the second DC/DC power converter circuit comprises at least a second inductor electrically coupled in series to the upper voltage rail of the second low side DC power bus, and further comprising:
at least a first capacitor electrically coupled in parallel across the first and the second DC/DC power converter circuits.

14. The power system of claim 13, wherein the first DC/DC power converter circuit comprises at least a first diode electrically coupled in series to an output of the first DC/DC power converter circuit; and wherein the second DC/DC power converter circuit comprises at least a second diode electrically coupled in series to an output of the second DC/DC power converter circuit.

15. The power system of claim 14 wherein the first and the second diodes are each silicon carbide diodes.

16. The power system of claim 12, further comprising:
an auxiliary power source; and
an auxiliary power converter electrically coupling the auxiliary power source to the high side DC power bus.

17. The power system of claim 16 wherein the auxiliary power source is an auxiliary power storage device and wherein the auxiliary power converter is an auxiliary buck-boost power converter.

18. The power system of claim 17 wherein the auxiliary buck-boost power converter comprises an inductor and at least one switch, the at least one switch electrically coupled in series with a switch of the second DC/DC power converter circuit.

19. The power system of claim 17 wherein the auxiliary buck-boost power converter comprises an inductor electrically coupled in parallel with a number of inductors of the second DC/DC power converter circuit.

20. The power system of claim 2 wherein at least one of the first and the second DC/DC power converter circuits is an interleaved power converter circuit.

21. The power system of claim 1, further comprising:
a first fuel cell system comprising a first fuel cell stack electrically coupled to supply a voltage across the first low side DC power bus; and
a second fuel cell system comprising a second fuel cell stack electrically coupled to supply a voltage across the second low side DC power bus.

22. The power system of claim 1, further comprising:
a first fuel cell system comprising a first fuel cell stack electrically coupled to supply a voltage across the first low side DC power bus and a second fuel cell stack electrically coupled to supply a voltage across the second low side DC power bus.

23. The power system of claim 1, further comprising:
a first fuel cell system comprising a fuel cell stack having a first portion and a second portion, the first portion of the fuel cell stack electrically coupled to supply a voltage across the first low side DC power bus and the second portion of the fuel cell stack electrically coupled to supply a voltage across the second low side DC power bus.

24. The power system of claim 23, wherein the fuel cell system comprises:
at least one center-tapped fuel cell stack divided into the first portion and the second portion by a center tap.

25. A power system, comprising:
a high side DC power bus;
a first low side DC power bus;
a second low side DC power bus;
a first DC/DC power converter electrically coupled to the first low side DC power bus and operable to transform power between the first low side DC power bus and the high side DC power bus; and
a second DC/DC power converter electrically coupled to the second low side DC power bus and operable to transform power between the first low side DC power bus and the high side DC power bus, wherein the first and the second DC/DC power converters are electrically coupled in series with one another across the high side DC power bus during at least one time.

26. The power system of claim 25 wherein one of the first or the second DC/DC power converters is a boost DC/DC power converter circuit, and the other one of the first or the second DC/DC power converters is a buck-boost DC/DC power converter circuit.

27. The power system of claim 25 wherein the first and the second DC/DC power converters are respective boost DC/DC power converter circuits operable to boost respective voltages across the first and the second low side DC power buses to supply portions of a voltage across the high side DC power bus.

28. The power system of claim 25 wherein the first and the second DC/DC power converters are respective interleaved high power DC/DC boost power converter circuits.

29. The power system of claim 25 wherein the first DC/DC power converter comprises a number of power semiconductor switches, a number of anti-parallel diodes, each of the anti-parallel diodes electrically coupled in anti-parallel across a respective one of the power semiconductor switches, and a number of inductors, each of the inductors electrically coupled between the first lower side DC power bus and a terminal of a respective one of the power semiconductor switches.

30. The power system of claim 29, further comprising:
a controller coupled to control at least some of the power semiconductor switches.

31. The power system of claim 25, further comprising:
a DC/AC power converter electrically coupled to the high side DC power bus and operable to invert a current carried by the high side DC power bus.

32. The power system of claim 31 wherein the DC/AC power converter is bi-directionally operable to provide a rectified current to the high side DC power bus.

33. The power system of claim 31 wherein the DC/AC power converter is a three-phase power converter circuit comprising a first leg comprising a first pair of upper and lower power semiconductor switches, a second leg comprising a second pair of upper and lower power semiconductor switches and a third leg comprising a third pair of upper and a lower power semiconductor switches, and a number of anti-parallel diodes, each of the anti-parallel diodes electrically coupled in anti-parallel across a respective one of the upper and lower power semiconductor switches.

34. The power system of claim 25, further comprising:
a third low side DC/DC converter circuit operable to bi-directionally transform power between the high side DC power bus and an auxiliary power storage device.

35. A method of operating a power system, comprising:
pulling up a potential on a first voltage rail of a high side DC power bus during at least a first period; and
pulling down a potential on a second voltage rail of the high side DC power bus during at least a portion of the first period.

36. The method of claim 35 wherein pulling up a potential on a first voltage rail of a high side DC power bus comprises boost converting a voltage across a first low side DC power bus and wherein pulling down a potential on a second voltage rail of the high side DC power bus comprises boost converting a voltage across a second low side DC power bus, wherein a lower voltage rail of the first low side DC power bus is commonly connected with a higher voltage rail of the second low side DC power bus.

37. The method of claim 35 wherein pulling up a potential on a first voltage rail of a high side DC power bus comprises boost converting a voltage across a first low side DC power bus and wherein pulling down a potential on a second voltage rail of the high side DC power bus comprises boost converting a voltage across a second low side DC power bus, wherein an upper voltage rail of each of the first and the second low side DC power buses are electrically commonly coupled, and wherein a lower voltage rail of each of the first and the second low side DC power buses are electrically commonly coupled.

38. The method of claim 35, further comprising:
inverting a voltage across the first and the second voltage rails of the high side DC power bus during at least a portion of the first period; and
applying the inverted voltage to drive an electric machine.

39. A method of operating a power system, comprising:
in a first mode, operating a first DC/DC power converter circuit to boost a potential on a first voltage rail of a high side DC power bus above a high potential of a first low side DC power bus; and
in the first mode, operating a second DC/DC power converter circuit to boost a potential on a second voltage rail of the high side DC power bus below a low potential of a second low side DC power bus, the first and the second DC/DC power converter circuits electrically coupled in series with each other across the high side DC power bus.

40. The method of claim 39, further comprising:
operating a first DC/AC power converter circuit to invert a current carried by the high side DC power bus.

41. The method of claim 39, further comprising:
operating a first DC/AC power converter circuit in at least one mode to invert a current received via the high side DC power bus; and
operating the first DC/AC power converter circuit in at least another mode to rectify a current supplied to the high side DC power bus.

42. The method of claim 39, further comprising:
operating an auxiliary DC/DC power converter circuit to boost a voltage supplied by an auxiliary power storage device.

43. The method of claim 39, further comprising:
operating an auxiliary power converter circuit to reduce a voltage supplied to an auxiliary power storage device.

44. A method of operating a power system, comprising:
supplying power from a first primary power source to a first low side DC power bus electrically coupled to the first primary power source during a first period;
supplying power from a second primary power source to a second low side DC power bus electrically coupled to the second primary power source during at least a portion of the first period;
boosting a potential on a first voltage rail of a high side DC power bus above a high potential of the first low side DC power bus during the first period;
boosting a potential on a second voltage rail of the high side DC power bus below a low potential of the second low side DC power bus during at least the portion of the first period;
ceasing the supplying of power from the second primary power source to the second low side DC power bus electrically coupled to the second primary power source during a second period;
continuing the supplying of power from the first primary power source to the first low side DC power bus during the second period; and
boosting the potential on the first voltage rail of the high side DC power bus above the high potential of the first low side DC power bus during the second period.

45. The method of claim 44 wherein continuing the supplying of power from the first primary power source to the first low side DC power bus during the second period comprises supplying a same voltage across the first low side DC power bus during the second period as during the first period.

46. The method of claim 44 wherein supplying power from a second primary power source to a second low side DC power bus electrically coupled to the second primary power source during at least a portion of the first period comprises supplying a voltage across the first low side DC power bus from a first fuel cell stack of a first fuel cell system; and wherein supplying power from a second primary power source to a second low side DC power bus electrically coupled to the second power source during at least a portion of the first period comprises supplying a voltage across the second low side DC power bus from a second fuel cell stack of a second fuel cell system.

47. The method of claim 44 wherein supplying power from a second primary power source to a second low side DC power bus electrically coupled to the second primary power source during at least a portion of the first period comprises supplying a voltage across the first low side DC power bus from a first fuel cell stack of a fuel cell system and wherein supplying power from a second primary power source to a second low side DC power bus electrically coupled to the second primary power source during at least a portion of the first period comprises supplying a voltage across the second low side DC power bus from a second fuel cell stack of the fuel cell system.

48. The method of claim 44 wherein supplying power from a second primary power source to a second low side DC power bus electrically coupled to the second primary power source during at least a portion of the first period comprises supplying a voltage across the first low side DC power bus from a portion of a fuel cell stack and wherein supplying power from a second primary power source to a second low side DC power bus electrically coupled to the second primary power source during at least a portion of the first period comprises supplying a voltage across the second low side DC power bus from a second portion of the fuel cell stack.

49. The method of claim 44 wherein ceasing the supplying of power from the second primary power source to the second low side DC power bus electrically coupled to the second primary power source during a second period occurs in response to a determination that an operational fault has occurred for the second primary power source.

50. The method of claim 44 wherein ceasing the supplying of power from the second primary power source to the second low side DC power bus electrically coupled to the second primary power source during a second period occurs in response to a determination that a demanded output power is below an output power threshold.

51. The method of claim 44, further comprising:
from time-to-time providing a short circuit path across at least one of the first or second primary power sources.

52. The method of claim 44, further comprising:
determining an ambient temperature at a startup time when starting at least one of the first or the second primary power sources;
determining whether the ambient temperature is below a threshold temperature; and
providing a short circuit path across at least one of the first or second primary power sources in response to the ambient temperature being below the threshold temperature at the startup time.

53. A power system, comprising:
a first multi-layer substrate comprising at least a first electrically conductive layer, a second electrically conductive layer and an electrically insulative layer positioned between the first and the second electrically conductive layers, wherein the first electrically conductive layer of the first multi-layer substrate is patterned to form a number of regions, the regions electrically isolated from one another; and
a second multi-layer substrate comprising at least a first electrically conductive layer, a second electrically conductive layer and an electrically insulative layer positioned between the first and the second electrically conductive layers, wherein the second electrically conductive layer of the second multi-layer substrate is patterned to form a number of regions, the regions electrically isolated from one another, the second multi-layer substrate positioned overlying at least a portion of the first multi-layer substrate, at least one of the regions of the second electrically conductive layer of the second multi-layer substrate electrically coupled to at least one of the regions of the first electrically conductive layer of the first multi-layer substrate.

54. The power system of claim 53 wherein any one of the regions of the second electrically conductive layer of the second multi-layer substrate are electrically coupled to fewer than two of the regions of the first electrically conductive layer of the first multi-layer substrate thereby preventing a short circuit path between the regions of the first electrically conductive layer of the first multi-layer substrate.

55. The power system of claim 54, further comprising:
a first number of switches surface mounted to at least some of the regions of the first electrically conductive layer of the first multi-layer substrate.

56. The power system of claim 55 wherein the first number of switches form at least a portion of at least one phase leg of a DC/AC power converter.

57. The power system of claim 55, further comprising:
a second number of switches surface mounted at least some of the regions of the first electrically conductive layer of the first multi-layer substrate.

58. The power system of claim 57 wherein the first number of switches form at least a portion of at least one phase leg of a DC/AC power converter and wherein the second number of switches form at least a portion of at least one phase of a DC/DC power converter.

59. The power system of claim 53 wherein the electrically insulative layer of the second multi-layer substrate forms at least one via therethrough, and further comprising:
a conductive material received in the at least one via to electrically couple at least one of the regions of the first electrically conductive layer of the second multi-layer substrate with at least one of the regions of the first electrically conductive layer of the first multi-layer substrate by way of at least one of the regions of the second electrically conductive layer of the second multi-layer substrate.

60. The power system of claim 53, further comprising:
a third multi-layer substrate comprising at least a first electrically conductive layer, a second electrically conductive layer and an electrically insulative layer positioned between the first and the second electrically conductive layers, wherein the first electrically conductive layer is patterned to form a number of regions, the regions electrically isolated from one another, at least a portion of the second multi-layer substrate positioned overlying at least a portion of the third multi-layer substrate, at least one region of the second electrically conductive layer of the second multi-layer substrate electrically coupled to at least one of the regions of the first electrically conductive layer of the third multi-layer substrate; and
a first number of switches surface mounted to at least some of the regions of the first electrically conductive layers of the first and the third multi-layer substrates, wherein the first number of switches form at least one phase leg of a DC/AC power converter.

61. The power system of claim 60 further comprising:
a second number of switches surface mounted at least some of the regions of the first electrically conductive layer of the first multi-layer substrate, wherein the second number of switches form at least a portion of at least one phase of a DC/DC power converter.

62. The power system of claim 60 wherein the first multi-layer substrate is approximately planar, the second multi-layer substrate is approximately planar, the third multi-layer substrate is approximately planar, and the second multi-layer substrate is spaced normally from the first and the third multi-layer substrates.

63. The power system of claim 62 wherein the first and the third multi-layer substrates are each elongated and at least approximately parallel to one another.

64. The power system of claim 63 wherein the second multi-layer substrate is elongated and is positioned perpendicularly across both the first and the third multi-layer substrates, the second electrically conductive layers of the first and the third multi-layer substrates each soldered to the first electrically conductive layer of the second multi-layer substrate.

65. The power system of claim 64 wherein the insulative layer of the second multi-layer substrate forms at least one via therethrough, and further comprising:
a conductive material received in the at least one via to electrically couple at least one of the regions of the first electrically conductive layer of the second multi-layer substrate with at least one of the regions of the first electrically conductive layers on each of the first, and the third multi-layer substrates by way of at least one of the regions of the second electrically conductive layer of the second multi-layer substrate.

66. The power system of claim 53, further comprising:
a third multi-layer substrate comprising at least a first electrically conductive layer, a second electrically conductive layer and an electrically insulative layer positioned between the first and the second electrically conductive layers, wherein the first electrically conductive layer of the third multi-layer substrate is patterned to form a number of regions, the regions electrically isolated from one another, at least a portion of the second multi-layer substrate positioned overlying at least a portion of the third multi-layer substrate, at least one region of the second electrically conductive layer of the second multi-layer substrate electrically coupled to at least one of the regions of the first electrically conductive layer of the third multi-layer substrate;
a fourth multi-layer substrate comprising at least a first electrically conductive layer, a second electrically conductive layer and an electrically insulative layer positioned between the first and the second electrically conductive layers, wherein the first electrically conductive layer of the fourth multi-layer substrate is patterned to form a number of regions, the regions electrically isolated from one another, at least a portion of the second multi-layer substrate positioned overlying at least a portion of the fourth multi-layer substrate, at least one region of the second electrically conductive layer of the second multi-layer substrate electrically coupled to at least one of the regions of the first electrically conductive layer of the fourth multi-layer substrate;
a fifth multi-layer substrate comprising at least a first electrically conductive layer, a second electrically conductive layer and an electrically insulative layer positioned between the first and the second electrically conductive layers, wherein the first electrically conductive layer of the fifth multi-layer substrate is patterned to form a number of regions, the regions electrically isolated from one another, at least a portion of the second multi-layer substrate positioned overlying at least a portion of the fifth multi-layer substrate, at least one region of the second electrically conductive layer of the second multi-layer substrate electrically coupled to at least one of the regions of the first electrically conductive layer of the fifth multi-layer substrate; and
a first number of switches surface mounted to at least some of the regions of the first electrically conductive layers of the first, the third, the fourth, and the fifth multi-layer substrates, wherein the first number of switches form at least one phase leg of a DC/AC power converter and at least one phase leg of a DC/DC power converter.

67. The power system of claim 66 wherein the insulative layer of the second multi-layer substrate forms at least one via therethrough, and further comprising:
a conductive material received in the at least one via to electrically couple at least one of the regions of the first electrically conductive layer of the second multi-layer substrate with at least one of the regions of the first electrically conductive layers on each of the first, the third, the fourth, and the fifth multi-layer substrates by way of at least one of the regions of the second electrically conductive layer of the second multi-layer substrate.

68. A power system, comprising:
a first DC/AC converter multi-layer substrate comprising at least a first electrically conductive layer, a second electrically conductive layer and an electrically insulative layer positioned between the first and the second electrically conductive layers, wherein the first electrically conductive layer of the first DC/AC converter multi-layer substrate is patterned to form a number of regions, the regions electrically isolated from one another;
a second DC/AC converter multi-layer substrate comprising at least a first electrically conductive layer, a second electrically conductive layer and an electrically insulative layer positioned between the first and the second electrically conductive layers, wherein the first electrically conductive layer of the second DC/AC converter multi-layer substrate is patterned to form a number of regions, the regions electrically isolated from one another;
a first number of switches surface mounted to at least some of the regions of the first electrically conductive layers of the first and the second DC/AC converter multi-level substrates to form at least one phase leg of a DC/AC converter;
a DC/DC converter multi-layer substrate comprising at least a first electrically conductive layer, a second electrically conductive layer and an electrically insulative layer positioned between the first and the second electrically conductive layers and forming at least one via therethrough, wherein the first and the second electrically conductive layers of the DC/DC converter multi-layer substrate are patterned to form a number of regions, the regions on first electrically conductive layer electrically isolated from one another and the regions on the second electrically conductive layer electrically isolated from one another, the second electrically conductive layer of the DC/DC converter multi-layer substrate opposed to at least a portion of the first electrically conductive layers of the first and the second DC/AC converter multi-layer substrates, at least one of the regions of the second electrically conductive layer of the DC/DC converter multi-layer substrate electrically coupled to at least one of the regions of the first electrically conductive layer of the first and the second DC/AC converter multi-layer substrates; and
a conductive material received in the at least one via to electrically couple at least one of the regions of the first electrically conductive layer of the DC/DC converter multi-layer substrate with at least one of the regions of the first electrically conductive layers on each of the first and the second DC/AC converter multi-layer substrates by way of at least one of the regions of the second electrically conductive layer of the DC/DC converter multi-layer substrate.

69. The power system of claim 68 wherein the first electrically conductive layer of the DC/DC converter multi-level substrate is patterned to form a number of regions, the regions of the DC/DC converter multi-level substrate electrically isolated from one another, and further comprising:
a second number of switches surface mounted to at least some of the regions of the first electrically conductive layers of the DC/DC converter multi-level substrate.

70. The power system of claim 68 wherein the DC/DC converter multi-level substrate is a die bonded copper substrate.

71. The power system of claim 68 wherein the DC/DC converter multi-level substrate is a die bonded copper substrate.

72. The power system of claim 68, further comprising:
a third DC/AC converter multi-layer substrate comprising at least a first electrically conductive layer, a second electrically conductive layer and an electrically insulative layer positioned between the first and the second electrically conductive layers, wherein the first electrically conductive layer of the third DC/AC converter multi-layer substrate is patterned to form a number of regions, the regions electrically isolated from one another; and
a fourth DC/AC converter multi-layer substrate comprising at least a first electrically conductive layer, a second electrically conductive layer and an electrically insulative layer positioned between the first and the fourth electrically conductive layers, wherein the first electrically conductive layer of the fourth DC/AC converter multi-layer substrate is patterned to form a number of regions, the regions electrically isolated from one another, and wherein the second electrically conductive layer of the DC/DC converter multi-layer substrate is opposed to at least a portion of the first electrically conductive layers of the third and the fourth DC/AC converter multi-layer substrates, at least one of the regions of the second electrically conductive layer of the DC/DC converter multi-layer substrate electrically coupled to at least one of the regions of the first electrically conductive layer of the third and the fourth DC/AC converter multi-layer substrates.

73. A power system, comprising:
a first primary direct current to direct current (DC/DC) power converter coupled between a first voltage rail of a high voltage direct current (DC) power system and a positive voltage bus of a low voltage DC power system such that the first primary DC/DC power converter controls a voltage difference between the first voltage rail and the positive voltage bus; and
a second primary DC/DC power converter serially connected to the first primary DC/DC power converter and coupled between a second voltage rail of the high voltage DC power system and a negative voltage bus of the low voltage DC power system such that the second primary DC/DC power converter controls a voltage difference between the second voltage rail and the negative voltage bus.

74. The power system of claim 73 wherein the voltage difference between the first voltage rail and the positive voltage bus is independently controllable from the voltage difference between the second voltage rail and the negative voltage bus.

75. The power system of claim 73, further comprising:
a neutral node operable at a neutral voltage, wherein the neutral voltage is between a voltage of the positive voltage bus and a voltage of the negative voltage bus;
a first capacitor coupled between the neutral node and the first voltage rail; and
a second capacitor coupled between the neutral node and the second voltage rail.

76. The power system of claim 75 wherein a first DC source and a second DC source are coupled in series, and wherein the neutral node is coupled between the first DC source and the second DC source.

77. The power system of claim 76 wherein the neutral node is coupled to a negative terminal of the first DC source and a positive terminal of the second DC source.

78. The power system of claim 75 wherein the first primary DC/DC power converter comprises:
a first inductor coupled to a positive terminal of a first DC source;
a first switch coupled between the neutral node and the first inductor; and
a first diode coupled between the first inductor and the first voltage rail, and wherein the second primary DC/DC power converter comprises:
a second inductor coupled to a negative terminal of a second DC source;
a second switch coupled between the neutral node and the second inductor; and
a second diode coupled between the second inductor and the second voltage rail, such that DC power is transferable from the first and the second DC sources to the high voltage DC power system by operation of the first and second switches.

79. The power system of claim 75 wherein the first primary DC/DC power converter comprises:
a first inductor coupled to a positive terminal of a first DC source;
a first switch coupled between the neutral node and the first inductor; and
a second switch coupled between the first inductor and the first voltage rail, and wherein the second primary DC/DC power converter comprises:
a second inductor coupled to a negative terminal of a second DC source;
a third switch coupled between the neutral node and the second inductor; and
a fourth switch coupled between the second inductor and the second voltage rail, such that power is transferable from the first and the second DC sources to the high voltage DC power system by operation of the first and third switches, and such that power is transferable from the high voltage DC power system to the first and the second DC sources by operation of the second and fourth switches.

80. A power system, comprising:
a first voltage rail operable at a first direct current (DC) voltage;
a second voltage rail operable at a second DC voltage;
a neutral node operable at a neutral voltage that is between the first DC voltage and the second DC voltage, the neutral node coupled to a negative terminal of a first source and coupled to a positive terminal of a second source;
a first primary direct current to direct current (DC/DC) power converter, comprising
a first inductor coupled to the positive terminal of the first source;
a first switch coupled between the neutral node and the first inductor; and
a first diode coupled between the first inductor and the first voltage rail;
a second primary DC/DC power converter, comprising
a second inductor coupled to a negative terminal of the second source;
a second switch coupled between the neutral node and the second inductor; and
a second diode coupled between the second inductor and the second voltage rail;
a first capacitor coupled between the first voltage rail and the neutral node; and
a second capacitor coupled between the second voltage rail and the neutral node.

81. The power system of claim 80 wherein the first source is operable at a first source voltage and the second source is operable at a second source voltage, and wherein a sum of the first DC voltage and the second DC voltage is greater than a sum of the first source voltage and the second source voltage.

82. The power system of claim 80 wherein the first source is operable at a first source voltage and the second source is operable at a second source voltage, and wherein a sum of the first DC voltage and the second DC voltage is less than a sum of the first source voltage and the second source voltage.

83. The power system of claim 80 wherein the first source is operable at a first source voltage (V₁) and the second source is operable at a second source voltage (V₂), and further comprising:
a controller operable to actuate the first switch and the second switch for a duty cycle (D), wherein a DC voltage (V_{DC}) corresponding to a sum of the first DC voltage of the first voltage rail and the second DC voltage of the second voltage rail is (V_{DC})=(V₁+V₂)/(1−D).

84. The power system of claim 83 wherein the first source voltage and the second source voltage are equal, and the controller is operable to actuate the first switch and the second switch for the same duty cycle.

85. The power system of claim 83 wherein the controller is operable to actuate the first switch for a first duty cycle and is operable to actuate the second switch for a second duty cycle, wherein the first duty cycle is different from the second duty cycle, such that the first source voltage and the second source voltage are different.

86. The power system of claim 80 wherein the first inductor, the first switch, and the first diode are electrically coupled to form a first converter leg, and wherein the second inductor, the second switch, and the second diode are electrically coupled to form a second converter leg.

87. The power system of claim 86 wherein the first primary DC/DC power converter further comprises:
a third converter leg, and wherein the second primary DC/DC power converter further comprises:
a fourth converter leg, wherein each of the third and fourth converter legs have an inductor, a switch, and a diode.

88. The power system of claim 86 wherein the first primary DC/DC power converter further comprises:
a plurality of additional first converter legs, and wherein the second primary DC/DC power converter further comprises:
a plurality of additional second converter legs, wherein each of the additional first and second converter legs have an inductor, a switch and a diode.

89. The power system of claim 88 wherein a number of the additional first converter legs of the first primary DC/DC power converter is different from a number of the additional second converter legs of the second primary DC/DC power converter.

90. The power system of claim 80, further comprising:
a third primary DC/DC power converter, comprising
a third inductor coupled to the positive terminal of the first source;
a third switch coupled between the neutral node and the third inductor; and
a third diode coupled between the third inductor and the first voltage rail; and
a fourth primary DC/DC power converter, comprising
a fourth inductor coupled to the negative terminal of the second source;
a fourth switch coupled between the neutral node and the fourth inductor; and
a fourth diode coupled between the fourth inductor and the second voltage rail.

91. The power system of claim 80, further comprising:
a plurality of additional first primary DC/DC power converters, each additional first primary DC/DC power converter comprising a first additional inductor coupled to the positive terminal of the first source, a first additional switch coupled between the neutral node and the respective inductor, and a first additional diode coupled between the respective inductor and the first voltage rail; and
a plurality of additional second primary DC/DC power converters, each additional second primary DC/DC power converter comprising a second additional inductor coupled to the negative terminal of the second source, a second additional switch coupled between the neutral node and the respective inductor, and a second additional diode coupled between the respective inductor and the second voltage rail.

92. The power system of claim 91 wherein a number of the first primary DC/DC power converters is different from a number of the second primary DC/DC power converters.

93. A power system, comprising:
a first primary direct current to direct current (DC/DC) power converter coupled between a first voltage rail operable at a first direct current (DC) voltage and a positive terminal of a first DC source, comprising:
a first inductor coupled to the positive terminal of the first DC source;
a first switch coupled between a neutral node and the first inductor; and
a second switch coupled between the first inductor and the first voltage rail; and
a second primary DC/DC power converter coupled between a second voltage rail operable at a second DC voltage and a negative terminal of a second DC source, comprising
a second inductor coupled to the negative terminal of the second DC source;
a third switch coupled between the neutral node and the second inductor; and
a fourth switch coupled between the second inductor and the second voltage rail.

94. The power system of claim 93 wherein:
the first switch conducts DC current from the first DC source to the first voltage rail;
the second switch conducts DC current from the first voltage rail to the first DC source;
the third switch conducts DC current from the second DC source to the second voltage rail; and
the first switch conducts DC current from the second voltage rail to the second DC source.

95. The power system of claim 94, further comprising:
a third primary DC/DC power converter coupled between the first voltage rail and the positive terminal of the first DC source, comprising:
a third inductor coupled to the positive terminal of the first DC source;
a fifth switch coupled between the neutral node and the third inductor; and
a first diode coupled between the third inductor and the first voltage rail; and
a fourth primary DC/DC power converter coupled between the second voltage rail and the negative terminal of the second DC source, comprising
a fourth inductor coupled to the negative terminal of the second DC source;
a sixth switch coupled between the neutral node and the fourth inductor; and
a second diode coupled between the fourth inductor and the second voltage rail,
wherein the third switch conducts DC current from the first DC source to the first voltage rail, wherein the first diode blocks DC current from the first voltage rail to the first DC source, wherein the fourth switch conducts DC current from the second DC source to the second voltage rail, and wherein the second diode blocks DC current from the second voltage rail to the second DC source.

96. The power system of claim 95 wherein a capacity from the first and second sources to the first and second voltage rails is greater than a capacity from the first and second voltage rails to the first and second sources.

97. The power system of claim 93, further comprising:
the neutral node operable at a neutral voltage that is between a first DC voltage and the second DC voltage, the neutral node coupled to the negative terminal of the first DC source and coupled to the positive terminal of the second DC source;
a first capacitor coupled between the first voltage rail and the neutral node; and
a second capacitor coupled between the second voltage rail and the neutral node.

98. A power system, comprising:
a high voltage side having a high voltage rail operable at a first direct current (DC) voltage and a low voltage rail operable at a second DC voltage;
a low voltage side;
a traction drive electrically coupled to the high voltage side without an intervening power converter;
a fuel cell system electrically coupleable to the high voltage side to provide power to the traction drive; and
a DC/DC power converter system electrically coupling the low voltage side to the high voltage side of the power system, wherein the DC/DC power converter system further comprises:
a first primary DC/DC power converter; and
a second primary DC/DC power converter serially connected to the first primary DC/DC power converter,
such that the first primary DC/DC power converter is coupled between the high voltage rail and a positive terminal of the low voltage side, and such that the second primary DC/DC power converter is coupled between the low voltage rail and a negative terminal of the low voltage side.

99. The power system of claim 98, further comprising:
at least one high voltage auxiliary electrically coupled to the fuel cell system without the intervening power converter.

100. The power system of claim 98, further comprising:
a low voltage battery having a positive terminal coupled to the positive terminal of the low voltage side and having a negative terminal coupled to the negative terminal of the low voltage side such that DC power is transferred between the low voltage battery and the high voltage side of the power system through the DC/DC power converter system.

101. The power system of claim 98, further comprising:
a high voltage power storage device;
a second DC/DC power converter system electrically coupling the high voltage power storage device to the high voltage side of the power system, wherein the second DC/DC power converter system further comprises:
a third primary DC/DC power converter; and
a fourth primary DC/DC power converter serially connected to the third primary DC/DC power converter,
such that the third primary DC/DC power converter is coupled between the first voltage rail and the positive terminal of the high voltage power storage device, and such that the fourth primary DC/DC power converter is coupled between the second voltage rail and the negative terminal of the high voltage power storage device.

102. The power system of claim 98 wherein the fuel cell system is directly coupled to the high voltage side to provide power directly to the traction drive via the high voltage side.

103. The power system of claim 98, further comprising:
a second DC/DC power converter system electrically coupling a high voltage power storage device to the high voltage side of the power system, wherein the DC/DC power converter system further comprises:
a third primary DC/DC power converter; and
a fourth primary DC/DC power converter serially connected to the third primary DC/DC power converter,
such that the third primary DC/DC power converter is coupled between the high voltage rail and the positive terminal of the fuel cell system, and such that the fourth primary DC/DC power converter is coupled between the low voltage rail and the negative terminal of the fuel cell system.

104. A method of operating a power system, comprising:
supplying power from a first primary power source to a first low side direct current (DC) power bus electrically coupled to the first primary power source;
supplying power from a second primary power source to a second low side DC power bus electrically coupled to the second primary power source;
pulling up voltage from the first primary power source to a positive high voltage on a first voltage rail of a high side DC power bus; and
pulling down voltage from the second primary power source to a negative high voltage on a second voltage rail of the high side DC power bus.

105. The method of claim 104, further comprising:
selecting one of the first primary power source and the second primary power source; and
reducing power supplied from the selected one of the first or the second primary power sources so that the selected one of the first or the second primary power sources is operating in an idling mode.

106. The method of claim 104, further comprising:
selecting one of the first primary power source and the second primary power source; and
ending the supplying of the power from the selected one of the first or the second primary power sources so that the selected one of the first or the second primary power sources is operating in a sleeping mode; and
operating the non-selected one of the first or the second primary power sources at a higher voltage level.

107. The method of claim 106, wherein operating the non-selected one of the first or the second primary power sources at the higher voltage level further comprises operating the non-selected one of the first or the second primary power sources at a maximum voltage level.

108. The method of claim 104, further comprising:
operating at a reduced voltage at least one of the first primary power source or the second primary power source so that waste heat is generated for a cold start.

109. A method of operating a power system, comprising:
stepping up a positive DC voltage of a first primary power source to a higher positive DC voltage; and
stepping down a negative DC voltage of a second primary power source to a lower negative DC voltage,
wherein the first primary power source and the second primary power source are serially connected.

110. The method of claim 109, further comprising:
transmitting power over a first low side DC power bus electrically coupled to the first primary power source; and
transmitting power over a second low side DC power bus electrically coupled to the second primary power source.

111. The method of claim 110, further comprising:
receiving power from the first primary power source and the second primary power source;
actuating a first switch of a first primary DC/DC power converter to transmit the received power from the first primary power source to a high voltage rail having the higher positive DC voltage; and
actuating a second switch of a second primary DC/DC power converter to transmit the received power from the second primary power source to a low voltage rail having the lower negative DC voltage.

112. The method of claim 110, further comprising:
de-actuating a first switch of a first primary DC/DC power converter and a second switch of a second primary DC/DC power converter;
receiving power via a high voltage rail having the higher positive DC voltage;
receiving power via a low voltage rail having the lower negative DC voltage;
switching a third switch of the first primary DC/DC power converter to transmit power received via the high voltage rail to the first primary power source; and
switching a fourth switch of the second primary DC/DC power converter to transmit the power received via the low voltage rail to the second primary power source.

113. The method of claim 109, further comprising:
switching a first switch of a first primary DC/DC power converter to step up the positive DC voltage to the higher positive DC voltage; and
switching a second switch of a second primary DC/DC power converter to convert the negative DC voltage to the lower negative DC voltage.

114. The method of claim 109, further comprising:
protecting the first primary power source with a first diode of a first primary DC/DC power converter; and
protecting the second primary power source with a second diode of a second primary DC/DC power converter,
wherein the first and second diodes block voltage and current changes occurring on a load side of the power system coupled to the first and the second primary DC/DC power converters.

115. A method of operating a first primary power source and a second primary power source, comprising:
initially generating power from the first primary power source and the second primary power source, wherein the first primary power source and the second primary power source are serially connected;
initially stepping up a positive DC voltage of the first primary power source to a higher positive DC voltage;
initially stepping down a negative DC voltage of the second primary power source to a lower negative DC voltage;
reducing power generated by the second primary power source; and
further stepping up the positive DC voltage of the first primary power source to a second higher positive DC voltage.

116. The method of claim 115, further comprising:
selecting one of the first primary power source and the second primary power source; and
reducing power supplied from the selected one of the first or the second primary power sources so that the selected one of the first or the second primary power sources is operating in an idling mode.

117. The method of claim 115, further comprising:
selecting one of the first primary power source and the second primary power source;
ending the generation of the power from the selected one of the first or the second primary power sources so that the selected one of the first or the second primary power source is operating in a sleeping mode; and
operating the non-selected one of the first or the second primary power sources at a second higher voltage level.

118. The method of claim 117, wherein operating the non-selected one of the first or the second primary power sources at a higher voltage level further comprises operating the non-selected-one of the first or the second primary power sources at a maximum voltage level.

119. The method of claim 115, further comprising:
reducing the negative DC voltage of the second primary power source; and
generating waste heat from the second primary power source for a cold start.
